(19) United States
(12) Patent Application Publication
(10) Pub. No.: US 2024/0253141 A1
(43) Pub. Date: Aug. 1, 2024

(54) ELECTRODE ASSEMBLY AND ELECTROCHEMICAL MACHINING METHOD

(71) Applicant: Cummins Ltd, London (GB)

(72) Inventors: Robert L. Holroyd, Huddersfield (GB); Thomas Roberts, Huddersfield (GB); Laura Sullivan, Huddersfield (GB); Aaron Matthew Holt, Huddersfield (GB); Ivan Scott Arbuckle, Huddersfield (GB); Philip Neil Dickinson, Huddersfield (GB)

(21) Appl. No.: 18/288,481

(22) PCT Filed: Apr. 27, 2022
(86) PCT No.: PCT/GB2022/051071

§ 371 Date: Oct. 26, 2023

(30) Foreign Application Priority Data
Apr. 27, 2021 (GB) 2106010.8

(51) Int. Cl. B23H 3/04; B23H 3/10; B23H 9/06; B23H 9/14; B33Y 10/00; B33Y 50/02; B33Y 80/00

(52) U.S. Cl. CPC B23H 3/04; B23H 3/10; B23H 9/06; B23H 9/14; B33Y 50/02; B33Y 10/00; B33Y 80/00

(57) ABSTRACT

An electrode assembly for electrochemically machining a cavity of a component is disclosed. The electrode assembly comprises: an electrode, a mounting body, and an urging means. The electrode comprises a plurality of conductive elements, including an outermost conductive element. The mounting body is coupled to the electrode and engageable with the component to align the electrode within the cavity. The urging means is configured to transition the electrode from a movable configuration to a conforming configuration. In the movable configuration the conductive elements are moveable relative to one another. In the conforming configuration adjacent conductive elements align to define a substantially continuous outer electrode surface.

### CROSS-REFERENCE TO RELATED APPLICATIONS

The present application claims the benefit of priority to International Patent Application No. PCT/GB2022/051071, filed Apr. 27, 2022, which claims the benefit of priority to GB Patent Application No. 2106010.8, filed Apr. 27, 2021, the contents of which are incorporated herein by reference in their entirety.

### FIELD

The present disclosure relates to an electrode assembly, associated methods, and a component.

### BACKGROUND

Electrochemical machining is a known process that is used to remove welded joints and to polish internal passages of tubes. In the process, a positively charged workpiece forms an anode. The workpiece, or at least an exposed surface thereof, is spaced apart (to define a gap) from a negatively charged electrode, which forms a cathode. An electrolyte is pumped through the gap provided between the workpiece and the electrode. The electrolyte effectively completes the electrical circuit between the electrode and workpiece (cathode and anode respectively). Atoms are removed from the exposed surface of the workpiece as electrons cross the gap, resulting in an improved surface finish of the workpiece.

Existing electrochemical machining processes, and associated apparatuses, limit the use of the process to only some workpieces.

There exists a need to overcome one or more disadvantages associated with existing arrangements, whether mentioned in this document or otherwise.

### SUMMARY

According to a first aspect of the disclosure there is provided an electrode assembly for electrochemically machining a cavity of a component, the electrode assembly comprising:
a) an electrode comprising a plurality of conductive elements, including an outermost conductive element;
b) a mounting body coupled to the electrode and engageable with the component to align the electrode within the cavity; and
c) an urging means configured to transition the electrode from a movable configuration to a conforming configuration; wherein
d) in the movable configuration the conductive elements are moveable relative to one another; and
e) in the conforming configuration adjacent conductive elements align to define a substantially continuous outer electrode surface.

Electrochemical machining is intended to mean a process in which an electrolyte is passed through a gap between a negatively charged tool (cathode) and a positively charged workpiece (anode) to remove material from the workpiece. The electrolyte completes an electrical circuit (interrupted by the gap between the anode and cathode) to remove material, and transport it away, from the workpiece. In this instance it will be appreciated that the component is an example of a workpiece. The electrode is an example of a tool.

The cavity may have any one of a variety of different shapes. For example, the cavity may be generally cylindrical (e.g. having a generally circular cross-section). Alternatively, the cavity may be generally cuboidal (e.g. having a generally square, or rectangular, cross-section). The cavity may have a nonlinear geometry (i.e. it may incorporate one or more bends along its extent, or length). The cavity may be a volute. Specifically, the cavity may be a volute formed in a housing of a turbomachine housing (e.g. a turbine housing or compressor housing). The cavity may be defined by an opening. The cavity may have a discharge aperture. The electrolyte may flow through the opening of the cavity, along the internal wall of the cavity, and exit via the discharge outlet. The cavity may be an internal cavity. The cavity may define a generally enclosed volume. The cavity may have an inlet and an outlet (e.g. be a through-bore).

The component may be any one of a range of different components. Examples include a manifold, turbomachine housing (e.g. a turbine housing or a compressor housing, or another variety of pump housing) or an EGR valve. The component may be a turbine housing, or compressor housing, for a turbocharger. Where the component is a compressor housing, the compressor housing may be for an eCompressor (i.e. a compressor driven by an electric motor, or generator). The eCompressor may form part of an eTurbocharger. The component may an engine component. The component may be manufactured from a range of different electrically conductive materials including, but not limited to, aluminium, cast-iron and stainless steel.

For the purposes of this document, the electrochemical machining of the cavity is intended to refer to the effective polishing of a preformed cavity. That is to say, the cavity is not created, in a solid surface for example, by the electrochemical machining process. Rather, the surface finish of an existing cavity is improved, by reducing its surface roughness, using electrochemical machining. This is owing to the fact that the electrode is inserted into a cavity, in order for the process to be carried out. Alongside the polishing, the tolerance of the cavity dimensions may also be improved by the electrochemical process.

The electrode assembly may comprise a single electrode. Alternatively, the electrode assembly may comprise a plurality of electrodes (e.g. a pair of electrodes). The electrode assembly comprising the plurality of electrodes is advantageous where there are effectively two cavities to be machined (e.g. a twin entry volute of a turbine housing). Where the electrode assembly comprises a plurality of electrodes, each of the electrodes may be coupled to the mounting body (i.e. there may only be a single mounting body). The electrode may be referred to as an internal electrode.

The conductive elements may otherwise be described as electrically conductive bodies. That is to say, the conductive elements readily permit a flow of electrons thereacross. The conductive elements, and electrode generally, forms part of an electrical circuit. Examples of materials that the conductive elements may be manufactured from include metals. Whilst most hard-wearing metals are suitable, stainless steels, such as 300 and 400 series stainless steels, are particularly desirable owing to their corrosion resistance. 300 and 316 series stainless steels have been found to be particularly effective.

The plurality of conductive elements may be discrete, separate elements to one another. For example, the electrode may comprise five separate conductive elements, which may be tethered together by a flexible element. Alternatively, the conductive elements may be permanently connected to one another. For example, the conductive elements may be hingeably connected to one another, and therefore able to pivot relative to one another. The hinge may be provided on an inner radius where the conductive elements define an arc in use. The conductive elements may each have a different cross-section shape and/or length, or extent. The plurality of conductive elements may be said to be electrically coupleable to one another, or in electrical communication with one another, at least in the conforming configuration.

The outermost conductive element refers to a conductive element which is distal the mounting body. Put another way, when the electrode is inserted into the cavity, the outermost conductive element is the conductive element which will first be inserted into the opening of the cavity. The conductive elements may be referred to as electrically conductive elements. Each of the conductive elements may be said to define an outer surface of the respective element. The collective plurality of conductive elements may be said to define an overall outer surface of the electrode when the elements are in the conforming configuration.

The mounting body may be a mounting flange or other alignment means which, in use, can engage the component. The mounting body being coupled to the electrode may otherwise be described as at least a portion of the electrode extending from the mounting body. One of the conductive elements may be fixedly attached (e.g. bolted) to the mounting body. The mounting body may be engagable with the component by way of abutment. That is to say, a face of the mounting body may engage a face of the component. The mounting body may be secured in position by, for example, a mounting fixture such as a toggle clamp or a peg. Preferably, the component comprises features, such as apertures, which may themselves be used to support pegs, for example, which can be used to align the mounting body with the component. The mounting body may align the electrode substantially centrally within the cavity. That is to say, when taken at any point along a cross-section of the cavity, the electrode, specifically the conductive elements thereof, may be provided substantially centrally therein along an axis. By aligning the electrode within the cavity, a substantially continuous gap, or clearance, may be defined between the outer electrode surface and an internal wall which defines the cavity. The gap between the outer electrode surface and the internal wall of the cavity is preferably between around 3 mm and around 6 mm on radius, but may be less than around 3 mm in some instances. The mounting body may be said to provide axial and rotational alignment of the electrode relative to the component. The mounting body may be a generally solid body or may comprise one or more apertures. That is to say, the mounting body may be described as defining a perimeter, optionally with internal structure provided therein. The mounting body may be described as securing the electrode in a stationary manner.

The mounting body may be the only means by which the electrode is aligned in the cavity. Alternatively a further support may be incorporated. For example, an outer end of the electrode may be supported within the cavity by the further support. Where the component is a turbomachine housing, the further support may be provided at least partly through an axial outlet (for a turbine housing) or an axial inlet (for a compressor housing).

The mounting body may comprise a gasket, which may be a non-conductive (electrically) gasket. The non-conductive gasket may seal, or isolate, part of the component (e.g. a flange) from the electrochemical machining circuit, and process. Said part of the component may therefore not be polished, or have material eroded. An engagement face of the mounting body may indirectly engage the component to be machined where a gasket is also incorporated. That is to say, a gasket may interpose the engagement face and the component.

The mounting body may comprise a manifold. The gasket may interpose the manifold and the component to be machined. The manifold may comprise one or more bosses. An electrode may be coupled to each respective boss (e.g. one electrode to one boss). The boss may be provided in a recess. Each recess may fluidly communicate with an electrolyte inlet such that electrolyte can flow around, and along, each electrode, through the cavity to be machined.

The electrode may be electrically coupled to the mounting body. In use, a negative charge may be applied to (part of) the mounting body (e.g. the manifold thereof) in order to apply a negative charge to the electrode.

The urging means may take on one, or a number, of different forms. The urging means may use tension, magnetism or a spring bias. Examples of urging means include a flexible element (e.g. a cord), electromagnets or spring. Where the urging means is a flexible element, the flexible element may be tensioned in order to draw, or pull, the conductive elements into engagement with one another. Releasing the tension in the flexible element may permit the conductive elements to move relative to one another. For an electromagnet, or a magnet more generally, magnetism may be used to urge the conductive elements toward one another. In a spring system, the conductive elements may be biased towards one another where a spring, between the conductive elements, is combined with a hinge. These are just some examples of potential urging means, and it will be appreciated there are a number of other options available. The flexible element is preferably a non-conductive flexible element.

The urging means being configured to transition the electrode between configurations may otherwise be described as the urging means being able to change the configuration of the electrode, or to vary the configuration. The urging means is configured to at least transition the electrode from a moveable configuration to a conforming configuration, and the urging means may also be configured to transition the electrode back from the conforming configuration to the moveable configuration. Alternatively, at the point where the urging means is released, for example, it may be withdrawal of the electrode from the cavity, and contact between the conductive elements and the internal wall of the cavity, which urges the electrode from the conforming configuration to the moveable configuration. The urging means may also be said to secure, or lock, the electrode in the conforming configuration when actuated.

In the moveable configuration the conductive elements may be moveable relative to one another in at least one degree of freedom. In one example, in the moveable configuration the conductive elements are hingeably connected to one another, but are able to pivot about that hinge axis. In another example, where the urging means is a flexible element, in the moveable configuration the conductive elements may be able to freely move relative to one another, but be tethered by way of the flexible element. The moveable configuration facilitates the insertion of the electrode into a cavity and particularly where the cavity is a nonlinear geometry (e.g. a volute, or spiralling geometry). Put another way, the moveable configuration is advantageous when the electrode is to be inserted into a nonlinear cavity e.g. where the cavity incorporates a bend of some variety (such that a linear electrode could not be inserted therein).

The conforming configuration refers to an arrangement of the conductive elements once the electrode has been aligned with the cavity by way of the mounting body. In the conforming configuration adjacent (e.g. consecutive) conductive elements align. The adjacent conductive elements align to define a substantially continuous outer electrode surface which may be said to conform to the internal wall along at least part of the cavity. Described another way, neighbouring (e.g. sequential) conductive elements align with each other in the conforming configuration. For example, at the point where the electrode has been aligned within the cavity by the mounting body, the outermost conductive element may be contacting the internal wall of the cavity. Such contact, if the electrochemical machining process was initiated, could lead to a short circuit and risk damage to the component. By using the urging means to place the conductive elements in the conforming configuration, the conductive elements are aligned with one another such that the outer electrode surface conforms to the cavity and avoids any contact between the electrode and the cavity. In the conforming configuration the electrodes may be said to rigidly engage one another such that any movement relative to one another is substantially prevented. One example may be where the conductive elements comprise a flat face, and in the conforming configuration the flat faces of the respective conductive elements engage one another to fix the conductive elements in position. The electrode may be described as being held in a fixed arrangement (e.g. no relative movement between conductive elements) whilst in the conforming configuration. The electrode may be described as being stationary in the conforming configuration. The electrode may have an at least partly nonlinear geometry in the conforming configuration. Described another way, the electrode may be at least partly arcuate in the conforming configuration (e.g. be at least partly arcuate along its extent, or length). The electrode may be entirely arcuate in the conforming configuration. The electrode may have a combination of linear and nonlinear geometry in the conforming configuration (e.g. extending straight for a given distance, before bending). Where multiple electrodes are present, the above may apply to one, or each, of the electrodes.

The substantially continuous outer electrode surface may be described as a continuous outer electrode surface with only very minor gaps, at some discrete positions, at join lines between the conductive elements. The outer surface could therefore be described as continuous when the conductive elements are in the conforming configuration.

Advantageously, electrochemical machining can achieve a surface finish which is similar to a polished standard. A sand cast finish, which may have a surface roughness of 6-18 μm (micrometres) Ra, can be improved and the surface finish reduced to between 0.5-5 μm Ra using electrochemical machining. Furthermore, the surface finish obtained using electrochemical machining can be achieved in only a few minutes, which is considerably faster than is the case for traditional polishing. Advantageously, electrochemical machining can be used to provide an improved surface finish for a number of different electrically conductive materials including, but not limited to, aluminium, cast-iron and stainless steel. Furthermore, electrochemical machining can occur without there being any contact between the conductive body and the internal wall.

Advantageously, the electrode assembly can be used to electrochemically machine a variety of different cavity geometries. For example, the cavity may be a volute (i.e. a generally spiralling geometry of a turbomachine housing). The electrode assembly can be used to readily electrochemically machine nonlinear cavities (i.e. cavities incorporating at least one bend, such that a rigid, linear electrode could not extend past the bend).

Advantageously, the electrode assembly described above facilitates the electrochemical machining of a cavity without there being need for contact between the electrode assembly and the cavity. That is to say, the electrode may be aligned within the cavity only by virtue of the mounting body engaging an exterior of the component. The electrode assembly can provide a repeatable surface finish due to the consistent alignment of the electrode relative to the component (and specifically within the cavity). As well as improving the surface finish of the cavity, the electrode assembly can also be used to improve the tolerance of the cavity of the component through use of the electrode assembly in an electrochemical machine process.

The urging means may comprise a flexible element.

The flexible element may be configured to draw the conductive elements into engagement with one another in the conforming configuration.

The urging means may comprise a single flexible element. Alternatively, the urging means may comprise a plurality of flexible element. Where the urging means comprises a single flexible element, the flexible element may extend through each of the conductive elements and double back on itself, in a U-shaped manner, through the outermost conductive element. When an operator pulls on the flexible element the flexible element may be tensioned so as to draw the conductive elements into engagement with one another and substantially prevent relative movement between the conductive elements. The flexible element may comprise a cord or wire. The cord may be a fabric cord. The cord may comprise a plurality of strands (e.g. interwoven strands). The flexible element may be a metal rope. In preferred embodiments the flexible element is a cord.

Advantageously, the flexible element provides a simple urging means which can be reliably and repeatedly used to transition the electrode to the conforming configuration. If required, the flexible element can be readily replaced. The flexible element is also an intuitive urging means for an operator to use.

Urging means may be provided for each electrode. Where the urging means is a flexible element, and the electrode assembly comprises a plurality of electrodes, the electrode assembly may therefore comprise two urging means in the form of two flexible elements. One flexible element may be associated with each electrode. For example, where the flexible element is a cord, a single cord may extend through each electrode. The flexible element (e.g. cord) may double back (e.g. in a U-shaped manner) such that a single flexible element extends through the electrode in two separate positions. Alternatively, the flexible element (e.g. cord) may not double back and may extend, in a single pass, successively through each of the conductive bodies (e.g. such that ‘free’ ends of the flexible element are generally located at opposing ends of the electrode). The flexible elements may be pulled, or actuated, simultaneously so as to align both electrodes within respective cavities. A manual toggle clamp may be used to actuate, or pull, the flexible element. Alternatively, an electronically or pneumatically actuated device may be used to actuate, or pull, the flexible element. The flexible element (e.g. the cord) may extend through each of the conductive elements of the associated electrode. More generally, the urging means may extend through each of the conductive elements of the associated electrode. The urging means may extend at least partway through, or entirely through, the associated electrode.

Where the urging means comprises a flexible element, simply releasing the flexible element may provide some degree of movement between the conductive elements. However, upon withdrawal of the electrode from the cavity, a slack in the flexible element means that more movement between the conductive elements can occur to facilitate the removal of the elements, and the electrode, from the cavity. The electrode, specifically the conductive elements thereof, may be deflected by the internal wall of the cavity as the electrode is withdrawn and an outer surface of the conductive elements contacts the internal wall. This deflection may be permitted by virtue of the electrode being in the movable configuration.

Each of the plurality of conductive elements may comprise a plurality of passages. Each of the plurality of conductive elements may comprise only a single passage.

The plurality of passages may specifically be two passages. That is to say, each of the plurality of conductive elements may comprise a pair of passages. The passages may extend from one end of the conductive element to another, or from a first end to an opposing second end.

The passages may be bores. The passages may otherwise be described as cavities.

The plurality of passages may be said to extend through the conductive elements. At least the inboard conductive elements may comprise a plurality of passages which extend therethrough.

The flexible element may be receivable through the plurality of passages to tether the conductive elements to one another.

The flexible element being receivable through the plurality of passages may otherwise be described as the flexible element being insertable through the passages. The flexible element may be received by the passages and then remain in the passages throughout the life of the electrode assembly. Tethering the conductive elements is intended to mean that, although relative movement between the elements is permitted, there is still some degree of restraint of the extent of movement between the conductive elements. For example, the outermost conductive elements still remains attached to the other elements, despite its outermost position, even when the urging means is not actuated (e.g. the cord is not tensioned).

The plurality of passages may be positioned in such a way that the tensioning of the flexible element can reliably draw the conductive elements into engagement with one another in the conforming configuration.

A single flexible element may tether the conductive elements of one electrode to one another. That is to say, there may be one flexible element for each electrode. The flexible element may double-back, in a U-shaped manner, along the electrode. Outer ends of the flexible element may extend beyond the conductive elements.

A plurality of cords may tether the conductive elements of one electrode to one another. That is to say, there may be a plurality of cords for each electrode.

Advantageously, the flexible element being receivable through the passages means that the flexible element is securely routed through the conductive elements. This means that the flexible element may not be exposed to electrolyte which could be damaging to the flexible element and reduce the lifespan of the electrode assembly.

The flexible element may be inserted through the passages by using a draw-wire style arrangement. That is to say, the flexible element may be attached to a semi-rigid wire, rod or filament, which is then urged through the passages (drawing the flexible element with it, through the passages, in the process). One example of a possible draw wire is a welding rod.

Each passage may have a nonlinear profile along its length through the respective conductive element.

The passages having a nonlinear profile along their length is intended to mean that the passages do not simply have a single, linear axis (i.e. are not straight). Instead, the passages may be arcuate along their length and be defined by at least two linear profiles coming together at an angle.

Advantageously, providing passages having a nonlinear profile has been found to improve the consistency of the alignment of the conductive elements with one another, in the conforming configuration, where a flexible element is used as the urging means.

The passages, for a given conductive element, may be provided distal one another.

The passages being provided distal one another may otherwise be described as the passages being provided relatively far away from one another when taken about at a cross-section of the conductive element. For example, if the conductive element has a generally triangular cross-section, the passages may be provided proximate corners of the conductive element. Similarly, if the conductive element has a square profile, then the passages may be provided in a diagonally opposing manner to one another. As such, the passages may be said to generally oppose one another through a cross-section of the conductive element. The passages may also be said to be provided at a periphery of the conductive element. Described another way, the passages may be provided away from a centre of a cross-section of the conductive element.

Advantageously, providing the passages distal one another has been found to improve the consistency and reliability with which the conductive elements are aligned with one another upon actuation of the urging means.

The plurality of passages provided in the outermost conductive element may merge into a single opening.

The single opening may be proximate an outermost tip, or end, of the electrode. As mentioned above, the outermost conductive element is the conductive element which is furthest away, or distal, the mounting body. The plurality of passages in the outermost conductive element merging into a single opening may otherwise be described as the flexible element being able to extend through one of the passages in the outermost conductive element and double back and then extend through the other of the passages. The flexible element may therefore follow a U-shaped path through the outermost conductive element.

Advantageously, having the plurality of passages merge into a single opening means that a single flexible element can double back on itself and the single flexible element can form the urging means. Put another way, an operator being able to grip both ends of a single flexible element ensures that any tension applied through the flexible element is transmitted to the conductive elements. This also removes the need to have ‘free’ ends of the flexible element secured to, and protected by, an end of the outermost conductive element.

The single opening also means that the flexible element can be replaced more easily if needed e.g. due to maintenance in use. The single opening also advantageously means that the flexible element is not exposed proximate an outermost tip of the outermost conductive element, owing to the opening defining a protective recess.

Each of the conductive elements may comprise:
a) a first end proximate the mounting body; and
b) a second, opposing end, distal the mounting body.

The first and second ends may be described as outer ends of each of the conductive elements. Put another way, it may be the first and second ends which engage corresponding ends of adjacent conductive elements in the conforming configuration.

For at least inboard conductive elements, one or more of the first and second ends may comprise an alignment feature configured to align the respective conductive element with the adjacent conductive element.

The alignment feature may specifically be configured to align the respective end with a proximate end of an adjacent conductive element.

Inboard elements is intended to refer to the conductive elements which are not at either end of the electrode. Put another way, if a first conductive element is coupled to the mounting body, then the inboard conductive elements refer to each of the elements which interpose the first conductive element and the outermost conductive element. In some arrangements there may be, for example, three inboard conductive elements. The inboard conductive elements may otherwise be described as in middle, central or interposing conductive elements. There may be a plurality of inboard conductive elements. In preferred arrangements, an end of each inboard conductive element comprises at least one alignment feature.

Advantageously, the aforementioned arrangement provides a useful guiding/alignment functionality which is repeatable and reliable.

The alignment features may comprise one or more of an alignment face, a projection and a recess.

The alignment face refers to a face which can engage an adjacent alignment face. The alignment face may be a flat face or an arcuate face. The alignment face may advantageously provide a location and/or sealing functionality.

In some embodiments the alignment face may be a flat face. The flat face may otherwise be described as a substantially flat border. The flat face may surround the respective projection or recess and may define a periphery of the end of the conductive element. The flat face may be described as an abutment face.

The projection and recess may take the form of a mortise and tenon-style interaction whereby the projection is received within the recess to align the conductive elements. Surrounding flat faces may then engage one another to provide the axial, or lengthwise, alignment between the conductive elements. When in the conforming configuration, this arrangement provides an outer electrode surface which is substantially continuous with only very minor gaps at joint lines between the conductive elements.

In preferred arrangements, each of the first ends of the inboard conductive elements comprises a flat face which surrounds a recess. In preferred arrangements, each of the second ends of the inboard conductive elements comprises a flat face which surrounds a projection. However, it will be appreciated that the arrangements may be reversed in other arrangements (e.g. the recesses may be provided at seconds ends).

The projections may further comprise rounded, or filleted, edges so as to reduce wear and aid the element even further.

Advantageously, the flat faces also provide a reliable electrical coupling between adjacent conductive elements when the electrode is in the conforming configuration. This ensures even the outermost conductive element is electrically connected to the power source, even if the power source is only directly connected to, for example, the first conductive element.

The projection may be an elongate, and comparatively narrow, projection. The projection may therefore be described as a tab, key, or tongue. The projection may be received by a corresponding recess. The recess may be similarly elongate, and narrow. The recess may generally match the external profile of the projection. The recess may be described as a slot, groove or keyway. The projection and recess may form a tongue and groove, key and keyway, or tab and slot arrangement.

In some embodiments, the projection may remain received by the slot irrespective of the configuration of the conductive elements. For example, the projection may be at least partly received by the recess when the conductive elements are in the movable configuration, the conforming configuration, or any configuration therebetween.

Advantageously, the projection being at least partly received by the recess, irrespective of the configuration of the conductive elements, improves the positional alignment of the conductive elements during the transition from the movable to the conforming configuration. This may be by way of reducing the number of degrees of freedom of movement between adjacent conductive elements.

Each of the inboard conductive elements may comprise:
a) at the second end, a projection and a surrounding alignment face; and
b) at the first end, a recess and a surrounding alignment face;
c) wherein the projection is receivable by a corresponding recess of an adjacent conductive element.

The projection may be described as a male alignment feature. The recess may be described as a female alignment feature.

The conductive elements may be hingeably connected to one another.

The conductive elements being hingeably connected to one another may otherwise be described as the conductive elements being pivotally connected to one another. Two conductive elements being hingeably connected to one another also encompasses a degree of translational movement between the elements (e.g. in the case of a camming hinge).

Advantageously, the conductive elements being hingeably connected to one another means that the conductive elements remain connected to each other whether in the moveable or conforming configuration. The risk of the conductive elements becoming detached from one another (e.g. where a hooked connection mechanism is otherwise employed) can therefore be reduced. The conductive elements being hingeably connected to one another also advantageously means there is a reduced risk that any conductive element of the electrode become detached in use.

A hinge pin may extend through each pair of projection and corresponding recess to hingeably connect the adjacent conductive elements.

The hinge pin may otherwise be described as a dowel. The hinge pin may be said to define an axis. The hinge pin may extend through bores of each of the adjacent conductive elements or, in preferred embodiments, extends through an elongate aperture and a pair of bores (i.e. giving rise to a slight translational movement as the electrode is transitioned to the conforming configuration).

The projection comprises a hooked portion.

The hooked portion may be described as finger-like. The hooked portion may extend from an end of the projection. The corresponding recess may receive at least the hooked portion. The corresponding recess may be generally narrowing, or reducing in extent, owing to the presence of an abutment portion. Put another way, the recess may generally increase in size moving from the end of the conductive element.

The projection and recess may form a latching, or locking, arrangement which substantially prevents axial separation of the conductive elements. Separation of the conductive elements may be substantially prevented by the hooked portion fouling on an abutment portion.

One way of implementing an arrangement to connect the conductive elements is a bayonet-style interaction between adjacent conductive elements. For example, one (a first) conductive element may comprise slots, whilst the adjacent (a second) conductive element comprises corresponding projections. The projections may be inserted into, and received by, the slots (e.g. by urging the conductive elements towards one another in a first, offset orientation). Once the projections disengage the slots, one of the conductive elements may then be rotated (relative to the other conductive element), so as to generally align the conductive elements and prevent inadvertent separation of the conductive elements. In one example, the conductive elements may be rotated by around 90° relative to one another. A cavity may be provided behind the slots to provide a space in which the projections can be received once they have disengaged the slots.

The conductive elements may remain connected to one another, e.g. daisy-chained to one another, in both the conforming and movable configurations owing to the interconnection between the projection and recess (specifically between the hooked portion and abutment portions thereof).

The projection, specifically the hooked portion thereof, may be manoeuvred (e.g. partly rotated) out of the recess to disconnect the conductive elements. Inadvertent disconnection of the conductive elements is thus avoided.

Passages may be at least partly recessed into the projection. This may otherwise be described as the flexible element being received at least part way through the projection.

Advantageously, this arrangement provides for improved alignment and also protects the flexible element in use.

A cross-section shape of the electrode may be non-constant along a length of the electrode.

The cross-section shape of the electrodes refers to an outer geometry of the conductive element when taken in cross-section along a length of the electrode. Put another way, it refers to the bound outer surface of the conductive element when taken in cross-section. The cross-section shape being non-constant along a length of the electrode is intended to mean that electrode effectively has a cross-sectional shape which varies along a length of the electrode. For example, proximate the mounting body the electrode may have a generally rectangular cross-section, partway along the electrode the electrode may have a generally trapezoidal cross-section, and towards the outer tip the electrode may have a generally triangular cross-section.

The electrode having a non-constant cross-section shape advantageously means that the outer surface of the electrode can conform more closely to the cavity in which the electrode is inserted in use. That is to say, the cross-section shape of the electrode may be determined, or at least influenced, by the cavity in which the electrode is to be inserted. It will be recalled that it is advantageous for there to be a substantially continuous clearance, or gap, between the outer electrode surface and the internal wall of the cavity. It will therefore be appreciated why the cross-section shape of the electrode may vary in accordance with the cross-section shape of the cavity.

The electrode assembly may further comprise a cap provided over at least a tip of the outermost conductive element.

The cap may be referred to as a protective cap, outer cap or outer body. The cap being provided over at least tip of the outermost conductive element means that the tip of the outermost conductive element (i.e. the point distal, or furthest away from, the mounting body) is not exposed in use. The cap may be made of nylon or another non-conductive material (e.g. a non-conductive plastic). The cap may be a sacrificial cap in that it may be replaced periodically. The cap may extend, for example, over the entire outermost conductive element, or over at least half of the length of the outermost conductive element.

The cap may be between around 1 mm and around 2 mm larger, radially, than an outer end of the outermost conductive element.

Advantageously, the cap provides a protective functionality of the outermost conductive element. It will be appreciated that when the electrode is inserted in the movable configuration, at a point during insertion the outermost conductive element will contact the internal wall of the cavity. It is this contact which initially means that the conductive elements can move and be roughly guided through the cavity (i.e. be deflected), before the urging means is actuated so as to properly align the conductive elements, and electrode, within the cavity. Providing the protective cap advantageously means that the wear on the outermost conductive element is reduced and that the risk of damage to the component is also reduced. The cap may be described as an emergency spacer in the event that the urging means fails in use (possibly resulting in disengagement of the conductive elements and contact between the outermost conductive element and the component).

The mounting body may be an alignment flange.

The alignment flange refers to a body which has at least one flat face and which can abut the component. The alignment flange may abut a corresponding alignment flange of the component. The alignment face may be described as an engagement face.

Advantageously, the mounting body being an alignment flange means that toggle clamps or pegs, or another fixture, can be readily used to couple the alignment flange to the component. The electrode can therefore be readily aligned and it be clear to an operator when the alignment flange has properly engaged the component (indicating the electrode to be correctly aligned).

The mounting body may comprise one or more electrolyte apertures extending therethrough.

The electrolyte apertures may otherwise be described as a bore. The electrolyte aperture preferably extends through an entirety of the mounting body. This may otherwise be described as extending through an entire thickness of the mounting body.

Advantageously, providing one or more electrolyte apertures through the mounting body means that a flow of electrolyte can be readily introduced past the electrode (between the electrode and the internal wall) using the mounting body. The mounting body may therefore form part of a baffle to reduce the risk of leakage of electrode. The electrolyte aperture in the mounting body may provide part of an electrolyte inlet or a discharge outlet depending on the component being machined and the parameters in use.

The mounting body may comprise only one electrolyte aperture, or a plurality of electrolyte apertures. The mounting body may comprise one electrolyte aperture for each electrode.

The mounting body may comprise an integral busbar.

The busbar being integral with the mounting body encompasses the mounting body and busbar being a single component. The busbar may comprise one or more bores which may act as sockets into which electrical connections can be received. The sockets may receive inserts, such as copper or stainless steel inserts, to aid the connection.

Advantageously, by making the busbar integral with the mounting body, the voltage drop between the busbar and the mounting body is reduced. It is desirable to keep the voltage drop low to maintain a high efficiency during electrochemical machining.

The mounting body may effectively transmit electrical power to the electrode and electrolyte conduit, from the busbar, in integral arrangements. The mounting body may therefore constitute a cathode in an electrochemical machining process.

The mounting body may be integral with a first conductive element of the electrode.

The mounting body being integral with the first conductive element of the electrode is intended to encompass the mounting body and first conductive element of the electrode being manufactured as a single body. The mounting body being integral with the first conductive element of the electrode is also intended to encompass arrangements where the mounting body and conductive element are manufactured separately and are joined in a subsequent manufacturing step (e.g. welding).

Advantageously, making the first conductive element of the electrode integral with the mounting body significantly improves the alignment of the electrode within the cavity to be machined. This is of particular advantage for electrochemical machining where the gap between the outer electrode surface and the internal wall of the cavity is an important parameter.

The mounting body may comprise a plurality of electrolyte channels distributed around the electrode.

The electrolyte channels may be said to extend at least partway through the mounting body. The electrolyte channels may extend across, or through, an entire extent of the mounting body between an engagement face and a rear face of the mounting body (e.g. between the two major faces of the mounting body).

The plurality of electrolyte channels may comprise four electrolyte channels. The electrolyte channels may be described as discharge channels. The plurality of electrolyte channels may be evenly distributed around the electrode. The plurality of electrode channels may be offset from, and distributed around, a perimeter of the electrode. The plurality of electrode channels may extend through the electrode. It may specifically be at least downstream ends of the plurality of electrolyte channels that are distributed around the electrode. Downstream ends of the plurality of electrolyte channels may be described as discharge apertures. Downstream ends of the plurality of electrolyte channels may be described as entry points for electrolyte around the electrode (and into the cavity to be machined). Downstream ends of the electrolyte channels may be defined in the engagement face of the mounting body. The electrolyte channels may be bores. The electrolyte channels may be inclined in a direction of electrolyte flow. Each of the plurality of electrolyte channels may be equal in volume. Electrolyte is preferably distributed equally between each of the plurality of electrolyte channels. The electrolyte channels may each define an equal effective flow area therethrough. In embodiments where the component to be machined comprises a plurality of cavities of different (e.g. non-equal) cross-sectional areas (e.g. a turbomachine housing with two volutes having different cross-sectional areas at a given point), respective arrays of electrolyte channels (e.g. downstream ends thereof) may be adjusted to provide an even (e.g. equal) flowrate of electrolyte through each cavity. That is to say, the size and/or geometry of the downstream ends (e.g. discharge apertures) of the electrolyte channels may be altered to adjust the velocity, and so mass flowrate, of electrolyte flow for that cavity.

The plurality of electrolyte channels, preferably downstream ends thereof, may be evenly distributed around the electrode. An even distribution is intended to encompass a continuous even distribution (e.g. downstream ends of electrolyte channels extending in a generally repeating pattern around an entire perimeter of an electrode) and a discontinuous even distribution (e.g. two series of downstream ends of electrolyte channels, provided at two sides of an electrode, evenly distributed along those two sides only).

A respective plurality, or array, of electrolyte channels may be distributed around each electrode in embodiments comprising a plurality of electrodes.

Advantageously, incorporating a plurality of electrolyte channels distributed around the electrode results in an electrolyte flow being more evenly distributed around the electrode during electrochemical machining. This has been found to avoid undesirable flow characteristics such as regions of recirculation in which insulating hydroxides, byproducts of electrochemical machining, may otherwise be recirculated and reduce the efficiency of, or prevent, electrochemical machining from occurring in those regions.

The electrolyte channels and/or electrolyte conduit may be referred to as an electrolyte delivery system. The distribution of electrolyte channels may be said to conform to an outer surface of the electrode (e.g. follow the outer surface of the electrode).

The electrolyte channels may be arcuate cavities.

Arcuate cavities is intended to refer to at least the cross section geometry of the electrolyte channels at a downstream end. In preferred embodiments downstream ends of the electrolyte channels occupy, or extend, around about a quarter of the perimeter of the electrode. As such, the combination of four electrolyte channels extends effectively around an entire perimeter of the electrode. For embodiments having n electrolyte channels, downstream ends of the electrolyte channels preferably occur around 1/n of a proportion of the perimeter of the electrode (proximate the mounting body).

Advantageously, the electrolyte channels being arcuate cavities means that flow can be smoothly directed around at least partly arcuate electrodes.

The electrolyte channels may vary in cross-sectional area from an upstream end to a downstream end.

The electrolyte channels may increase in cross-sectional area (e.g. normal to a flow direction) from the upstream end to the downstream end. Alternatively, the electrolyte channels may reduce in cross-sectional area from the upstream end to the downstream end.

Advantageously, the electrolyte channels varying in cross-sectional area means that an electrolyte conduit can be used to feed the electrolyte channels whilst the electrolyte channels guide the flow around the electrode, e.g. a perimeter thereof, to provide high efficiency electrochemical machining.

The electrolyte channels may be defined by one or more ribs.

The one or more ribs may be tapered at an upstream end. The one or more ribs may incorporate a reduction in the cross-sectional area at an upstream end. The one or more ribs may have a generally streamlined geometry at an upstream end.

Each of the electrolyte channels is preferably defined by at least two ribs. The ribs refer to generally elongate bodies of material which are comparatively thin in view of their length. At least one rib may separate each of the electronic channels from one another.

Advantageously, such geometries have been found to split (e.g. divide) the (bulk) electrolyte flow without inducing swirl and/or turbulence in the electrolyte flow. The presence of the one or more ribs also advantageously provides a higher surface area in contact with the electrolyte such that the electrolyte can be charged by the mounting body (where the electrolyte conduit is electrically connected to [e.g. integral with] the mounting body) before the electrolyte enters the cavity to be machined. This may be referred to as precharging.

Defining the electrolyte channel with ribs also provides a comparatively high effective flow area through the electrolyte channels (e.g. flow restrictions are reduced or avoided).

The electrode assembly may further comprise an electrolyte conduit.

The electrolyte conduit may otherwise be referred to as an electrolyte supply or an electrolyte feed. The electrolyte conduit has an extent (e.g. a length) which may be axial (i.e. straight) or may incorporate one or more arcuate portions (e.g. be bent). The electrolyte conduit preferably has a circular cross-section.

The electrolyte conduit may be manufactured from an electrically conductive material. The electrolyte conduit may be manufactured from the same material as the mounting body.

Advantageously, the electrolyte conduit provides electrolyte for the electrochemical machining process in a uniform manner to the mounting body. The electrolyte conduit may be integral with the mounting body (e.g. encompassing the electrolyte conduit being manufactured as a single component with the mounting body, and the electrolyte conduit being joined to the mounting body in a separate manufacturing process [e.g. welding]).

The electrolyte conduit may extend normal to the mounting body.

The electrolyte conduit extending normal to the mounting body may otherwise be described as the electrolyte conduit being perpendicular. Described another way, the electrolyte conduit may be said to project from the mounting body, preferably a rear face thereof. The electrolyte conduit extending normal to the mounting body generally aligns the electrolyte conduit with at least a first conductive element of the electrode such that electrolyte flowing through the electrolyte conduit does not significantly change direction as it moves towards, and around, the electrode. The electrolyte conduit is preferably upstream of a plurality of electrolyte channels where incorporated.

The electrolyte conduit may be in electrical communication with the mounting body.

The electrolyte conduit being electrical communication with a mounting body is intended to mean that the electrolyte conduit is provided at a similar, or the same, potential as the electrolyte conduit. Where the electrolyte conduit is integral with the mounting body, the electrolyte conduit is in electrical communication with the mounting body. The electrolyte conduit is preferably held at the same potential as the rest of the mounting body. The electrolyte conduit may be considered to define part of the electrode where the electrode and electrolyte conduit are both electrically connected to the mounting body. Similarly, the mounting body may be considered to define part of the electrode.

Advantageously, as electrolyte flows through the electrolyte conduit, charge may be transferred to the electrolyte by the electrolyte conduit to precharge the electrolyte before it enters the cavity to be machined. This has been found to improve the quality of machining at an upstream end of the cavity.

The electrolyte conduit may have an extent of at least around a major dimension of a cross-section of the conduit.

The extent of the electrolyte conduit may otherwise be referred to as a length of the electrolyte conduit. Where the electrolyte conduit is a circular conduit (e.g. a circular pipe), a major dimension may otherwise be referred to as a diameter, preferably an internal diameter. For a rectangular conduit, the major dimension of the cross-section is the longer of the sides of the rectangle. If the electrolyte conduit has a variable cross-section, the major diameter refers to a largest (internal) major diameter. However, the electrolyte conduit preferably has a uniform, or constant, cross-section. The extent of the electrolyte conduit may extend up until a point where the electrolyte flow is divided (e.g. upstream of electrolyte channels).

Advantageously, the electrolyte conduit having an extent of at least around a major dimension of a cross-section of the conduit has been found to provide desirable flow-guiding properties and also provide a degree of precharging to the electrolyte where the conduit is electrically connected to the mounting body.

The electrolyte conduit may have an extent at least equal to around three, or more, major dimensions of the cross section of the conduit.

The electrolyte conduit may have an extent of at least around six major dimensions of the cross-section of the conduit.

Advantageously, the electrolyte conduit having an extent of at least around six major dimensions of the cross section of the conduit has been found to provide a desirable precharging effect to the electrolyte. Furthermore, an electrolyte conduit around six major dimensions in length has been found to provide a low turbulence flow of electrolyte to the electrolyte channels, resulting in high efficiency electrochemical machining.

The electrolyte conduit may have an extent equal to around six major dimensions of the cross-section of the conduit.

The electrode may be a first electrode; and
a) a second electrode, comprising a respective plurality of conductive elements, may be coupled to the mounting body.

An electrode assembly comprising two electrodes may otherwise be described as a twin electrode arrangement. The electrode assembly may be said to comprise a pair of electrodes (i.e. a first and second electrode) or may comprise further electrodes.

Advantageously, providing a pair of electrodes coupled to the mounting body means that a single mounting body can be used to anchor, or align, the two electrodes. This reduces the number of steps required by an operator to align and couple the electrode assembly to the component.

The electrodes may share a single, common urging means. Alternatively, the electrode assembly may comprise an urging means associated with each electrode (i.e. having two urging means for two electrodes, and so on).

An electrode assembly comprising a plurality of electrodes is particularly advantageous for electrochemical machining volutes of a twin volute turbine housing. Twin volute turbine housing is intended to mean a turbine housing having a pair of discrete volutes, having an associated cross-sectional area, which may converge to form a single volute at some point along an extent of the volutes. The twin volute turbine housing may be an asymmetric or symmetric twin volute arrangement.

According to a second aspect of the disclosure there is provided a method of electrochemically machining a cavity of a component using the electrode assembly according to the first aspect of the disclosure, the method comprising:
a) inserting the outermost, and successive, conductive elements of the electrode through an opening of the cavity and along the cavity whilst the electrode is in the movable configuration;
b) coupling the mounting body to the component to align the electrode within the cavity, and actuating the urging means to transition the electrode from the movable configuration to the conforming configuration, the conductive elements thus defining the substantially continuous outer electrode surface which conforms to at least part of an internal wall of the cavity; and
c) applying a negative charge to the electrode, and providing a flow of electrolyte through the cavity to remove material from the internal wall of the cavity.

The component may be grounded to earth. Grounding the component to earth means that substantially any static is discharged from the component. Advantageously, this means that when the flexible electrode is negatively charged, and therefore forms a cathode, the workpiece effectively forms the anode by virtue of having a greater positive charge. Grounding the component to earth, in combination with providing the electrolyte, therefore completes the circuit to facilitate the electrochemical machining of the component. The component may be connected to a positive terminal of a power supply (to define a cathode). The electrode may be connected to a negative terminal of a power supply (to form an anode).

Inserting the electrode through the opening may be described as the electrode being inserted into the cavity. The electrode may be said to penetrate the cavity. Inserting the electrode along the cavity is intended to mean that the electrode passes at least partway through an extent, or length, of the cavity. The electrode may be passed through an entirety of the cavity i.e. a distal end of the electrode may abut an end wall, end point, or tip of the cavity. Alternatively, the electrode may extend only partway through the cavity. That is to say, there may still be an extent of the cavity which is not occupied by the electrode in use.

Successive conductive elements is intended to refer to the conductive elements which are effectively upstream of the outermost conductive element. Put another way, it will be understood that, upon insertion of the electrode into the opening of the cavity, the outermost conductive element will be inserted first, followed by the next conductive element which is adjacent to the outermost conductive element. The insertion may otherwise be described as sequential insertion of the conductive elements. The conductive elements may be described as being arranged in an end-to-end manner. The conductive elements may be described as being arranged consecutively.

The opening may be a circular opening or an opening having another geometry. The opening may otherwise be referred to as an aperture.

The conductive elements of the electrode may be inserted along the cavity such that the conductive elements, and the electrode more generally, occupy an entire extent, or length, of the cavity. Alternatively, the electrode, and constituent conductive elements, may only be inserted partway along the cavity (e.g. such that part of the cavity is free of the electrode).

Insertion of the conductive elements whilst the electrode is in the moveable configuration is intended to mean that the conductive elements can move relative to one another whilst the electrode is inserted. Advantageously, this means that the electrode can be inserted into a complex cavity, such as a volute of a turbomachine housing, whilst effectively conforming to the cavity (in order to provide an efficient electrochemical machining operation).

Coupling the mounting body to the component may occur by way of the mounting body engaging the component. The mounting body may be temporarily affixed to the component using a temporary fixture. Examples include the use of pegs, which may align bores of the mounting body with corresponding bores in the component, or the use of toggle clamps to secure the mounting body to the component. In preferred arrangements, and where the component is a turbomachine housing, the mounting body may specifically engage a flange of the turbomachine housing.

Aligning the electrode within the cavity is intended to mean that the electrode is located, when viewed in cross-section, substantially centrally within the cavity such that a substantially continuous clearance, or gap, exists around an exterior of the conductive element and the internal wall of the cavity.

Actuating the urging means may otherwise be described as transitioning the electrode from the moveable configuration to the conformed configuration. Actuating the urging means may take one of many forms depending upon which urging means is incorporated. Where the urging means is a flexible element, actuating the urging means may comprise tensioning the flexible element. Where the urging means is a spring and hinge system, the urging may occur substantially automatically. Where the urging means is an electrical system, such as an electromagnetic system, actuating the urging means may comprise activating an electromagnet to bring the conductive elements towards one another. The actuation preferably occurs in a repeatable and non-destructive manner such that the actuation can be subsequently released and the electrode withdrawn following the electrochemical machining operation.

The urging means may be described as securing the conductive elements in the conforming configuration whilst, or at least before, electrochemical machining occurs. The electrode is preferably substantially fixed in geometry (e.g. substantially no relative movement between the conductive elements) whilst electrochemical machining occurs. The electrode may be maintained in the conforming configuration for the duration of electrochemical machining.

The conductive elements defining the substantially continuous outer electrode surface may otherwise be described as outer surfaces of the constituent conductive elements substantially aligning with one another to define the overall outer electrode surface. Substantially continuous is intended to mean that there may be small gaps, such as a join line, between the conductive elements, but that the surfaces otherwise align to define a generally continuous, and single, surface.

The outer electrode surface conforming to at least part of the internal wall of the cavity is intended to mean that the outer electrode surface generally follows the profile of the internal wall for at least part of an extent of the cavity, moving from the opening towards a distal end of the cavity. As mentioned above, the electrode may not be placed along an entire length of the cavity in use, and so the electrode may only extend partway along the extent of the cavity. The outer electrode surface preferably conforms to an extent of the internal wall of the cavity which is substantially equal to a length of the electrode. Put another way, the electrode preferably conforms to the cavity along the entire length of the electrode.

Applying a negative charge to the electrode is intended to mean that the electrode is negatively charged. In other words, the electrode is the cathode in the electrochemical machining process summarised above. The negative charge may be applied by connecting the flexible electrode to a power supply. The power supply may a DC (direct current) power supply.

The electrode may be electrically connected to a power supply, which may be a DC power supply. The DC power supply is also readily adjustable if needed. At least one of the conductive elements may be directly connected to the power supply. When the electrode is in the conforming configuration, engagement between the conductive elements may electrically couple the conductive elements together such that the power supply is indirectly connected to even the outermost conductive element.

The DC power supply may have an output amperage of at least around 100 A. The DC power supply having an output amperage of at least 100 A has been found to be effective for use with an electrochemical machining process. The output amperage may be around 140 A, or around 1 kA, or around 1.5 kA or 2.5 kA. The output amperage may be up to around 5 kA.

The DC power supply may have an output voltage of at least around 10 V. It will be appreciated that the output voltage may be −10 V, depending upon which terminal of the power supply the output is taken from. The output voltage may be around 20 V, around 30V, or around 40 V. For health and safety reasons, it is desirable that the output voltage does not exceed around 50 V.

The power supply may provide around 1.5 kA at around 40V (i.e. a 60 kW power supply). The power supply may provide around 2.5 kA at around 40V (i.e. a 100 kW power supply).

Providing the flow of electrolyte may comprise pumping the electrolyte. Pumping the electrolyte may provide a stream of electrolyte. The electrolyte may be saltwater or any other fluid which provides a flow of ions. A mild acid solution is another example of a suitable electrolyte. The electrolyte may include Sodium Nitrate and/or Sodium Chloride. The concentration may range from around 15% to around 30% by volume. Where a combination of Sodium Nitrate and Sodium Chloride is included, the ratio of Sodium Nitrate to Sodium Chloride may be, for example, around 80:20, around 70:30 or around 60:40 by volume. The electrolyte may consist of 100% Sodium Nitrate at a concentration, by volume, of between around 15% and around 30%.

Pumping a flow of electrolyte through the cavity may be described as urging an electrolyte flow through the opening, along the cavity, and out of the cavity via a discharge outlet. The flow of electrolyte may suspend material removed from the internal wall, through the cavity, and out of the cavity via the discharge outlet.

Removing material from the internal wall may be referred to as polishing the internal wall. Removing material from the internal wall may otherwise be referred as reducing a surface roughness of the internal wall. Removing material from the internal wall may be referred to as improving a surface finish of the internal wall.

The method is not limited to carrying out the steps in the order set out in the claim. For example, the negative charge may be applied to the electrode before the electrode is inserted through the opening and along the cavity (although, in practice, it is anticipated that the electrode will be fully inserted into the cavity before power is switched on and the charge is applied). Similarly, electrolyte may be pumped through the cavity before the electrode is inserted. With that said, the electrode may be inserted before the negative charge is applied to the electrode. Similarly, the electrolyte may be pumped through the cavity after the electrode has been inserted, and optionally after the negative charge is applied to the electrode.

Advantageously, the above described method means that a relatively complex cavity, which may not otherwise be electrochemically machined, can be electrochemically machined. A surface finish of the internal wall of the cavity, and/or tolerance of the cavity more generally, can thus be improved in a repeatable and reliable manner by using the process.

Advantageously, the ability to transition the configuration which the conductive elements are in means that the electrode can be inserted through a complex geometry cavity, and the urging means be actuated once the electrodes are aligned within the cavity, such that the conductive elements are then drawn into engagement with one another. This improves the repeatability of the process by ensuring that the outer electrode surface is in facing relations with the internal wall and that a substantially continuous clearance is defined therebetween. The process advantageously does not require any contact between the electrode and the internal wall during the process.

The method may further comprise releasing the urging means, decoupling the mounting body from the component and withdrawing the electrode from the cavity, the electrode transitioning to the movable configuration as the electrode is withdrawn from the cavity.

Releasing the urging means may otherwise be described as deactivating or reversing the actuation of the urging means. Releasing the urging means may comprise releasing the tension from a flexible element, deactivating the power supply to power down an electromagnet, or similar.

Decoupling the mounting body from the component may otherwise be described as disengaging the mounting body from the component, or removing a fixture which secured the mounting body to the component. The mounting body may be subsequently separated from the component so as to withdraw the electrode from the cavity. Withdrawing the electrode from the cavity may otherwise be described as retracting the electrode from the cavity whilst separating the mounting body from the component, so that a gradually reducing extent of the electrode is provided within the cavity.

The electrode transitioning to the moveable configuration as the electrode is withdrawn from the cavity may occur at the point when the urging means is released. Alternatively, such as in the case of an urging means which is a flexible element, releasing the urging means may comprise relaxing the tension in the flexible element, but the conductive elements may remain substantially aligned with one another until such a time that the conductive elements contact the internal wall so as to increase the separation there between the conductive elements. Put another way, the conductive elements may remain in contact with one another until the conductive elements are deflected by contacting the internal wall. As such, the urging means may be described as a locking means, or similar, which secures the conductive elements in the conforming configuration, but when disengaged means that the conductive elements can then separate.

The electrode transitioning to the movable configuration as the electrode is withdrawn from the cavity advantageously means that a cavity with a complex geometry, such as a volute of a turbomachine housing, can still be machined using the electrode. For example, almost any cavity can be machined with the electrode because of the ability for the electrode to effectively conform to the internal wall of the cavity by virtue of the moveable and conforming configurations.

A low power test may be conducted before an operational power is supplied to the electrode.

Low power test refers to an initial check of the system, after the urging means has been actuated. The low power test can be run to check for any short circuit, which may indicate (undesirable) contact between the electrode and the component. Put another way, a failed low power test may be indicative of a misalignment of the electrode within the cavity.

A successful low power test provides the operator with an indication that the electrode is correctly aligned within the cavity. The operator can then provide an operational power to the electrode, to begin the electrochemical machining process. The operational power may be described as a full electrochemical process power.

Advantageously, the low power test reduces the risk that the electrode becomes welded to the internal wall of the cavity due to a misalignment of the electrode within the cavity.

An indicator may be applied to the component during the electrochemical machining.

One, or a plurality, of indicators may be applied. The indicator(s) may be a machined feature (for example). An example of the machined feature is a hemisphere having, for example, a 5 mm diameter, although it will be appreciated that a wide range of other geometries, and features, could otherwise be machined into the component. This can advantageously provide a visual indicator (e.g. a poka-yoke) that the cavity has been polished, and polished to its full depth. The feature can also be used as a non-functional counterfeit detection feature.

The feature may be applied to an exterior of the component (e.g. an outer face of a flange) or an interior of the component (e.g. to the internal wall). The indicator(s) may be applied by the electrode (e.g. to the internal wall of the cavity) and/or may be applied by the mounting body (e.g. to an exterior of the component).

The cavity may be a fluid conduit. The cavity may comprise a fluid conduit.

Fluid conduit refers to a cavity (e.g. a passage) through which a fluid flows in use. The fluid may be a liquid (e.g. water or oil) or a gas (e.g. air). Example of fluid conduits include: a turbine housing volute, a compressor housing volute, a pipe within a manifold, and water or oil conduits.

Components which incorporate fluid conduits include manifolds, EGR valves and turbomachine housings, in particular turbine housings and compressor housings for turbochargers. An engine block is a further component incorporating a fluid conduit.

Manifolds, turbomachine housings and EGR valves are just some examples of components which may incorporate a cavity that can be electrochemical machined using the above defined method. These are also example of components which may incorporate a nonlinear cavity (e.g. incorporating a bend along an extent of the cavity) which is a challenging geometry to electrochemically machine (unless the flexible electrode described herein is utilised). It will be appreciated that a variety of other components, and associated cavity geometries, can be used in combination with the method.

The component, which may be a turbomachine housing such as a turbine housing or compressor housing, may be manufactured from cast iron. The component, which may be a turbine housing or compressor housing, may be manufactured from aluminium. The component, which may be a turbine housing or compressor housing, may be manufactured from stainless steel.

The component may be a turbine housing or a compressor housing for a turbocharger, and the cavity may be a turbine housing volute or a compressor housing volute respectively.

A volute has a cross-section which changes along an extent, or length, of the volute. That is to say, the volute has a non-constant cross-sectional area, or shape taken normal to the length of the volute. This can otherwise be described as generally tapering.

For the compressor housing volute, the cross-section may transition from a generally smaller circle to a generally larger circle (moving from the opening to a discharge outlet). For the case of a turbine housing volute, a cross-section may transition from a generally larger rectangle to a generally smaller rectangle. It will be appreciated that the shapes are by way of example only, and that a variety of other geometries, including complex cross-sectional shapes, may otherwise be incorporated.

For a turbine housing volute, defined by a cross-section which extends along an arcuate extent of the volute, a width of the cross-section (i.e. a major dimension) may reduce from around 80 mm (proximate a turbine housing inlet) to around 15 mm (distal the turbine housing inlet). A height of the cross-section (i.e. a minor dimension) may reduce from around 100 mm (proximate a turbine housing inlet) to around 40 mm (distal a turbine housing inlet). The width of the cross-section may be taken in the axial direction. The height of the cross-section may be taken in a radial direction.

For a compressor housing volute, the cross-section may be generally circular and a corresponding diameter may reduce from around 100 mm (proximate a compressor housing outlet) to around 15 mm (distal a compressor housing outlet).

An extent, or length, of the volute may be said to be arcuate. That is to say, moving from the opening to an end point, or distal tip, of the volute, the midpoint of the cavity (i.e. a midpoint of the cross-section) is generally arcuate. The volute may be said to extend part way around the circumference of a circle. The geometry may otherwise be described as generally snail shell like, or partly spiral. The volute may also extend in a direction out of a plane of the spiral. That is to say, the volute may be spring-like, or partly helical. Put another way, the geometry along the length of the volute may be similar to that if a generally circular ring of flexible material is cut, and the two ends are urged in opposing axial directions.

The volute may be between around 250 mm and around 2000 mm in extent (i.e. length). This may correspond with a housing where the volute centreline is provided at a diameter of between around 150 mm and around 600 mm.

The turbine housing may be a twin volute housing. The turbine housing may be an asymmetric housing.

The electrode may extend through at least around 50% of an extent of the volute. The electrode extending through to at least around 50% of the extent of the volute is advantageous in that a significant proportion of the volute can be machined in the electrode chemical machining process. The electrode may extend through at least around 80% of the extent of the volute, or at least around 85% of the extent of the volute.

A distal end of the volute may not be occupied by the electrode in use. The performance benefit gained by electrochemically machining the distal end of the volute may be less than other parts of the volute, so it may be preferable that the distal end of the volute is not electrochemically machined. The electrode may terminate between around 5 and around 25 mm from a distal tip of the volute. The electrode may be described as extending towards an end of the volute tail, or tip. In some arrangements, an entire extent of the volute may be occupied by the electrode. That is to say, the electrode may extend through an entire extent of (for example) the compressor housing volute or turbine housing volute.

The electrode may be less than between around 250 mm and around 2000 mm in extent (i.e. length).

The opening may be an inlet of a turbine housing or an outlet of a compressor housing. The inlet of the turbine housing may be generally tangential. The outlet of the compressor housing may be generally tangential. By inserting the electrode through an opening which is one of these features, the electrode can be inserted through a readily accessible aperture having a geometry which generally decreases moving along an extent of the volute. This is advantageous in being able to insert an electrode, having a corresponding tapering geometry, such that the electrode conforms to the internal cavity along an extent of the electrode and/or cavity.

Electrolyte may be pumped through the opening and be discharged through an outlet of the turbine housing or an inlet of a compressor housing respectively.

Pumping electrolyte through the opening, the opening being an inlet of a turbine housing or an outlet of a compressor housing, provides a convenient means of connecting the volute to an electrolyte source. As mentioned above, these features are readily accessible from an exterior of the component. Discharging the electrolyte via an outlet of the turbine housing, or an inlet of the compressor housing, these features being generally axial, also provides a convenient way of discharging the electrolyte flow. The discharge electrolyte flow, i.e. the electrolyte flow downstream of the conductive body, comprises pieces of machined material. As well as facilitating the electrochemical machining process, the electrolyte also transports machined material out of the component. Machined material may be in the form of fine particle hydroxides, which are diluted into the electrolyte. The electrolyte may be filtered continuously, as part of the process, so as to remove the particles from the electrolyte (before the electrolyte is recirculated). The electrolyte may be cooled as part of the recirculating process. The electrolyte may dissipate heat generated by the electrochemical machining process.

It will be appreciated that the direction of electrolyte flow could also be reversed e.g. for a turbine housing, electrolyte may be pumped in via the turbine housing outlet and discharged via the turbine housing inlet. More specifically, the electrolyte may be pumped in via a turbine inducer gap.

According to a third aspect of the disclosure there is provided a computer program comprising computer executable instructions that, when executed by a processor, cause the processor to control an additive manufacturing apparatus to manufacture the electrode, or a conductive element thereof, according to the first aspect of the disclosure.

According to a fourth aspect of the disclosure there is provided a method of manufacturing an electrode, or a conductive element thereof, via additive manufacturing, the method comprising:
a) obtaining an electronic file representing a geometry of the electrode, or a conductive element thereof, according to the first aspect of the disclosure; and
b) controlling an additive manufacturing apparatus to manufacture, over one or more additive manufacturing steps, the electrode, or a conductive element thereof, according to the geometry specified in the electronic file.

According to a fifth aspect of the disclosure there is provided a component comprising a cavity electrochemically machined using the electrode assembly according to the first aspect of the disclosure and/or using the method according to the second aspect of the disclosure.

The component may be any component incorporating a fluid conduit, such as a manifold, EGR valve, engine block or turbomachine housing, in particular a turbine housing or a compressor housing for a turbocharger.

Where the component is a turbine housing or a compressor housing for a turbocharger, the cavity may be a turbine housing volute or a compressor housing volute respectively.

The optional and/or preferred features for each aspect of the disclosure set out herein are also applicable to any other aspects of the disclosure, where appropriate.

### BRIEF DESCRIPTION OF THE DRAWINGS

Embodiments of the present disclosure will now be described, by way of example only, with reference to the accompanying drawings, in which:

FIG. 1 schematically depicts a known electrochemical machining process;

FIGS. 2a and 2b are perspective views of an electrode assembly according to an embodiment of the disclosure;

FIG. 3a is a perspective view of a wireframe model of the electrode of FIGS. 2a and 2b in isolation;

FIGS. 3b and 3c are magnified views of parts of the electrode of FIG. 3a;

FIG. 4 is a perspective view of two inboard conductive elements, in isolation, of the electrode shown in FIGS. 2 to 3c;

FIG. 5a is a perspective view of an alternative electrode in a moveable configuration;

FIG. 5b is a perspective view of the electrode of FIG. 5a transitioning to a conforming configuration;

FIGS. 5c to 5e are various views of the electrode of FIGS. 5a and b in the conforming configuration;

FIG. 6 is a cross-section view of a turbine housing with the electrode of FIGS. 2a to 4 inserted into a volute thereof;

FIG. 7 is a view taken normal to a flange of the turbine housing, showing two electrodes, of FIGS. 2 to 4, inserted into volutes of the turbine housing;

FIGS. 8 to 11 are cross-section views illustrating the cross-section shape of the electrodes, and volutes, at different points along the volute/electrode;

FIG. 12a and 12b are perspective views indicating the external geometry of the electrodes of FIGS. 2 to 4 and 6 to 11;

FIG. 13 shows the overall geometry of the electrodes of FIG. 12a and 12b;

FIG. 14 is a perspective view of part of the electrodes of FIG. 12a and 12b;

FIG. 15a to 15d are various views of outer ends of a conductive element according to another embodiment;

FIG. 16 is a perspective view of part of a conductive element 400 according to another embodiment;

FIG. 17 is a part-cutaway side view of the conductive element of FIG. 17 and an adjacent (second) conductive element in a movable configuration;

FIG. 18a to 18c show part of two conductive elements, according to another embodiment, in a movable configuration;

FIG. 19 is a perspective view of a mounting body, according to another embodiment, connected to electrolyte conduits;

FIGS. 20 and 21 are perspective view of parts of an electrode according to another embodiment;

FIG. 22 is a perspective view of a mounting body according to another embodiment;

FIG. 23a and 23b are perspective views of a mounting body according to another embodiment;

FIG. 23c and 23d are perspective cross-section views of the mounting body of FIG. 23a and 23b;

FIG. 24 is a perspective cross-section view of a mounting body according to another embodiment;

FIG. 25 is a perspective view of part of a mounting body according to another embodiment;

FIG. 26 shows results of a Computational Fluid Dynamics (CFD) simulation conducted on an electrode assembly comprising the mounting body of FIG. 24

FIG. 27 shows the results of a CFD simulation conducted on a modified electrode assembly;

FIG. 28 shows the results of a CFD simulation carried out on an electrode assembly comprising the mounting body of FIG. 25;

FIG. 29a and 29b are perspective views of an electrode assembly according to another embodiment;

FIG. 29c is a perspective cross-section view of part of the electrode assembly shown in FIGS. 29a and b;

FIGS. 30 and 31 show the results of CFD simulations conducted on the electrode assembly of FIGS. 29a-c;

FIG. 32a and 32b are perspective views of an electrode assembly according to another embodiment;

FIG. 33a to 33c are perspective views of an electrode assembly according to another embodiment;

FIG. 34 is a perspective view of an electrode assembly according to another embodiment;

FIG. 35a and 35b are perspective views of the electrode assembly of FIG. 34 installed in situ and coupled to a compressor housing;

FIG. 36 is a table of experimental data obtained using the electrode assembly of FIG. 29a to 29c when a turbine housing is machined;

FIG. 37 is a plot of some of the data shown in FIG. 36, indicating the relationship between conduit length and surface finish;

FIG. 38 is a table of experimental data obtained using the electrode assembly of FIG. 29a to 29c when a compressor housing is machined;

FIG. 39 is a plot of some of the data shown in FIG. 38, indicating the relationship between conduit length and surface finish; and

FIG. 40 is a plot indicating the relationship between conduit length and the Reynolds Number of electrolyte flow.

### DETAILED DESCRIPTION

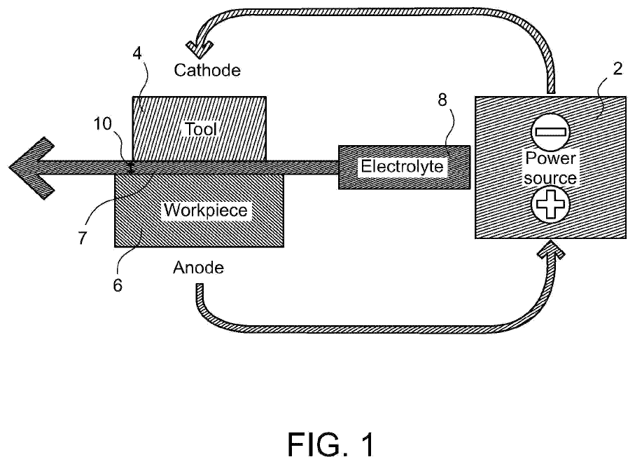

FIG. 1 is a schematic illustration of a known electrochemical machining process.

A power source 2, which may be a DC power source, is used to apply a negative charge to an electrode 4. This may be by virtue of the electrode 4 being electrically connected to a negative terminal of the power source 2. The electrode 4 therefore forms a cathode. The power source is preferably a DC power supply.

A positive charge is effectively applied to a component 6, which is to be machined, by electrically connecting the component 6 to a positive terminal of the power source 2 or, alternatively, by connecting the component 6 to ground (i.e. grounding the component). Given that the component 6 is more positively charged than the electrode 4, the component forms an anode.

A gap 10 is provided between the electrode 4 and the component 6. Specifically, the gap 10 is provided between the electrode 4 and an electrode-facing surface 7, or exposed surface, of the component 6. The gap 10 may otherwise be referred to as a clearance.

A flow of electrolyte 8 is pumped through the gap 10 between the electrode 4 and the component 6 (specifically the electrode facing surface 7 thereof). The electrolyte flow 8 effectively completes the circuit, owing to the electrolyte being conductive. As electrons flow across the gap 10, material from an electrode facing surface 7 of the component 6 is dissolved, or removed. It will also be appreciated that material will be removed from the electrode facing surface 7 in a manner which generally conforms to the electrode 4 geometry. The electrolyte 8 then transports the removed material downstream of the component 6 and electrode 4.

The electrodes used in existing processes limit the geometries that can be machined by electrochemical machining. Specifically, given that the electrode 4 is in facing relations with the electrode-facing surface 7 of the component 6, and that a gap 10 is present in order for the electrolyte flow 8 to pass through, prior art methods and apparatuses may be unsuitable for use with more complex component geometries.

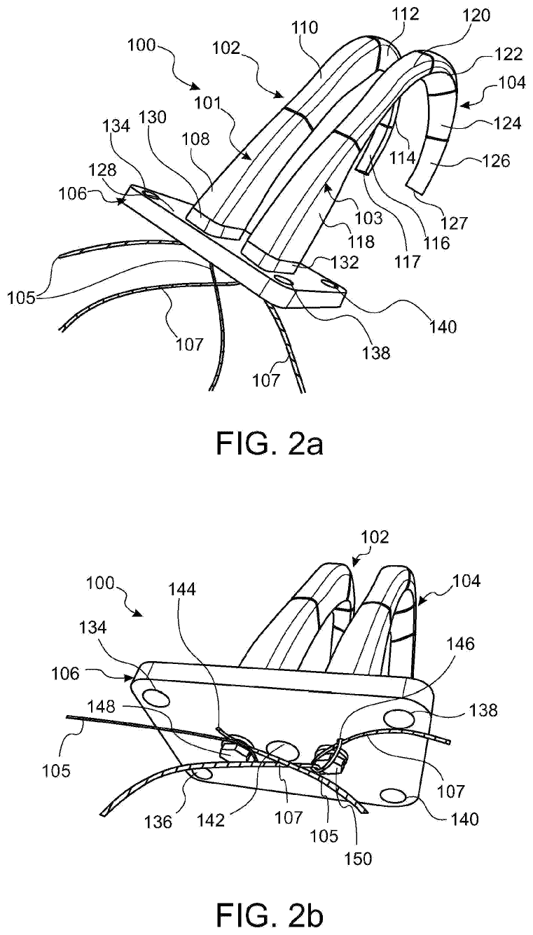

FIGS. 2a and 2b are perspective views of an electrode assembly 100 according to an embodiment of the disclosure.

The electrode assembly 100 comprises two electrodes 102, 104, a mounting body 106 and two urging means in the form of cords 105, 107.

Although the illustrated electrode assembly 100 comprises two electrodes 102, 104, it will be appreciated that, in some embodiments, the electrode assembly may comprise only a single electrode.

Each of the electrodes 102, 104 comprises a plurality of conductive elements. In connection with the first electrode 102, the first electrode 102 comprises five conductive elements 108, 110, 112, 114, 116. Of note, a join line between the third and fourth conductive elements 112, 114 is obscured from view in FIG. 2a. In connection with the second electrode 104, the second electrode 104 comprises a corresponding five conductive elements 118, 120, 122, 124, 126. The fifth conductive element 116, 126 of each of the first and second electrodes 102, 104 may be referred to as an outermost conductive element owing to its position at a greatest distance, along the electrode length, from the mounting body 106. Distal ends of each of the fifth, or outermost, conductive elements 116, 126 define outermost tips 117, 127 of the electrodes 102, 104.

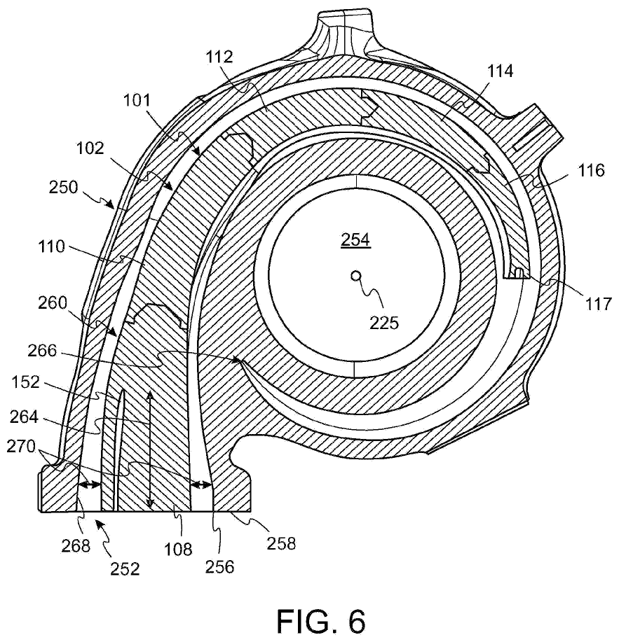

In use, the mounting body 106 engages a component to be machined to align the electrodes 102, 104 within a cavity of the component. An example of one electrode being aligned within a volute, an example of a cavity to be machined, is illustrated in FIGS. 6 to 11 and will be described in detail later in this document.

Returning to FIG. 2a, in the illustrated embodiment the mounting body 106 takes the form of a mounting flange. The mounting flange is generally cuboidal and defines an engagement face 128 which, in use, engages a corresponding face (e.g. a flange) of a component to be machined. Provided in the engagement face 128 are two bosses 130, 132 which project therefrom. The first conductive elements 108, 118 of the electrodes 102, 104 respectively are coupled to the mounting body 106 at the respective bosses 130, 132. The coupling may be by way of a number of different means including a bolted connection (as shown in FIG. 2b).

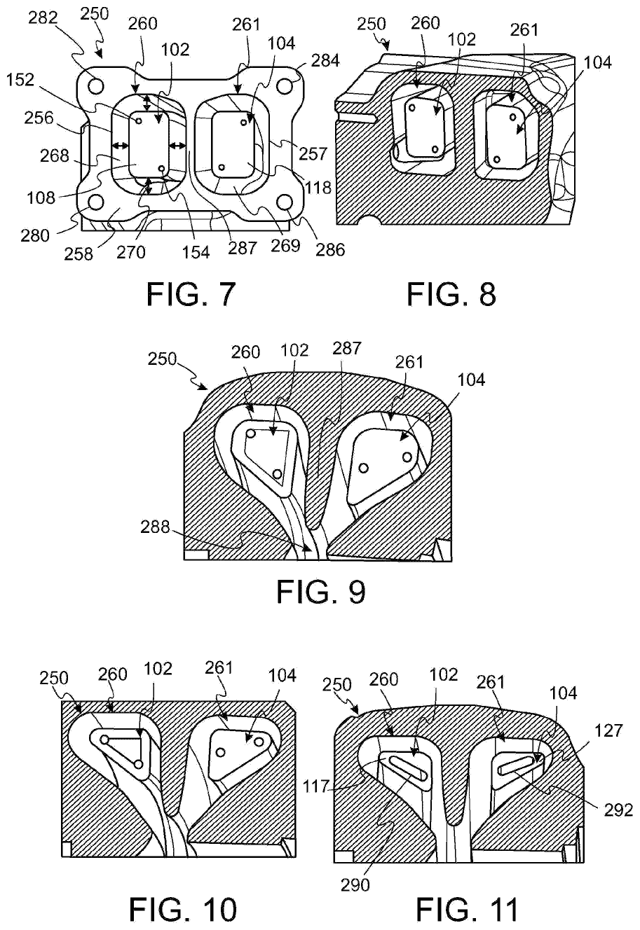

Also defined in the mounting body 106 are four bores 134, 136, 138, 140 (the bore 136 not being visible in FIG. 2a). The bores 134, 136, 138, 140 are used to align the mounting body 106, and so the electrodes 102, 104, with the component. The alignment may be by way of a fastener, such as a bolt extending through the bores, or by a peg or some other variety of projection. The component may have, for example, a four bolt/bore flange (e.g. as shown in FIG. 7). Returning to FIG. 2a, the bores 134, 136, 138, 140 (136 not visible in FIG. 2a, but visible in FIG. 2b) in the mounting body 106 of the electrode assembly 100 may align with bores of the component to be machined to locate, or align, the electrodes 102, 104. Alternatively, or in combination, a toggle clamp may be used to secure the mounting body 106 in engagement with the component.

Where the component to be machined is a compressor housing, for example, the mounting body of the electrode assembly may be aligned with a generally tangential outlet of the compressor housing (as opposed to a generally tangential inlet of a turbine housing). The outlet of the compressor housing may be circular. The mounting body may align with, or engage, an internal surface and/or external surface of the compressor housing outlet. This is particularly advantageous where the compressor housing outlet does not include any mounting bores or flange, and is instead connected (in use) to a proximate conduit using a V-band clamp (for example). The compressor housing outlet may have a plain diameter. The compressor housing outlet may comprise a clip retaining feature, such as a half V-band or half marmon flange. Said feature may mate with a corresponding feature of a conduit, and the two features be secured using a V-band clamp, to connect the compressor to the conduit. Engagement of the electrode assembly with the compressor housing outlet facilitates the insertion of electrodes through the compressor housing outlet, rather than through a (for example) tangential outlet of the compressor housing.

The mounting body of the electrode assembly may be said to be engage an existing feature of the component to be machined so as to align the electrode assembly, and so electrodes, with the component and cavity.

For completeness, an alternative embodiment of mounting body 600 is shown in FIG. 19 and will be described later in this document.

Returning to FIG. 2a, the conductive elements, and electrodes 102, 104 more generally, have two different configurations: a moveable configuration and a conforming configuration.

In FIG. 2a the electrodes 102, 104 are shown in the conforming configuration, whereby each of the constituent conductive elements rigidly engage one or more adjacent conductive elements. When held in the conforming configuration, relative movement between the conductive elements is substantially prevented.

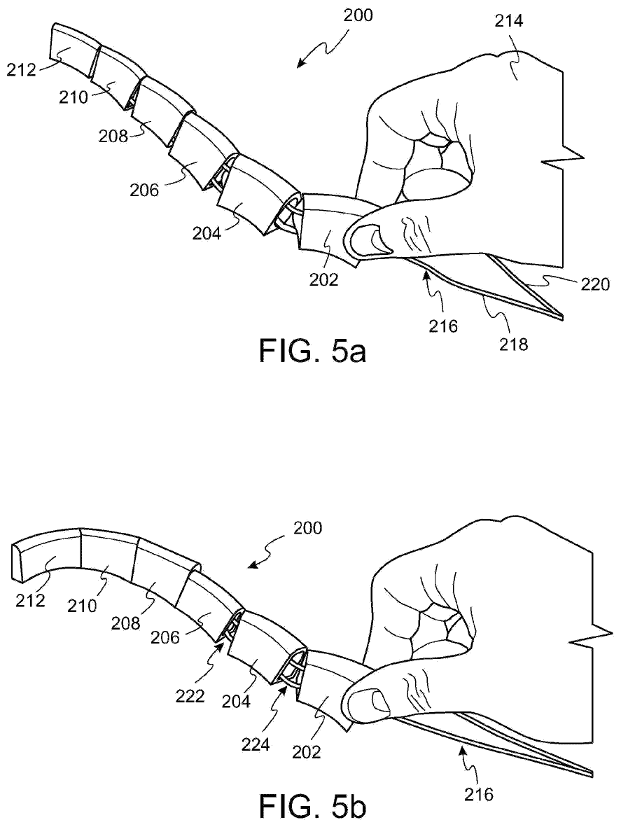

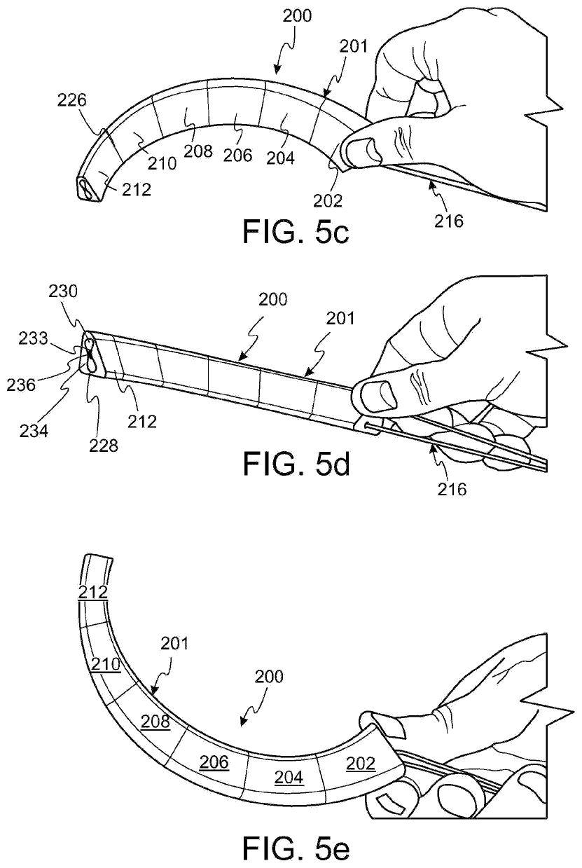

As is illustrated, in terms of the general concept, in FIGS. 5a to 5c, the conductive elements can, in a moveable configuration, move relative to one another. For example, the outermost conductive elements 116, 126 (in FIG. 2a) may be movable relative to the adjacent, fourth conductive element 114, 124.

When the electrodes 102, 104 are in the moveable configuration, whereby the conductive elements are able to move relative to one another, the relative movement facilitates the insertion of the electrodes 102, 104 into cavities, and particularly to more complex cavities. For example, a volute of a turbomachine housing, such as that shown in FIG. 6, presents a comparatively challenging cavity in which to insert an electrode for use in an electrochemical machining process. However, if relative movement between the conductive elements is permitted, such as in the moveable configuration, the electrodes 102, 104 can be gradually fed into the volute whilst the conductive elements move relative to one another. The conductive elements may move relative to one another owing to interaction between an internal wall of the volute and an outer surface of the conductive elements. Once the electrodes 102, 104 are inserted sufficiently deeply into the cavity, the electrodes 102, 104 are transitioned to the conforming configuration (i.e. that shown in FIGS. 2a and 2b) such that the conductive elements of the respective electrodes 102, 104 align with one another to define a substantially continuous outer electrode surface 101, 103. Said outer electrode surface 101, 103 is then provided in facing relations with the internal wall of the cavity (e.g. 268, 269 in FIG. 7), and provided at a substantially constant clearance, gap or offset, from the internal wall (e.g. 270 in FIG. 7). Electrochemical machining of the cavity may then occur, despite the comparatively complex geometry of the cavity.

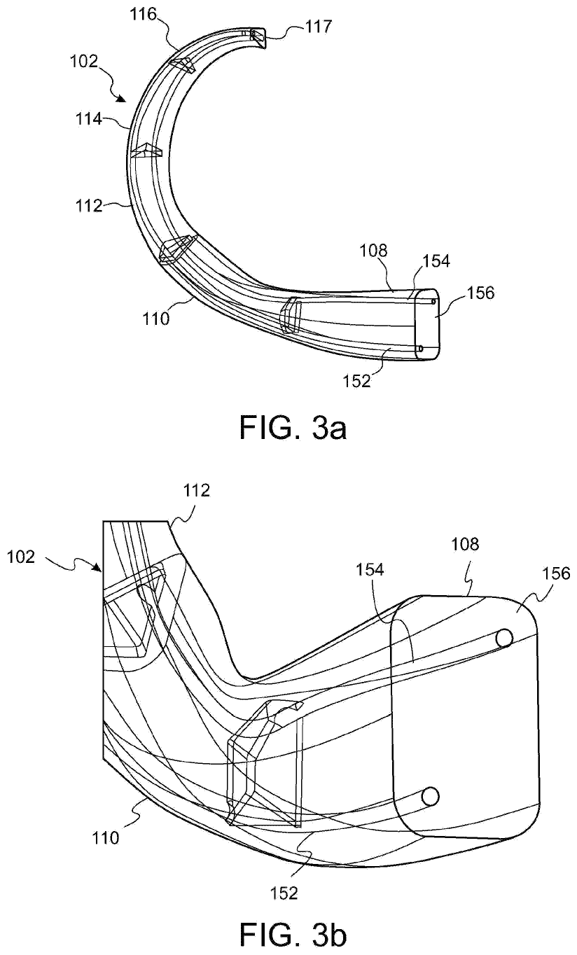

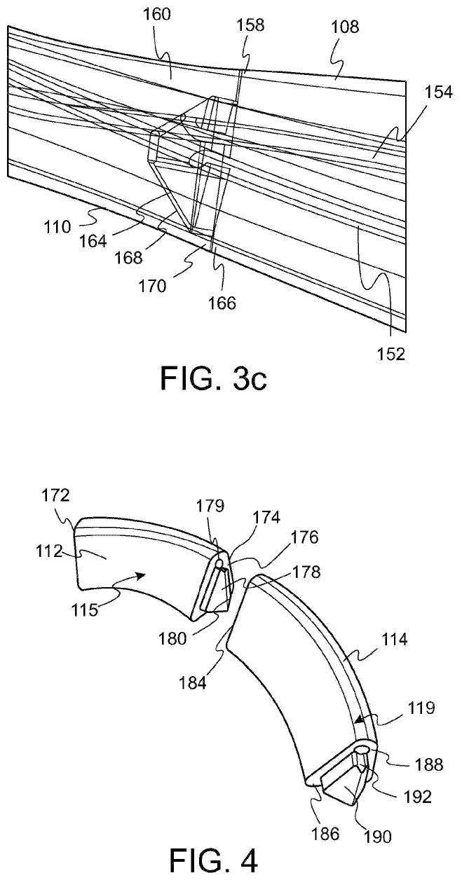

As previously mentioned, in the illustrated embodiments the electrode assembly 100 comprises two cords 105, 107, which may be referred to as first and second cords respectively. The cords 105, 107 are examples of one variety of flexible element suitable for use with the disclosure. Although the following description refers to the cords 105, 107, it will be appreciated that the description applies equally to other varieties of flexible element (e.g. a wire). Each cord comprises two ends as illustrated in FIG. 2a. As will be described in connection with FIG. 3a and FIGS. 5a to 5c, the cords 105, 107 extend through the conductive elements of respective first and second electrodes 102, 104. When it is desired to transition the electrodes 102, 104 to the conforming configuration (i.e. once the electrodes have been inserted into the cavity) the cords 105, 107 are actuated by way of tensioning them, in a direction away from the mounting body 106, so as to draw the conductive elements into engagement with one another. This is shown moving from FIGS. 5a to 5b and then to FIG. 5c. Returning to FIGS. 2a and 2b, the cords 105, 107 may then be secured such that the conductive elements, and the electrodes 102, 104 more generally, are retained in the conforming configuration. As mentioned, in the conforming configuration outer surfaces of the respective conductive elements, for each of the electrodes 102, 104, align with one another to define a substantially continuous outer electrode surface. Only minor discontinuities are provided in the outer electrode surface at joint lines between successive, or adjacent, conductive elements.

When it is desired to release, or withdraw, the electrodes 102, 104, the tension on the cords 105, 107 can be released, and the assembly 100 withdrawn by urging it away from the component. As a separation between the mounting body 106 and the component increases, the electrodes 102, 104 are gradually withdrawn from the cavity. Relative contact between outer surfaces of the electrodes 102, 104, and specifically the conductive elements thereof, may urge the conductive elements to move relative to one another to facilitate withdrawal of the electrodes 102, 104. Put another way, the conductive elements may be urged to move, relative to one another, when an outer surface of the conductive element engages the internal wall of the cavity.

It will be appreciated that, in the illustrated embodiment, the first conductive elements 108, 118 remain coupled to the mounting body 106 in a fixed manner (i.e. permanently coupled and fixed relative to one another). As such, the electrodes 102, 104 may be moveable from the second conductive elements 110, 120 onwards (i.e. third, fourth conductive elements etc.). However, it will be appreciated that this may vary in other embodiments and more, or fewer, conductive elements may otherwise be moveable relative to one another in the moveable configuration.

Although in the illustrated embodiment a cord, or cords, 105, 107, are used as the urging means by which to transition the electrodes 102, 104 from the moveable to the conforming configuration, a number of other possible urging means could otherwise be used. For example, a spring and hinge system may be used to urge the conductive elements into engagement with one another. Alternatively, an electromagnet system could be used in which an electromagnet is activated to attract adjacent conductive elements and draw them towards one another. However, the cords 105, 107 provide a straightforward and convenient means of drawing the conductive elements into engagement with one another in a reliable and repeatable manner. It will also be appreciated that the illustrated plurality of cords 105, 107 may be actuated simultaneously (e.g. in a single action both cords 105, 107 may be tensioned).

Turning to FIG. 2b, an alternative perspective view of the electrode assembly 100 is provided in which the mounting body 106 is more clearly visible. As described in connection with FIG. 2a, the electrode assembly 100 comprises the first and second electrodes 102, 104 (the conductive elements not being labelled in FIG. 2b).

FIG. 2b illustrates the mounting body 106 comprising the bores 134, 136, 138, 140 which are used for aligning and/or securing the mounting body 106 to the component. The mounting body 106 further comprises an electrolyte aperture 142. The electrolyte aperture 142, as suggested by the name, is incorporated to either receive, or discharge, electrolyte therethrough. That is to say, ‘fresh’ electrolyte may be introduced through the electrolyte aperture 142 so as to supply electrolyte for electrochemical machining. The electrolyte aperture 142 would thus constitute an electrolyte inlet. Alternatively, ‘spent’ electrolyte may be received through the electrolyte aperture 142 after having been used in the electrochemical machining process. In such a case, the electrolyte aperture 142 constitutes a discharge outlet.

Advantageously, a single electrolyte aperture 142 is in fluid communication with both cavities to be machined in use. In other words, the single electrolyte aperture may supply, or receive, electrolyte to, or from, multiple cavities in use. This reduces a sealing requirement, and may provide a simpler electrolyte fluid loop. Alternatively, an electrolyte aperture may be provided for each cavity, which may be described as at least one electrolyte aperture per electrode.

FIG. 2b also shows the mounting body 106 comprising two bores 144, 146 through which the cords 105, 107 are received. Although not visible in FIG. 2b, there are a further two bores, one associated with each electrode 102, 104, through which the other end of a respective cord 105, 107 is received. The bores, for a given cord 105, 107, preferably generally oppose one another (e.g. one bore may be located at a near 12 o'clock position, whilst the other is located at a near 6 o'clock position).

Also shown in FIG. 2b are fasteners 148, 150, in the form of bolts, which are used to secure the electrodes 102, 104 to the mounting body 106. It will be appreciated that each of the fasteners 148, 150 are received through a corresponding bore in the mounting body 106.

During electrochemical machining of a component, using the electrode assembly 100, one or more indicators (e.g. machined features) may be applied to the component. This can advantageously provide a visual indicator (e.g. a poka-yoke) that the cavity has been polished, and polished to its full depth. The feature may be applied to an exterior of the component (e.g. an outer face of a flange) or an interior of the component (e.g. to the internal wall). The indicator(s) may be applied by the electrode(s) 102, 104 (e.g. to the internal wall of the cavity) and/or may be applied by the mounting body 106 (e.g. to an exterior of the component).

Turning to FIG. 3a, a perspective view of a wireframe model of the electrodes 102, 104 is provided. As will be appreciated from FIGS. 2a and 2b, the first and second electrodes 102, 104 are substantially identical to one another. As such, the single electrode shown in FIG. 3a may correspond with either electrode but, for the purposes of this description, will be referred to as the electrode 102.

The electrode 102 comprises, as previously described, first to fifth conductive elements 108, 110, 112, 114, 116. The fifth, or outermost, conductive element 116 defines an outermost tip 117 of the electrode 102.

As will be appreciated from FIG. 4 and FIGS. 5a to 5c, the conductive elements engage one another such that they nest within, and align with, one another in the conforming configuration (i.e. as shown in FIG. 3).

FIG. 3a shows a plurality of passages 152, 154 which extend through the electrode 102. The sections of the passages 154, 152 which are labelled are those provided through the first conductive element 108. However, portions, or sections, of the passages 152, 154 are provided through each of the conductive elements. The cords shown in FIGS. 2a and b are receivable through the passages 152, 154. Tensioning of the cords thus draws the conductive elements into engagement with one another in the conforming configuration. When the tension in the cords is released, because the cords are retained within the passages 152, 154 the conductive elements remain tethered to one another even though the conductive elements can move relative to one another. The cords are in clearance with the passages 152, 154 to facilitate replacement of the cords when worn. The tension in the cords may be released, in the movable configuration, by just enough to enable the conductive elements to move relative one another and for the electrode to be retracted.

Also of note, as indicated in FIG. 3a the passages 152, 154 have a nonlinear profile along their length. That is to say, rather than the passages being a straight passage (i.e. that drilled by a single drilling operation) the passages 152, 154 are at least partly arcuate along their length. This has been found to be particularly advantageous in ensuring the correct alignment of the conductive elements in the conforming configuration.

FIG. 3a also indicates that the passages 152, 154 are provided distal one another in each of the conductive elements. Taking first conductive element 108 as an example, the first conductive element 108 has a first end 156. First end 156 defines a face in which the passages 152, 154 are provided. The first face has a generally rectangular geometry and the passages 152, 154 are provided generally diagonally opposite one another (i.e. towards opposing corners of the rectangular cross-section). This has been found to be a particularly effective placement, of the passages, in ensuring that the conductive elements align with one another in the conforming configuration. The passages, or sections thereof, provided through each of the conductive elements are substantially aligned with one another so as to define a substantially continuous pair of passages 152, 154.

In connection with the outermost conductive element 116, the two passages 152, 154 merge into a single opening. That is to say, the two passages 152, 154 open out into a single opening (as generally indicated in FIGS. 5d and 11). Advantageously, this enables the cord to extend in a U-shaped manner, down one passage and then back up the other passage. Again, this has been found to be particularly beneficial in ensuring the conductive elements align with one another in the conforming configuration. Although only partially visible in FIG. 3a, and as will be described in more detail in connection with FIG. 4 onwards, FIG. 3a shows the conductive elements comprising alignment features in the form of a combination of flat faces, projections and recesses.

FIG. 3b is a rotated perspective view of part of the electrode 102 shown in FIG. 3a. FIG. 3b is a magnified view of the first and second conductive elements 108, 110. FIG. 3b indicates the nonlinear profile of the passages 152, 154 along a length of the first conductive element 108 and beyond. FIG. 3b also shows that the passages 152, 156 are generally provided opposing one another, and towards distal corners of the face defined by the first end 156 of the first conductive element 108.

FIG. 3c is a magnified view of an interface between the first and second conductive elements 108, 110. Specifically, FIG. 3c shows the interface between a second end 158 of the first element 108 and a first end 160 of the second element 110.

As previously mentioned, a number of different alignment features are provided at the ends of conductive elements where the conductive element engages another conductive element. In the illustrated embodiment, the first conductive element 108 comprises a plurality of alignment features in the form of a projection 164 and a surrounding flat face 166. Of note, the surrounding flat face is more clearly visible in FIG. 4. Returning to FIG. 3c, the second conductive element 110 also comprises a plurality of alignment features provided at the first end 160 thereof. These alignment features include a recess 168 and a surrounding flat face 170. As will be appreciated from FIG. 3c when considered in combination with FIG. 4, the flat faces 166, 170 abut one another, when the conductive elements are in the conforming configuration, so as to align the elements with one another. Abutment of adjacent flat faces 166, 170 also provides a reliable conductive link between the conductive elements 112, 114. Put another way, the engagement of the flat faces 166, 170 places the conductive elements 112, 114 in electrical communication with one another. This is advantageous in being able to link only one conductive element directly to a power source, whilst the remaining conductive elements are indirectly connected to the power supply via the directly connected conductive elements.

The projection 164, which is received by the recess 168, facilitates the alignment of the conductive elements and ensures that the conductive elements are correctly aligned with one another in the conforming configuration. Respective outer surfaces of the conductive elements thus define a substantially continuous outer electrode surface of the electrode.

FIG. 3c also illustrates the first and second passages 152, 154 which extend through the first and second conductive elements 108, 110 (and other conductive elements). FIG. 3c shows how outer ends of the passages 152, 154 open out into the projection 164. This is also shown in FIG. 4.

Turning to FIG. 4, a perspective view of third and fourth conductive elements 112, 114 is provided. In this perspective view the conductive elements 112, 114 are offset from one another so as to more clearly show an interaction between the conductive elements 112, 114. It will be appreciated that in the conforming configuration the conductive elements 112, 114 would not be offset from one another and, instead, ends of the conductive elements 112, 114 would engage one another such that outer surfaces define the substantially continuous outer electrode surface.

Because both of the third and fourth conductive elements 112, 114 engage with adjacent conductive elements at either end, these elements may be referred to as inboard elements (i.e. conductive elements other than the first conductive element or the outermost conductive element).

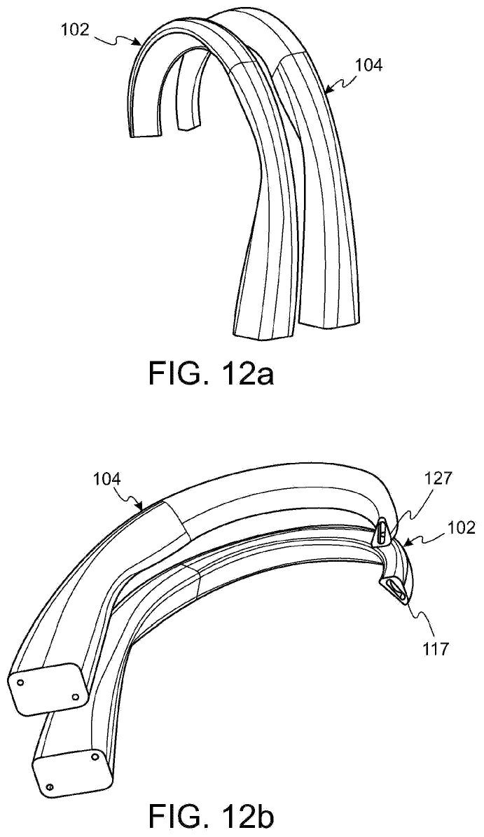

FIG. 4 indicates how the cross-section shape of the third and fourth conductive elements 112, 114 is generally triangular. This is in comparison to the generally rectangular cross-section of the first conductive element 108 as shown at the first end 156 thereof in FIG. 3b. As will be described in connection with later figures, in particular FIG. 12a to 14, the electrode may have a cross-section geometry which varies along its length so as to more closely conform the outer electrode surface to the cavity to be machined.

Returning to FIG. 4, and beginning with the third conductive element 112, the third conductive element 112 comprises a first end 172, which is proximate the mounting body in use, and a second opposing end 174, distal the mounting body in use. The second end 174 comprises alignment features in the form of a flat face 176 and a projection 178. As previously described, the flat face 176 surrounds the projection 178 so as to define an aligning face which can be engaged by a corresponding flat face of the adjacent fourth conductive element 114. The flat face 176 may be described as a border or peripheral face which extends in a loop around the projection 178. The projection 178 has a pointed tip 180. The projection 178 thus tapers to the tip 180. This has been found to be advantageous in aligning the conductive element with respect to the adjacent conductive element when the conductive elements are in the conforming configuration. This has been found to be particularly useful when the conductive elements are transitioned to the conforming configuration by the urging means, in use.

FIG. 4 also illustrates how portion 179 of the first passage 152, which extends through the third conductive element 112, is at least partly recessed into the projection 178. Although not visible in FIG. 4, a corresponding portion of the other passage which extends through the third conductive element 112 is also recessed into the projection 178. Also not visible in FIG. 4, the projection 178 of the third conductive element 112 is received by a corresponding recess in the fourth conductive element 114. Similarly, the flat face 176 of the second end 174 of the third conductive element 112 engages a corresponding flat face of the fourth conductive element 114 in the conforming configuration. The projection 178 may be said to be nested within, or received by, the recess. The projection 178 is received within the corresponding recess to an extent that the projection 178 is not visible when the electrode is in the conforming configuration. That is to say, the engagement between the corresponding flat faces defines a substantially continuous outer electrode surface between the conductive elements 112, 114.

Although not described in detail, the first end 172 of the third conductive element 112 also comprises a flat face which surrounds a recess. The recess is configured to receive a projection of the second conductive element (not shown in FIG. 4).

The features of the fourth conductive element 114 are substantially the same as those described in connection with the third conductive element 112 and will therefore not be described in detail. However, for completeness, the fourth conductive element 114 comprises first and second ends 184, 186. Each of the first and second ends 184, 186 comprise alignment features including a flat face 188 (only visible at second end 186). The recess (not visible in FIG. 4) is also provided at the first end 184. A projection 190 is provided at the second end 186. A portion 192 of one of the passages which runs through the fourth element 114 is at least partly recessed into the projection 190. In connection with the fourth element 114, FIG. 4 shows the tapered, and filleted, nature of the projection 190 which extends from the second end 186 thereof.

Each of the third and fourth conductive elements 112, 114 also define a respective outer surface 115, 119. When in the conforming configuration, e.g. FIGS. 5c to 5e, it will be appreciated that the outer surfaces 115, 119 align with one another such that the conductive elements 112, 114 define (part of) a substantially continuous outer electrode surface (e.g. as shown in FIG. 12a and 12b).

Whilst the above features have only been described in detail with third and fourth conductive elements 112, 114, it will be appreciated that these features may be incorporated on each of the conductive elements forming the electrode. However, and also as mentioned, the above description may only apply to inboard conductive elements (i.e. all conductive elements other than the first conductive element [which is coupled to the mounting body] and the outermost conductive element).

Turning to FIGS. 5a to 5e, the operational principle of the disclosure will now be described with reference to electrode 200. The electrode 200 comprises six conductive elements 202, 204, 206, 208, 210, 212. The conductive elements are arranged in the same way as the conductive elements described in connection with the previous Figures. However, in the illustrated electrode 200, the conductive elements are comparatively shorter. Also shown in FIG. 5a is an operator's hand 214 which is used to replicate the effect of the mounting body in securing, or pinning, the first conductive element 202 in position. A cord 216, having ends 218, 220, is also shown. The cord 216 extends through each of the conductive elements in the same way as that illustrated in FIG. 3a.

FIG. 5a shows the electrode 200, and specifically the conductive elements thereof, in a moveable configuration. In the moveable configuration, the conductive elements are able to move relative to one another. This facilitates the insertion of the electrode 200 into a cavity, and in particular a nonlinear cavity (e.g. a volute of a turbomachine housing). For example, the outermost conductive element 212 can pivot relative to the adjacent, fifth, conductive element 210. Similarly, the fifth conductive element 210 can pivot relative to the adjacent conductive element 208, and so on. The electrode 200 therefore has a number of degrees of freedom, which means the electrode 200 can be inserted into, and extend through, nonlinear cavities. Of note, whilst the term pivot is used above, this is owing to the illustrated electrode 200 being provided on a flat surface (thus limiting some of the degrees of freedom between the conductive elements). When the electrode 200 is effectively suspended within a cavity, by a mounting body, it will be appreciated that the conductive elements have a greater number of degrees of freedom, owing to there being a clearance above, and below, the conductive elements.

In FIG. 5a, the operator's hand 214 is used to grip the first conductive element 202. As mentioned previously, the operator's hand 214 replicates the holding, or pinning, of the first conductive element 202 by the mounting body in use (see 106 in FIGS. 2a and 2b). As such, in use, and at the point where the first conductive element 202 is pinned in position, the mounting body has engaged the component (to be machined) and at least the first conductive element 202 is aligned within the component, specifically the cavity thereof. This alignment preferably takes the form of a clearance, or gap, which exists continuously around an exterior, or outer surface, of the first conductive element 202, between the exterior and the internal wall of the cavity. Put another way, there is a gap which extends around an exterior of the first conductive element 202 between the conductive element and the internal wall.

At the point where the first conductive element 202 is aligned, and it is pinned in position (i.e. by using pegs, fasteners, toggle clamps or similar), the urging means, in this embodiment the cord 216, is then actuated to transition the electrode 200 to the conforming configuration. In the illustrated embodiment the actuation takes the form of the user applying tension to the ends 220, 218 of the cord 216. This may otherwise be described as tensioning the cord 216. With the first conductive element 202 pinned in place, tensioning the cord 216 which, it will be recalled, doubles back on itself within the outermost conductive element 212, draws the conductive elements into engagement with one another. Put another way, the conductive elements become aligned with one another. This is indicated moving from FIG. 5a (showing the electrode in the movable configuration) to FIG. 5b and to FIG. 5c (which shows the electrode 200 in the conforming configuration).

Turning to FIG. 5b, a first stage of the transition of the electrode 200 from the moveable configuration to the conforming configuration is shown. As will be appreciated from FIG. 5b, upon (partly) tensioning the cord 216, and with the first conductive element 202 held in position, the conductive elements begin to move towards one another, towards the conforming configuration. Generally speaking, given that the cord 216 extends through each of the conductive elements and doubles back on itself within the outermost conductive element 212, the outermost conductive element 212 is first drawn into alignment with the successive, and adjacent, fifth conductive element 210. This effect generally continues between successive conductive elements until, as indicated in FIG. 5b, the fourth conductive element 208 is generally aligned with the third conductive element 206.

Due to the cord 216 only being partially tensioned in FIG. 5b, and the electrode 200 only moving towards the conforming configuration, rather than being at it, gaps 222, 224 remain between the second and third conductive elements 204, 206, and the first and second conductive elements 202, 204 respectively. These gaps 222, 224 indicate that the electrode 200 is not in the conforming configuration in that these conductive elements are not yet aligned with one another. When comparing FIG. 5b with FIG. 5a it will be appreciated that, for the conductive elements 206, 208, 210, 212 which are aligned with one another, gaps which were previously present, or could have been present, between the conductive elements have been removed moving from FIG. 5a to FIG. 5b. This may otherwise be described as the conductive elements being drawn into engagement, or alignment, with one another. For these conductive elements, it will be appreciated that respective outer surfaces of these conductive elements define a generally continuous portion of an outer surface of the electrode 200.

Turning to FIG. 5c, with a continued tensioning of the cord 216 (from FIG. 5b), the conforming configuration shown in FIG. 5c is reached. As will be appreciated by comparing FIG. 5b with FIG. 5c, the gaps 222, 224 which were present between the first, second and third conductive elements 202, 204, 206 have been removed in the FIG. 5c conforming configuration such that all of the conductive elements are aligned with one another. Outer surfaces of each of the constituent conductive elements thus defined a substantially continuous outer electrode surface 201 in FIG. 5c. The outer surfaces of each of the conductive elements 202, 204 etc. is not individually labelled in FIG. 5c, but it will be appreciated that outer surface refers to the exterior of each respective conductive element visible in FIGS. 5c to 5e. Join lines between the conductive elements are just visible in FIG. 5c. One join line between the fifth conductive element 210 and the outermost conductive element 212 is labelled 226.

Turning to FIG. 5d, a rotated perspective view of the electrode 200 in the conforming configuration is provided. The view of FIG. 5d again indicates that each of the conductive elements are aligned with one another in the conforming configuration. More detail is shown in connection with the outermost conductive element 212.

Like the outermost conductive element 116 described in connection with FIG. 3a, the outermost conductive element 212 comprises portions of passages 228, 230 which extend through the conductive elements of the electrode 200. It is through these passages 228, 230 that the cord 216 is received. An outermost portion 233 of the cord 216 is also visible in FIG. 5d. As previously described, the cord 216 doubles back on itself (i.e. in a U-shaped manner) through the outermost conductive element 212. This occurs by way of the passages 228, 230 opening out into a single opening (as also shown in FIG. 11) proximate an outermost tip 234 of the outermost conductive element 212. The cord 216 extends through both passages 228, 230 and extends over a portion of material 236 which extends between, and at least partly defines, the passages 228, 230. It will be appreciated that when the cord 216 is tensioned, it is the engagement between the outermost portion 233 of the cord 216 and the portion of material 236 which effectively draws all of the conductive elements into engagement with one another (generally in succession).

Turning to FIG. 5e, a view of an underside of the electrode 200, in the conforming configuration, is provided. Again, the FIG. 5e view illustrates that the conductive elements align with one another to define a substantially continuous outer electrode surface 201. As will be appreciated from the combination of each of FIGS. 5c, 5d, and 5e, when the electrode 200 is provided in the conforming configuration the alignment features between the conductive elements are no longer visible. That is to say, the alignment features are generally obscured by the conductive elements, and specifically the outer surfaces thereof. The conductive elements may be described as being flush with one another in the conforming configuration.

The illustrated electrode 200 is entirely arcuate in the conforming configuration, but it will be appreciated that, for example in FIGS. 2a and 2b, the electrodes may generally be a combination of linear and nonlinear (e.g. arcuate) in the conforming configuration. This is also indicated in FIG. 3a, which shows the electrode 102 in the conforming configuration. By comparing FIG. 5a with FIGS. 5c to 5e, it will be appreciated that the electrode 200 can be inserted into a nonlinear cavity before being transitioned to the conforming configuration such that the outer electrode surface more closely conforms to the internal wall of the cavity. This is particularly useful where the cavity is a nonlinear cavity, for example a volute of a turbomachine housing, in facilitating electrochemical machining of the internal wall.

Turning to FIG. 6, a cross-section view of a turbine housing 250 with the electrode 102 inserted therein is provided.

For illustrative reasons, and ease of reference, only the (one) electrode 102 of the overall electrode assembly 100 (of FIGS. 2a and 2b) is shown. The mounting body, and cords, are omitted. It will also be appreciated that the electrode 102 is shown in the conforming configuration. The conductive elements 108, 110, 112, 114, 116 thus align with one another, specifically outer surfaces thereof, to define the substantially continuous outer electrode surface 101. This will be described in more detail below.

Initially beginning with the turbine housing 250, as is known in the art the turbine housing 250 comprises an inlet 252 and an outlet 254. The inlet 252 is of the form of a generally tangential opening 256. Inlet 252, and opening 256, are defined in a flange 258 of the turbine housing 250. The inlet 252 is in fluid communication with the outlet 254.

The outlet 252 is a generally axial outlet. In use, after exhaust gas flow, received through the inlet 252, has been expanded across a turbine wheel it is exhausted through the outlet 254. The outlet 254 may be defined in a generally tubular outlet portion of the turbine housing 250. The turbine wheel (not shown) rotates about an axis 225. The turbine wheel is provided in the fluid path between the inlet 252 and the outlet 254.

Extending at least part way between the inlet 252 and the outlet 254 is a cavity in the form of a volute 260. The volute 260 has a generally spiralling geometry. That is to say, a radial position of a cross-section profile of the volute 260 changes, with respect to the axis of rotation 225. The volute 260 may be described as having a generally linear portion, or extent 264, and having a generally nonlinear portion beyond the linear portion 264. As will be appreciated from FIG. 6, a cross-section profile of the volute 260 varies along an extent of the volute. The cross-section profile of the volute also generally reduces in area, and changes in shape, moving from the inlet 252 to the outlet 254. This will also be appreciated from FIGS. 7 to 11. The volute 260 may be described as being defined by an internal wall 268.

Returning to FIG. 6, the volute 260 comprises an outer end, or tip, 266. Although not visible from the view of FIG. 6, the outer end 266 of the volute 260 is in fluid communication with the outlet 254 via a nozzle, or throat, of the turbine housing 250 (see 288 in FIG. 9). Put another way, the volute 260 opens out into the outlet 254.

As will be appreciated from FIG. 6, the volute 260 is a challenging geometry to access. Typically, turbine housings are cast using a mould, using processes such as sand casting and investment casting, to define the volute 260 cavity therein. However, such processes may not provide a desirable surface finish, particularly in applications where the surface finish may have a significant effect upon efficiency of fluid flow therethrough. Advantageously, by utilising the electrode assembly 100 described in this document, an electrochemical machining process can be used to machine, or polish, the internal wall 268 which defines the volute 260. Furthermore, this can occur along a majority, or entire, extent, or length, of the volute 260 (i.e. between the opening 256 and the outer end 266).

A method of using the electrode assembly 100 will now be described in connection with FIG. 6. It is recalled that some features of the electrode assembly 100 are not shown in FIG. 6.

Firstly, the outermost conductive element 116 of the electrode 102 is inserted through the opening 256 of the inlet 252. The electrode 102 is inserted in a moveable configuration whereby the conductive elements 108, 110, 112, 114, 116 are moveable relative to one another. The electrode 102 continues to be inserted along an extent of the volute 260 until a part of the electrode 102 contacts the internal wall 268 of volute 260. For completeness, it is appreciated that the internal wall 268 runs along an entire extent of the volute 260. That is to say, there will be a part of the internal wall 268 which defines, for example, the outer end 266 of the volute 260. Because the electrode 102 is inserted in the moveable configuration, contact between the conductive elements, such as the outermost tip 117 of the outermost conductive element 116, and the internal wall 268 leads to some movement of that conductive element to better conform to the volute 260. The electrode 102 may be said to be deflected by the internal wall 268. This effectively allows the electrode 102 to follow a nonlinear path of the volute 260 (e.g. downstream of the linear portion 264 thereof). The insertion (of the electrode 102) continues until a mounting body of the electrode assembly engages the flange 258 of the turbine housing 250. At this point, the mounting body is coupled to the flange 258 to align the electrode 102 within the volute 260. This alignment is with reference to the electrode 102 being aligned relative to a cross-section profile of the volute 260, such that a clearance exists around the outer surface of at least the first conductive element 108 and the facing portion of the internal wall 268 of the volute 260. An example of this is shown in FIGS. 6 and 7, where a gap 270 is provided around the outer surface of the electrode 102.

The urging means, such as the cord, is then actuated to transition the electrode 102 from the moveable configuration to the conforming configuration. Actuation of the urging means, e.g. tensioning of the cord, draws the conductive elements into engagement with one another such that the respective outer surfaces of the conductive elements define a substantially continuous outer electrode surface. Put another way, any gaps previously present between the conductive elements are substantially removed by drawing the conductive elements into engagement with one another. This urging effectively means that the second conductive element 110 onwards (e.g. third, fourth conductive elements 110, 112) is aligned within the volute 260 by virtue of the alignment between the mounting body and the flange 258. This provides a continuous clearance around the electrode 102 along an extent of the volute 260 that the electrode 102 reaches, or occupies (i.e. up until a position proximate the outer tip 117 of the electrode 102 in FIG. 6).

A negative charge is then applied to the electrode 102, and a flow of electrolyte is pumped through the volute 260, to commence the electrochemical machining process. The power supply which the electrode 102 is connected to may provide around 1.5 kA at around 40V (i.e. a 60 kW power supply). The power supply may provide around 2.5 kA at around 40V (i.e. a 100 KW power supply). The machining process removes material from the internal wall 268 of the volute 260. This process can effectively be used to improve a surface finish (e.g. reduce a surface roughness) and/or improve the tolerance of manufacture of the volute of 260 (e.g. the dimensions of the volute 260). The turbine housing 250 is also grounded to earth such that a positive charge is then effectively applied to it relative to the negatively charged electrode 102. However, in other embodiments the turbine housing 250 may otherwise be electrically coupled to a positive terminal of the power supply. The process described in connection with FIG. 1 then occurs.

Specifically, the electrode 102 (specifically conductive elements 108 onwards) forms a cathode, and the internal wall 268 of the volute 260 forms the anode. The clearance between the outer surface of the electrode 102 and the internal wall 268 reduce the risk of arcing, or short circuiting, occurring between the electrode 102 and the internal wall 136 (which could otherwise lead to a poor surface finish and other issues with the machining process). The flow of electrolyte effectively completes the circuit and, as electrons pass across the electrolyte and are absorbed by the internal wall 136, material is removed from, or vaporised from, the internal wall 268. The electrolyte flow further transports any material which is removed and discharges the waste material through a corresponding outlet. It will be appreciated that the electrolyte flow may be pumped through either the inlet 252 in a direction towards the outlet 254, or may be pumped into the outlet 254 and discharged through the inlet 252. Either way, electrolyte may pass through the electrolyte aperture 142 shown in FIG. 2b.

Once the electrochemical machining has occurred, the urging means may then be released such that the electrode 102 can transition to the moveable configuration. The mounting body may then be decoupled from the flange 258 and the assembly withdrawn from the volute 260. In a similar fashion to the way that the conductive elements conformed to the volute 260 upon insertion, upon contact between a conductive element and the internal wall 268 during removal, or withdrawal, of the electrode 102, the electrode 102 is effectively able to move, to better conform to the volute 260 geometry to facilitate removal thereof. Put another way, the electrode 102 is deflected by contact with the internal wall 268 to aid in the removal of the electrode 102, and prevent the electrode 102 being stuck in the volute 260.

The electrolyte may be saltwater or any other fluid which provides a flow of ions. A mild acid solution is another example of a suitable electrolyte. The electrolyte may include Sodium Nitrate and/or Sodium Chloride.

In an embodiment, a cap is provided over at least the tip 117 of the outermost conductive element 116. The cap may be a sacrificial cap. The cap may be manufactured from a polymer, such as nylon or another non-conductive material. Advantageously, the cap protects the internal wall 268 from any inadvertent damage, such as scratching, when the electrode 102 is inserted into the volute 260 (i.e. owing to contact between the electrode 102 and the internal wall 268). However, given that the electrochemical machining process improves the surface finish of the internal wall 268, in other embodiments the cap may not be used.

For completeness, although only a single volute 260 is shown in the turbine housing 250 of FIG. 6, the turbine housing 250 is a twin entry turbine housing (see FIGS. 7 to 11). That is to say, the turbine housing 250 comprises a pair of volutes. The volutes generally follow the same profile. The electrode assembly illustrated in connection with the earlier Figures is particularly advantageous for such twin volute arrangements, whereby one electrode is received in each of the two volutes. The volutes may thus be machined simultaneously, and using a single electrolyte supply. However, it will also be appreciated that turbine housings comprising only a single volute may equally be machined using electrochemical machining. In such embodiments, the electrode assembly may also comprise only one electrode.

Although the above has been described with reference to a turbine housing volute, it will be appreciated that there are a range of other components, and cavities therein, which could be advantageously machined using the electrochemical machine process and the electrode assembly described herein. Once such alternative is a volute of a compressor housing, which has a generally similar geometry to the turbine housing volute shown in FIG. 6, although there are some geometric differences (e.g. the cross-section of the volute is generally circular, and preferably varies in area in a linear manner). Other components include valves, manifolds (e.g. exhaust manifolds) and any other component which has a comparatively complex cavity. Examples of comparatively complex cavities include cavities which follow an at least partly nonlinear path, such as an at least partly arcuate cavity. Further examples of comparatively complex cavities include cavities comprising a stagger or dog-leg-type arrangement. The cavity may have a generally tubular structure.

For completeness, FIG. 6 also shows part of a passage 152, for receiving a cord therein, of the first conductive element 108. The part of the passage 152 is visible, and the other passage is not visible, because of the nonlinear fashion in which the passages extend through the first conductive element 108 (see FIGS. 3a and 3b).

Turning now to FIGS. 7 to 11, these Figures illustrate the relationship between the cross-section shapes of the electrode 102 with respect to the cross-section shape of the volute 260.

Beginning with FIG. 7, a view of part of the turbine housing 250 is provided with first conductive elements 108, 118 of first and second electrodes 102, 104 respectively inserted therein. The view is provided normal to the flange 258 of the turbine housing 250.

The turbine housing 250 comprises a pair of volutes 260, 261, each of which defines a respective opening 256, 257 in the flange 258. Although the mounting body associated with the electrode assembly, which is coupled to the electrodes 102, 104, is not shown in FIG. 7, the position of the electrodes 102, 104 within the volute 260, 261 is indicative of the alignment which is provided by the interaction between the mounting body and flange 258. A clearance 270 extends around an entire exterior, or outer surface, of the electrode 102 and the corresponding internal wall 268 which defines the volute 260. The same applies for the second electrode 104 and second volute 261.

The first and second volutes 260, 261 are separated from one another by divider 287. As will be appreciated by considering FIG. 7 in combination with FIGS. 8 and 9, the divider 287 may only completely separate the volutes 260, 261 for part of an extent of the volutes 260, 261. That is to say, the two volutes 260, 261 effectively merge into a single nozzle 288 (see FIG. 9) at a given angular position about the axis of rotation.

From FIG. 7 it will be appreciated that the cross-section shapes of the first and second volutes 260, 261 and electrodes 102, 104 at this position are generally rectangular. That is to say, each of the conductive elements of the electrodes 102, 104 is generally defined by two pairs of generally parallel sides. It will also be appreciated from FIG. 7 that the passages 152, 154 which extend through the conductive element 108 are provided generally diagonally opposite one another (only labelled in connection with the first electrode 102).

Mounting bores 280, 282, 284, 286 are also defined in the flange 258. Advantageously, the mounting body, and specifically bores provided therein, interact with the bores 280, 282, 284, 286 to align the mounting body, and so electrode assembly more generally, with respect to the turbine housing 250 and constituent volutes 260, 261.

FIG. 8 is a cross-section view taken partway along an extent of the volutes 260, 261, and so electrodes 102, 104, relative to FIG. 7. As such, the flange 258 visible in FIG. 7 is not visible in FIG. 8. From the FIG. 8 view it will be appreciated that the cross-section shapes of the electrodes 102, 104, and volute 260, 261 generally correspond with those shown in FIG. 7 (i.e. are generally rectangular).

Turning now to FIG. 9, a further cross-section view through the turbine housing 250 is provided at a point further beyond the cross-section shown in FIG. 8 (e.g. at an angle further round the axis of rotation). In the FIG. 9 view it will be appreciated that the divider 287 no longer extends so as to completely separate the volutes 260, 261 from one another. Instead, the volutes 260, 261 open out into a single nozzle, or throat, 288. By comparing the cross-section shapes of the volutes 260, 261 and the electrodes 102, 104 between FIGS. 9 and 8, it will be appreciated that at the position the cross-section of FIG. 9 is taken the cross-section shapes are more akin to a trapezium. That is to say, the cross-sections are generally defined by one pair of parallel sides and one pair of non-parallel sides. Put another way, the geometry generally tapers moving towards the nozzle 288. Again, the cross-section shape of the electrodes 102, 104 at this position is matched to, or corresponds with, the cross-section shape of the volutes 260, 261 in the same region.

Turning to FIG. 10, a yet further cross-section view is provided at a further downstream position of the view shown in FIG. 9. In FIG. 10 the cross-section shapes of both the volutes 260, 261 and the corresponding electrodes 102, 104 are generally triangular. That is to say they are generally divided by three straight sides.

Finally, turning to FIG. 11 a cross-section view is taken which corresponds with an outer tip 117, 127 of each of the electrodes. As will be appreciated from FIG. 11, and similar to FIG. 10, the cross-section shape of the volutes 260, 261 and the electrodes 102, 104 is generally triangular. It will be appreciated that the specific triangular shape is different between FIGS. 10 and 11 owing to the fact that the volutes 260, 261 are reduced in cross-section at the point where the FIG. 11 cross-section is taken (in relation to the point at which the cross-section at FIG. 10 is taken).

FIG. 11 also indicates how the otherwise separate passages (i.e. 152, 154 in FIG. 7) open out into a single opening proximate the outermost tips 117, 127 of the electrodes 102, 104. The openings are labelled 290, 292 in FIG. 11. The single opening 290, between the passages 152, 154, advantageously defines part of a protective recess at the end of the electrode 102 (also indicated in FIG. 3a). The cord is fully received within the protective recess (i.e. the cord does not project beyond an outer end of the outermost conductive element). The cord is thus advantageously protected by the single opening 290, reducing the risk of damage to the cord in use. This also applies to the opening 292 associated with the second electrode 104.

When FIGS. 7 to 11 are compared, it will be appreciated that the cross-section of the volutes 260, 261 varies along their lengths, or along an extent of the volutes 260, 261. As well as a general size (e.g. area) of the cross-section, the specific geometry also changes. By adjusting the cross-sections of the electrodes 102, 104, and specifically the conductive elements thereof, which are situated in a corresponding portion of the volute 260, 261, when the mounting body is coupled to the flange 258 a generally uniform clearance, or gap, is provided around an outer surface of the electrodes despite this variation in geometric shape and size. This provides a uniform electrochemical machining effect along an extent of the volutes 260, 261 in which the electrodes 102, 104 are received. This is particularly beneficial given that one of the variables which can be used to control the electrochemical machining process is the clearance between the anode and the cathode (e.g. between the internal wall of the volute and the electrode). For example, reducing the gap between the outer surface of the electrode and the internal wall may mean that a less powerful power supply can be used to achieve the same overall electrochemical machining effect.

FIG. 12a and 12b indicate the geometry of the electrodes 102, 104 along their lengths. Of note, the illustrated electrodes 102, 104 are not shown as being split into as many conductive elements as previously illustrated. Instead, FIG. 12a and 12b are merely intended to provide a schematic indication of how the cross-sectional shape varies along the extent of the electrodes 102, 104. Briefly, and as described in connection with FIGS. 7 to 11, the cross-section shape of the electrodes 102, 104 transitions from generally rectangular to generally trapezoidal to generally triangular at outermost tips 117, 127 of the electrodes 102, 104. It will also be appreciated that this is a geometry which generally corresponds to the cross-section of the volutes along an extent of the volutes.

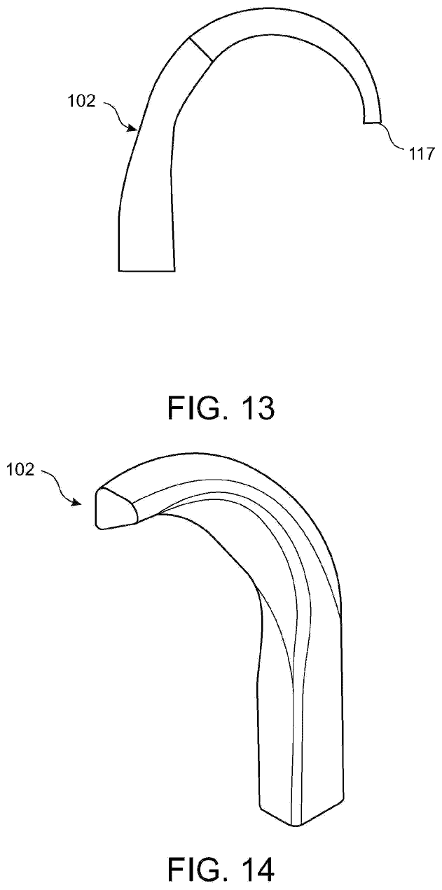

FIG. 13 is an external view of one of the electrodes 102. FIG. 13 shows, more clearly, the profile of the electrode 102 and how it is extends a U-shaped manner. This further illustrates the difficulty of inserting such a geometry of electrode, into a corresponding cavity, if it was not for the advantageous functionality that the conductive elements could be moved relative to one another in accordance with the present disclosure.

FIG. 14 is a perspective view of part of the electrode 102. FIG. 14 is a solid body view showing, again, how the cross-sectional geometry varies along an extent of the electrode 102.

All of the above description, in connection with FIGS. 13 and 14, applies equally to either of electrodes 102, 104.

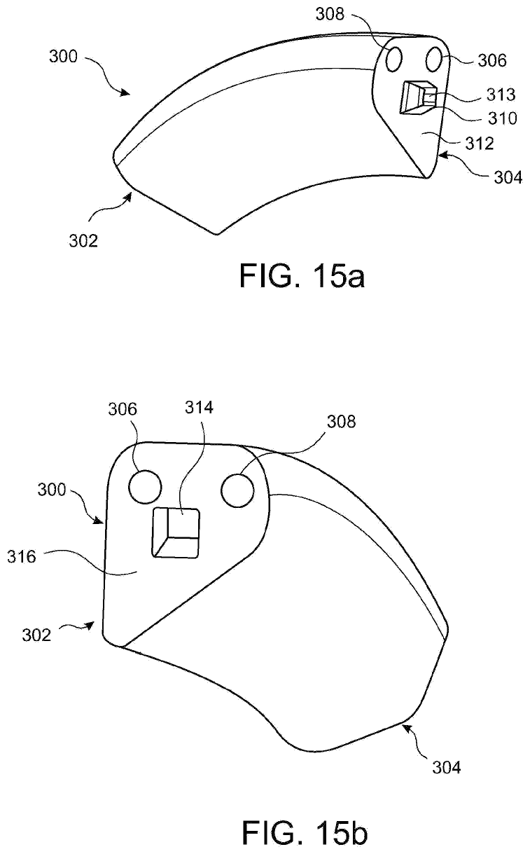

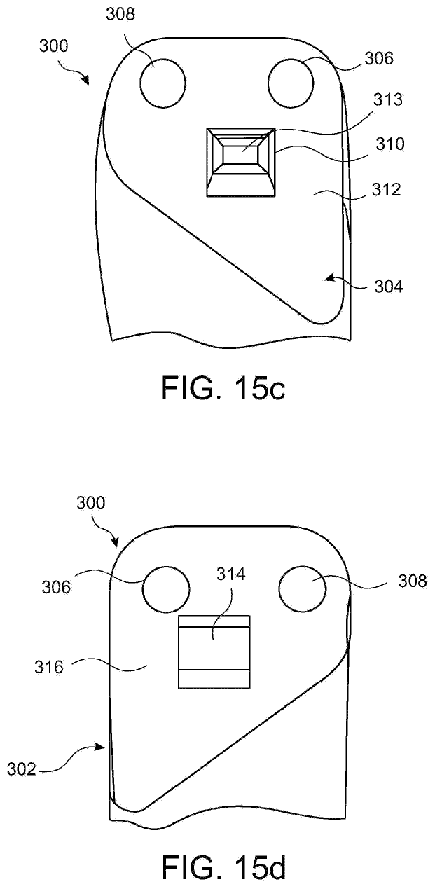

FIG. 15a to 15d are various views of a conductive element 300 according to another embodiment. The conductive element 300 shares many features in common with the conductive elements previously described, and only the distinctions will be therefore be described in detail here. Similarly, the uses, and functionality, of the conductive element 300 is the same as those previously described earlier in this application.

The conductive element 300 defines first and second ends 302, 304. The first end 302 is preferably proximate a mounting body of an electrode assembly in which the conductive element 300 is incorporated. The second end 304 is preferably distal the mounting body, or proximate and outermost tip of the electrode. The conductive element 300 comprises of a plurality of passages 306, 308 which extend through the conductive element 300. These passages 306, 308 are configured to receive a cord therethrough. However, in other embodiments the passages may be omitted and an alternative urging means may instead be employed.

Provided at the second end 304 are a number of alignment features which are configured to align the conductive element 300 with an adjacent conductive element. The alignment features comprise a projection 310 and flat face 312. The projection 310 projects from the flat face 312 and tapers towards an outer tip 313 thereof. The flat face 312 extends around the projection 310. The flat face 312 may be said to extend around the periphery of the second end 308.

Turning to FIG. 15b, a perspective view of the first end 302 of the conductive element 300 is provided. Again, the passages 306, 308 are visible. Provided at the second end 302 of the conductive element 300 is a recess 314. The recess 314 is provided in a flat face 316 at the second end 302 of the conductive element 300. The recess 314 is configured to receive a projection from an adjacent conductive element. It will be appreciated that, in use, the combination of the interactions between the projection and the recess, and the flat faces, will effectively align the conductive elements with one another. The alignment features therefore facilitate the correct alignment of the conductive elements when the electrode is transitioned from the moveable configuration to the conforming configuration in use. Again, the flat face 316 extends around the recess 314 and maybe described as extending around a periphery of the second end 302.

FIG. 15c shows the conductive element 300 when taken normal to the first end 302. FIG. 15d shows the passages 306, 308 provided in the first end 302, and the flat face 316 extending around the recess 314.

When comparing the conductive element 300 with the conductive elements 112, 114 shown in FIG. 4, it will be appreciated that the projection 310 of the conductive element 300 is comparatively smaller than the projections 178, 190 of the conductive elements 112, 114 respectively. It may be desirable to provide a comparatively larger projection, and a smaller surrounding flat face, to improve the repeatability of the alignment of the conductive elements relative to one another in use.

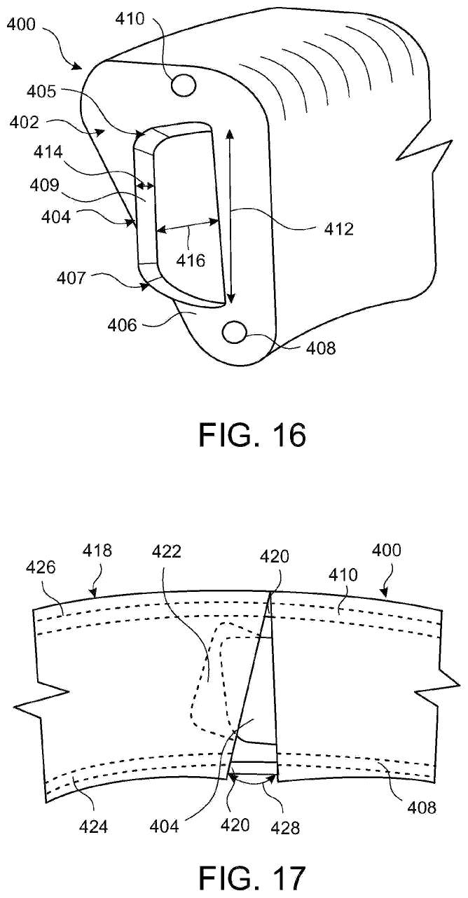

FIG. 16 is a perspective view of part of a conductive element 400 according to another embodiment. Many features of the conductive element 400 are the same as those already described in connection with earlier figures, and so only the differences will be described in detail.

The conductive element 400 comprises a first end (not visible) and a second end 402. A plurality of alignment features are provided at the second end 402 including a projection 404 and a surrounding flat face 406. The conductive element 400 also comprises first and second passages 408, 410 which extend therethrough. The first and second passages 408, 410 are configured to receive a cord therethrough.

The projection 404 differs from previous embodiments in that the projection 404 is an elongate, and comparatively narrow, projection. The projection 404 may therefore be described as a tab, key, or tongue. The projection 404 is received by a corresponding recess, as will be described in connection with FIG. 17. Returning to FIG. 16, a height of the projection 404 is labelled 412, and a width of the projection 404 is labelled 414. In the illustrated embodiment the height 412 of the projection 404 is between around 15 mm and around 25 mm. In the illustrated embodiment, the width 414 of the projection 404 is between around 3 mm and around 5 mm. It will be appreciated that a range of other dimensions may otherwise be used. The projection 404 thus has an aspect ratio (i.e. a ratio of height:width) of between around 3 and around 8. The projection 404 extends by a depth 416 (i.e. from the flat face 406) of between around 15 mm and around 30 mm. The projection 404 having a depth in this range has been advantageously found to result in the projection 404 remaining engaged in the corresponding recess even when the electrode is in the movable configuration (e.g. when the urging means is not actuated, such as the cords being relaxed).

The projection 404 also comprises filleted surfaces 405, 407. These filleted surfaces 405, 407 may otherwise be described as rounded corners. The projection 404 preferably comprises no corners, particularly proximate an end 409 distal the flat face 406.

Turning to FIG. 17, a part-cutaway side view of the conductive element 400 (referred to as a first conductive element), and an adjacent (second) conductive element 418, is provided. Dashed lines indicate the features are obscured from view in the FIG. 17 arrangement. The conductive elements 400, 418 form part of an electrode, and are shown in a movable configuration in FIG. 17. Also shown is a cord 420 extending through the conductive elements 400, 418.

The projection 404 of the first conductive element 400 is shown being partly received by recess 422 of the second conductive element 418. It will be appreciated that the recess 422 is similarly elongate, and narrow, generally matching the external profile of the projection 404. The recess 422 may therefore be described as a slot, groove or keyway.

Advantageously, the projection 404 remains at least partly received by the recess 422 even when the electrode is in the movable configuration. Put another way, even when the conductive elements 400, 418 can move relative to one another, there remains a partial engagement between the projection 404 and the recess 422. This has been found to improve the repeatability and reliability of the conductive elements 400, 418 aligning with one another following actuation of the urging means (e.g. tensioning the cord 420 in the illustrated embodiment). The projection 404 and recess 422 therefore form a tongue and groove, or key and keyway, or tab and slot arrangement, irrespective of the configuration of the conductive elements 400, 418. Described another way, the conductive elements 400, 418 remain partially engaged, or interconnected, in all configurations. The interaction between the projection 404 and recess 422 may limit the motion of the conductive elements 400, 418, relative to one another, to one or two degrees of freedom.

For completeness, FIG. 17 shows the first and second passages 408, 410 extending through the first conductive element 400. Corresponding first and second passages 424, 426 of the second conductive element 418 are also illustrated. The cord 420 extends through the first and second passages 408, 410, 424, 426 of the first and second conductive elements 400, 418 respectively. The visibility of the cord 420, between the second passages 408, 424, is indicative of the conductive elements 400, 418 being in a movable configuration in FIG. 17. In a conforming configuration the gap 428 is substantially eliminated from between the conductive elements 400, 418, such that the conductive elements 400, 418 are aligned with one another. It will be recalled that in the conforming configuration the outer surfaces of the conductive elements align so as to define a substantially continuous outer electrode surface.

Whilst only two conductive elements 400, 418 have been shown and described in connection with FIGS. 16 and 17, it will be appreciated that the features described therein may be applied to any number of conductive elements so as to define one or more electrodes forming part of an electrode assembly.

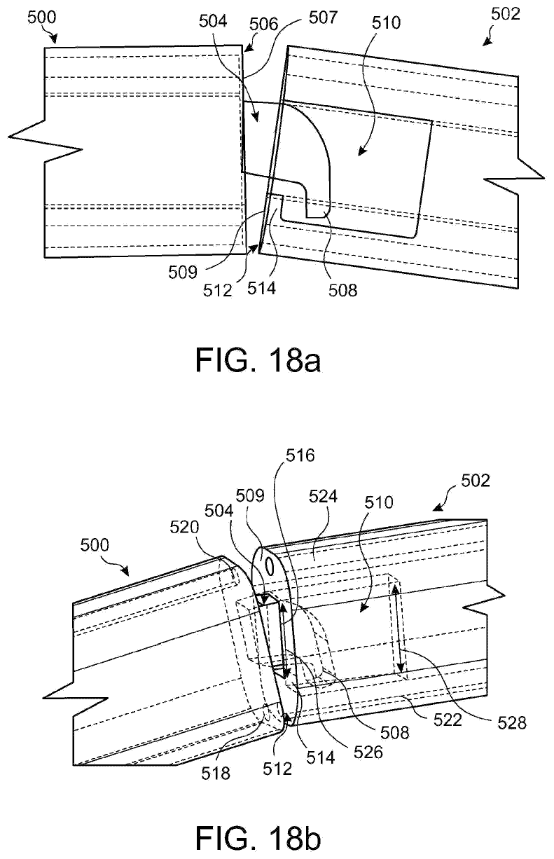

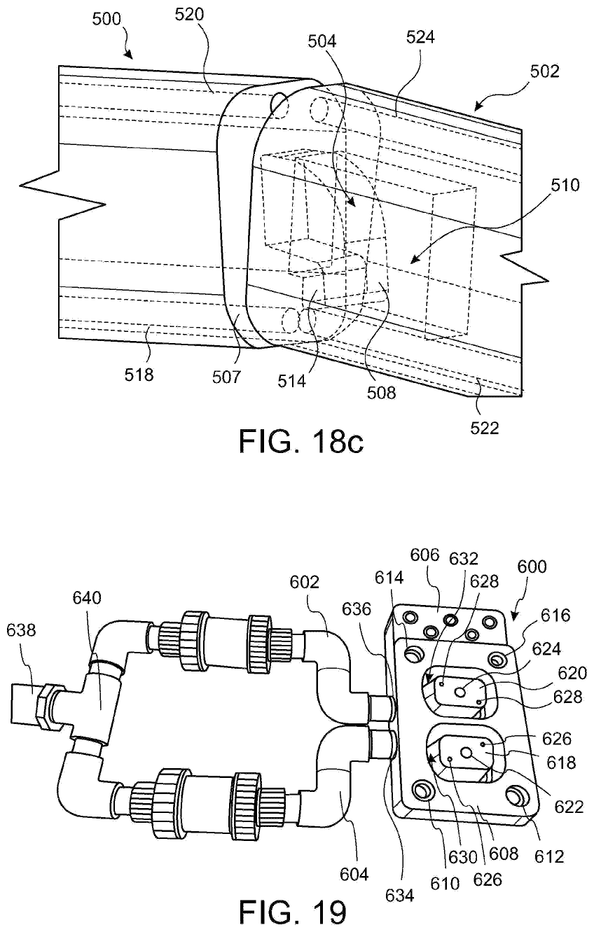

FIG. 18a is a partially cutaway side view of two conductive elements 500, 502 according to another embodiment. The conductive elements 500, 502 are shown in a movable configuration. Many features of the conductive elements 500, 502 are shared in common with the previous embodiments, and so only the distinctions will be described in detail.

The first conductive element 500 comprises a projection 504 provided at an end 506 thereof (e.g. a second end). Like the embodiment shown in FIGS. 16 and 17, the projection 504 is generally narrow and elongate. Unlike the embodiment of FIGS. 16 and 17, the projection 504 comprises a hooked portion 508. The projection 504 is received by a recess 510 provided at an end 512 of the second (and adjacent) conductive element 502.

From FIG. 18a it will be appreciated that the projection 504 and recess 510 form a latching, or locking, arrangement which substantially prevents axial separation of the conductive elements 500, 504. Axial separation of the conductive elements 500, 504 is substantially prevented by the hooked portion 508 fouling on an abutment portion 514 (which forms part of the recess 510) unless the projection 504, specifically the hooked portion 508, is manoeuvred (e.g. partly rotated) out of the recess 510. Inadvertent disconnection of the conductive elements 500, 502 is thus avoided.

Advantageously, the latching arrangement improves the reliability and repeatability with which the conductive elements 500, 502 align with one another in the conforming configuration. This is achieved by reducing the number of degrees of freedom with which adjacent conductive elements can move relative to one another.

The projection 504 and recess 510 may be said to define a guiding arrangement, or guide. The guiding arrangement, or guide, may be said to at least partially limit the movement between adjacent conductive elements irrespective of the configuration (i.e. movable or conforming) which the conductive elements are in. In the conforming configuration, flat faces 507, 509 of each of the conductive elements 500, 502 respectively engage one another. The flat faces 507, 509 surround each of the projection 504 and the recess 510 (specifically the opening 516 thereof) respectively.

The projection 504 may share the same major dimensions, and aspect ratio, as those described in connection with FIG. 16.

FIG. 18b is a perspective view of the conductive elements 500, 502 of FIG. 18a, with dashed lines indicating features obscured from view.

FIG. 18b shows the projection 504 extending through an opening 516 defined in the face 512 of the second conductive element 502. The opening 516 defines a neck, or narrowest point, of the recess 510. A height of the neck is indicated 526 in FIG. 18b. It will be appreciated that the height, or extent, 526 of the neck 516 is comparatively less than a height, or extent, 528 of the recess 510 distal the second end 512. The recess 510 may therefore be described as generally narrowing, or reducing in extent. This is at least in part due to the presence of abutment portion 514.

FIG. 18b also indicates how the projection 504 only extends partway through the recess 510 (although in other embodiments the projection 504 may extend further into the recess 510). Passages 518, 520, 522, 524, through which cords (not illustrated) extend in use, are also visible in FIG. 18b.

The hooked portion 508 of the projection 504 is also shown, adjacent abutment portion 514 of the recess 510. The hooked portion 508 may be described as finger-like.

FIG. 18c is a further perspective view of the conductive elements 500, 502 of FIG. 18a and 18b. FIG. 18c shows the projection 504 received by the recess 510 so as to define the latching, or locking, arrangement. Hooked portion 508 is also seen adjacent, but separated from, the abutment portion 514 of the recess 510. Passages 518, 520, 522, 524, extending through the first and second conductive elements 500, 502 respectively, for receipt of cords therethrough are also visible.

Whilst only two conductive elements 500, 502 have been shown and described in connection with FIG. 18a to 18c, it will be appreciated that the features described therein may be applied to any number of conductive elements so as to define one or more electrodes forming part of an electrode assembly. Equally, the projection and recess designs shown in FIGS. 16 to 18c may be combined with projection and recess designs of earlier embodiments in a single electrode. Alternatively, each conductive element, or at least the inboard elements, may share the same design of projection and recess (or alignment feature(s) more generally).

The projections 404, 504 shown in FIGS. 16 to 18c may be provided at second ends of conductive elements other than for an outermost conductive element (e.g. similar to that shown in FIG. 3a). The recesses 422, 520 shown in FIGS. 16 to 18c may be provided at first ends of conductive elements other than for a first conductive element (proximate a mounting body). Each inboard element (i.e. conductive elements which are not at either end of the electrode) may comprise a projection at one end and a recess at the other.

In the conforming configuration it will be appreciated that the conductive elements 400, 418, 500, 502 shown in FIGS. 16 to 18c would define a substantially continuous outer electrode surface like that shown in FIGS. 5c to 5e.

FIG. 19 is a perspective view of a mounting body 600 connected to electrolyte conduits 602, 604. The mounting body 600 shares some features in common with the mounting body 106 shown in FIGS. 2a and 2b. The mounting body 600 is, in use, coupled to an electrode (e.g. 102, 104 of FIGS. 2a and 2b) and is engageable with a component (to be machined) to align the electrode within the cavity.

The mounting body 600 comprises a manifold 606 and a gasket 608. The gasket 608 is non-conductive in the illustrated embodiment (e.g. it is manufactured from an insulating material). The gasket 608, in use, interposes the manifold 606 and the component to be machined (e.g. a flange thereof). Advantageously, the non-conductive gasket 608 reduces the extent to which electrochemical machining polishes, or erodes material from, the flange (e.g. 258 of FIG. 7) and an exposed face of any dividing wall (e.g. 287 in FIG. 7). The presence of the gasket 608 may substantially prevent any polishing, or eroding, action occurring to the flange of the component to be machined. The gasket 608 may therefore be said to isolate a flange of the component from the electrochemical machining circuit, and so process more generally. The gasket 608 in the illustrated embodiment generally matches a geometry of the flange of the component as shown in FIG. 7. The gasket 608 may be described as defining a seal.

Returning to FIG. 19, four mounting bores 610, 612, 614, 616 extend through the mounting body 600 (e.g. through both the manifold 606 and the gasket 608). In use, the mounting bores provide a location functionality by aligning with corresponding bores in the component to be machined (see FIG. 7).

Electrodes (not shown in FIG. 19) are coupled to the mounting body 600, specifically the manifold 606 thereof, via first and second bosses 618, 620. Each of the first and second bosses 618, 620 is associated with a respective electrode. The electrodes are attached to bosses 618, 620 via fasteners received through bores 622, 624 (see also fasteners 148, 150 of FIGS. 2a and 2b). Returning to FIG. 19, each boss 618, 620 further comprises a further pair of bores 626, 628 through which a cord is received (to transition the electrode from the movable configuration to the conforming configuration).

Each of the first and second bosses 618, 620 is provided in a respective recess 630, 632. Although not visible in FIG. 19, a respective bore extends between each electrolyte inlet 634, 636 and recess 630, 632 (e.g. in a sidewall thereof). Said bores place the electrolyte inlets 634, 636 in fluid communication with a respective recess 630, 632.

As will be appreciated from FIG. 19, each electrolyte conduit 602, 604 stems from a master electrolyte inlet 638 which branches into the two conduits 602, 604 at a junction 640. The electrolyte flow into each recess 630, 632 can therefore be controlled by solely controlling electrolyte flow through the master inlet 638.

When the mounting body 600 is installed in situ, forming part of an electrode assembly, electrolyte is pumped through the master inlet 638. The master inlet 638, and so electrolyte flow therethrough, branches into the conduits 602, 604 at junction 640. Electrolyte then flows through respective inlets 634, 636 and effectively into recesses 630, 632. The electrolyte then flows around, and along, the electrodes (which are mounted to bosses 618, 620 in use), and through the cavity (which the electrodes are inserted into). The electrochemical machining process thus polishes, or erodes material from, the wall of the cavity of the component. This also occurs whilst avoiding excessive erosion to the flange, and exposed face of the dividing wall, of the component. The electrolyte may be described as flowing into a respective cavity (of the component) from a side of the cavity (e.g. a generally radial inlet).

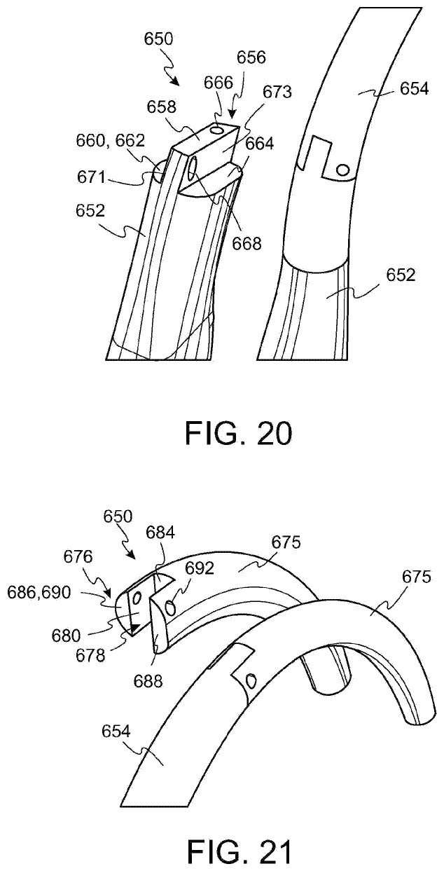

FIG. 20 shows a perspective view of part of an electrode 650 according to another embodiment.

On the left hand side of FIG. 20, part of a first conductive element 652 is shown. On the right hand side of FIG. 20, part of the first conductive element 652 is shown hingeably connected to (part of) a second conductive element 654.

The conductive elements 652, 654 share a number of features in common with the conductive elements 400, 418 shown in FIGS. 16 and 17. For brevity, only the differences will be described here in detail.

Beginning with the first conductive element 652 shown in isolation (i.e. the left hand side of FIG. 20), a second end 656 of the first conductive element 652, generally distal a corresponding mounting body (not shown) is illustrated. Like the conductive element 400 in FIGS. 16 and 17, the second end 656 of the first conductive element 652 comprises a plurality of alignment features in the form of a projection 658 and a surrounding alignment face 660. Of note, in the illustrated embodiment the alignment face 660 does not extend entirely around the projection 658 and is instead divided into a first portion 662 and a second portion 664. The first portion 662 and second portion 664 are located at either side of the projection 658.

The first conductive element 652 further comprises a first passage 666 which extends through the first conductive element 652. The first passage 666 is configured to receive a flexible element, such as a cord, therethrough. Unlike the conductive element 400 shown in FIGS. 16 and 17, the first conductive element 652 of FIG. 20 comprises a single passage 666. An urging means, preferably a flexible element in the form of a cord, is configured to extend through the single passage 666 in a single pass. That is to say, two cords do not extend through the first conductive element 652 and a single cord does not double back on itself in a U-shaped manner. As described elsewhere in this document, actuation of the urging means (e.g. tensioning of the cord in the illustrated embodiment) draws adjacent conductive elements into alignment with one another and places the overall electrode 650 in the conforming configuration. The single passage 666 extends through the projection 658 in the illustrated embodiment. An end of the passage 666 is flush with an end face of the projection 658. Incorporating a single cord, extending through the electrode 650 in a single pass, has been found advantageous for reasons of more straightforward assembly of the overall electrode assembly and more reliable, and repeatable, alignment of the conductive elements with one another. Incorporating a single cord which extends through the elements in a single pass also overcomes problems encountered with either a pair of cords, or a single cord which doubles back, whereby the cord(s) are tensioned but the elements are not properly aligned with one another. The hinge connection between adjacent elements, as described below. can be considered to replicate some of the function of the additional cord, or pass, in providing a degree of alignment between adjacent conductive elements.

Also shown in FIG. 20 is an aperture 668 which forms part of a hinge assembly between the adjacent conductive elements. The aperture 668 is not circular per se, but is instead lozenge-shaped (i.e. of the form of a circle split in two with the resulting semi-circle separated with straight lines extending between previous connecting points). The aperture 668 may be referred to as a hinge pin aperture. Advantageously, the aperture 668 being a lozenge shape, when used with a hinge pin which is cylindrical, provides a camming hinge functionality. Described another way, when the urging means is actuated (i.e. the cord is tensioned) rather than the first and second conductive elements 652, 654 moving in a purely rotational manner relative to one another, the hinge pin can also move through the aperture 668 in a translational motion. This has been found to provide improved alignment of conductive elements relative to one another. The hinge assembly reduces the freedom of movement between adjacent conductive elements (i.e. at least partially constrains the relative movement therebetween) and provides reliable alignment of conductive elements with one another upon actuation of the urging means.

In contrast to, for example, the flat face 312 of the conductive element 300 shown in FIG. 15a, the contact surface area between the first and second conductive elements 652, 654 of FIG. 20 is significantly increased in the conforming configuration as shown on the right hand side of FIG. 20. This is owing to the presence of both first and second portions 662, 664 of the face 660, and the side faces 671, 673 defined by the projection 658. Each of the aforementioned faces contact corresponding faces of the second conductive element 654 (as will be appreciated from viewing FIG. 21, which shows an opposing end of a conductive element in isolation). The increased contact area between adjacent conductive elements is advantageous because an increased contact area means that a greater current can be transmitted through the electrode and, in particular, to the conductive elements which are comparatively further away from the mounting body. The greater contact surface area therefore means that either more current can be carried through the electrode 650 or there is a reduced cooling requirement for a given level of current being carried through the electrode 650. The contact surface area between the first and second conductive elements 652, 654 is around 750 mm² in the illustrated embodiment. This is around three times the surface area that is otherwise in contact for the embodiment shown in FIG. 15a. Undesirable jarring of adjacent conductive elements (i.e. incorrect alignment of adjacent conductive elements when the urging means is actuated [e.g. cord tensioned but conductive elements not fully aligned]) is also alleviated owing to the presence of the projection 658 and corresponding recess (which can be considered to define a keyway, or guideway, of sorts). The projection 658 and corresponding recess also reduce the number of degrees of freedom of movement of the conductive elements.

As will be appreciated from the right hand image in FIG. 20, a substantially continuous outer electrode surface is still defined between the first and second conductive elements 652, 654 even with the ‘camming hinge’ incorporated.

Turning briefly to FIG. 21, second and third conductive elements 654, 675 are shown. Like that described in connection with FIG. 20, on the left hand side of FIG. 21 a third conductive element 675 is shown in isolation, generally from a first end 676 perspective. On the right hand side, part of the second conductive element 654 and the third conductive element 675 are shown in the conforming configuration.

At the first end 676 of the third conductive element 675 a recess 678 is defined. The recess 678, in turn, defines first and second side faces 680 (the second side face not being visible in FIG. 21) and a lower face 684. At an outermost first end 676 of the third conductive element 675 a further alignment face is defined by way of first and second portions 686, 688 of a flat surface 690. It will be appreciated that the first and second portions 686, 688 of the third conductive element 652 generally conform to the first and second portions 662, 664 of the first conductive element 652 (however, it is noted that the first and third conductive elements 652, 654 are not directly hingeably connected to one another [owing to the interposing second conductive element 654]).

A hinge pin bore 692 extends through the third conductive element 675, specifically toward the first end 676 thereof, and is configured to receive a hinge pin therethrough. Owing to the presence of the recess 678 the hinge pin bore 692 is effectively split into two constituent bores at either side of the recess 678. Unlike the hinge pin aperture 668 shown in FIG. 20, the hinge pin bore 692 of the third conductive element 675 is circular in nature.

Although not visible in FIG. 21, a corresponding passage (to the passage 666 in FIG. 20) extends through, and beyond, the lower face 684 of the third conductive element 675 and is configured to receive an urging means, in the form of a single cord, therethrough.

Although the conductive elements shown in FIGS. 20 and 21 are shown with a near entirely arcuate outer electrode surface, it will be appreciated that a variety of other geometries could otherwise be used. For completeness, in preferred embodiments a hinged connection is provided at every join between all of the constituent conductive elements (e.g. at joints between all inboard conductive elements).

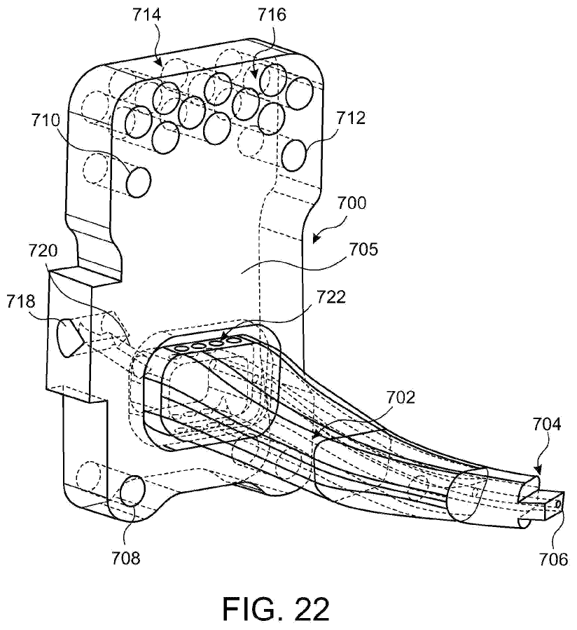

Turning to FIG. 22, a perspective view of a mounting body 700, which forms part of an electrode assembly according to another embodiment, is provided. The mounting body 700 shares a number of features in common with the mounting bodies previously described and only the differences will therefore be described in detail.

The mounting body 700 comprises an integral first conductive element 702. Described another way, the mounting body 700 and first conductive element 702 are unitary in nature and are manufactured as a single component. This has been found to be particularly advantageous for ensuring accurate alignment of the overall electrode, of which the first conductive element 702 forms part, within the cavity to be machined. At a second end 704 of the first conductive element 702, generally distal an engagement face 705 of the mounting body 700, a projection 706 is present (like that described in connection with FIG. 20).

The mounting body 700 comprises four bores 708, 710, 712 (a fourth being hidden from view in FIG. 22) which are used for aligning the mounting body 700 with a component to be machined.

The mounting body 700 further comprises an integral busbar 714. The busbar 714 being integral is intended to mean that the mounting body 700 and busbar 714 are all a single component. This busbar 714 effectively refers to an additional block of material and, in the illustrated embodiment, the busbar 714 comprises an array 716 of additional bores. In the illustrated embodiment the array 716 comprises ten bores. The constituent bores of the array 716 operate as sockets into which power supply cables are inserted in use. A power supply is thus provided in electrical communication with the electrode, of which the first conductive element 702 forms part, via the mounting body 700. In use, conductive inserts, such as copper or stainless steel inserts, may be inserted into the bores which make up the array 716 of bores. Advantageously, the integral busbar 714 reduces the voltage drop between the mounting body and conductive elements of the electrode. This is achieved by effectively removing an interface (e.g. a point of electrical connection) which would otherwise be present between the busbar and the electrode (for example). Efficiency of the overall electrochemical machining process is thus improved. For completeness, each interface (e.g. between adjacent conductive elements) may cause a corresponding voltage drop, which may be around 2-3 V (for example). For a 30V power supply, the voltage drop at each interface could therefore represent ˜10% of the supply voltage. Furthermore, each interface is a potential point of failure. It is therefore desirable to reduce the number of interfaces, or connections, where possible.

The mounting body 700 further comprises an electrolyte aperture 718. In the illustrated embodiment the electrolyte aperture 718 is configured to receive electrolyte therethrough. The electrolyte aperture 718 extends partway through the mounting body 700. A connecting channel 720, formed within the mounting body 700, is provided downstream of the electrolyte aperture 718. The combination of the electrolyte aperture 718 and the connecting channel 720 may be said to define an elbow given that there is a change of direction, substantially 90°, of the electrolyte as it passes therethrough. Although not shown in detail in FIG. 22, but will be described in detail in connection with later Figures, the connecting channel 720 opens out into an internal cavity within the first conductive element 702. An array of electrolyte channels 722, which may be referred to as discharge channels, are distributed around the first conductive element 702. Specifically, the electrolyte channels 722 extend through the first conductive element 702 (i.e. from the internal cavity through to an outer surface). In preferred embodiments at least downstream ends of the electrolyte channels 722 are distributed around the electrode. More detail regarding the electrolyte channels will be provided in connection with later Figures. Downstream ends of the electrolyte channels 722 extend only partway around the conductive element 702 (e.g. are distributed around a proportion of the perimeter of the conductive element 702).

It will be appreciated that a number of advantages associated with features described above, such as the integral busbar and the integral first conductive element 702, may be applied in combination with one another or in isolation of one another. For example, the integral busbar 714 provides advantages both in combination with, and in isolation of, the first conductive element 702 being integral with the mounting body 700. Similarly, the distribution of electrolyte channels 722 is advantageous in isolation of, and in combination with, the integral busbar 714 and the integral first conductive element 702.

The mounting body 700 is preferably manufactured using an additive manufacture method.

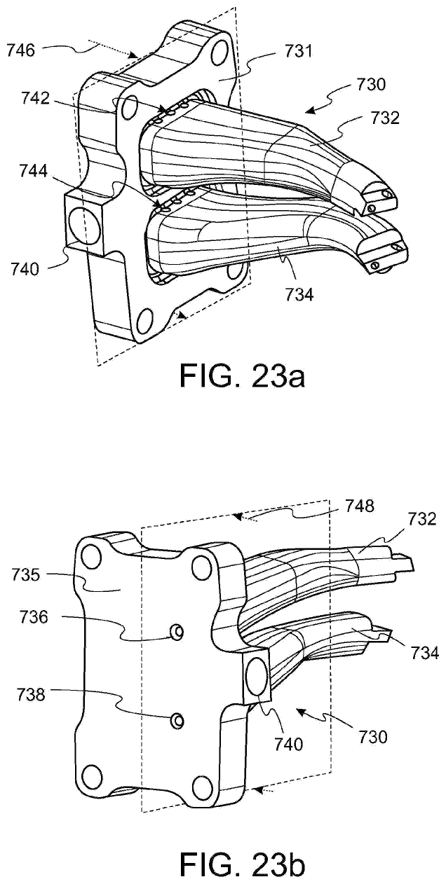

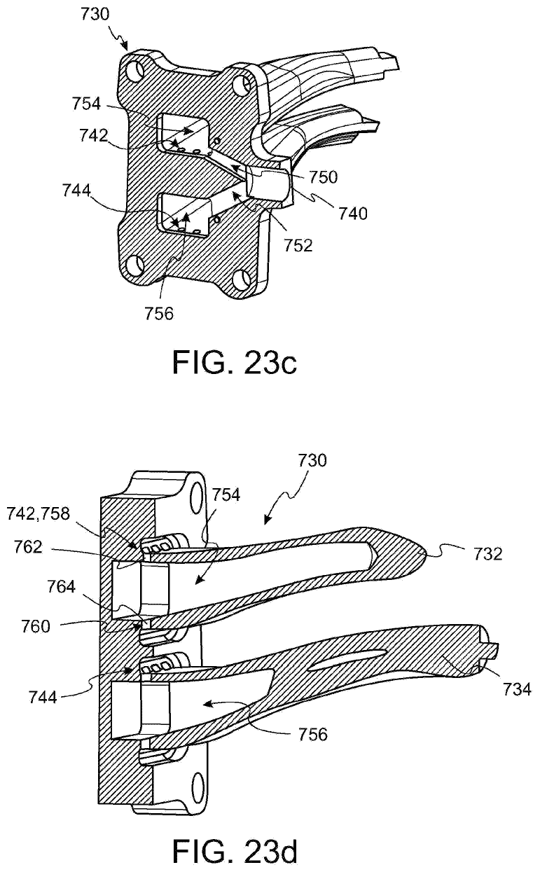

Turning to FIGS. 23a and b, perspective views of a mounting body 730 according to another embodiment is illustrated. FIG. 23a shows the mounting body 730 from an engagement-face 731 side of the mounting body 730 (e.g. proximate the cavity to be machined). FIG. 23b shows a generally opposing (e.g. rear) side of the mounting body 730.

The mounting body 730 shares a number of features in common with the mounting body 700 shown in FIG. 22. Only the differences will therefore be described in detail.

The mounting body 730 comprises a plurality of (integral) first conductive elements 732, 734. The mounting body 730 does not incorporate an integral busbar.

FIG. 23b shows an additional two bores 736, 738 in the rear face 735 of the mounting body 730. The bores 736, 738 are configured to receive respective cords therethrough such that, upon tensioning the cords, downstream conductive elements are drawn into alignment with one another (e.g. the electrodes are transitioned to the conforming configuration). The bores 736, 738 may receive glands in use, through which cords are received.

The mounting body 730 further comprises an electrolyte aperture 740.

FIG. 23a shows two arrays 742, 744 of electrolyte channels, distributed about perimeters of the respective first conductive elements 732, 734. As previously described, in use electrolyte is discharged, or expelled, through the electrolyte channels around an outer electrode surface of the electrodes.

Turning to FIG. 23c and 23d, perspective cross-section views of the mounting body 730 are provided. FIG. 23c is taken about the cross-section labelled 746 in FIG. 23a, and FIG. 23d is taken about the cross-section labelled 748 in FIG. 23b.

Beginning with FIG. 23c, as indicated in FIG. 23a the cross-section is taken about a thickness of the mounting body 730. FIG. 23c shows the electrolyte aperture 740 extending partway through the mounting body 730 and splitting into two connecting channels 750, 752. Downstream ends of each of the first and second connecting channels 750, 752 open out into respective first conductive element cavities 754, 756. The cavities 754, 756 refer to an internal volume within each of the first conductive elements 732, 734 respectively. As will be appreciated from FIG. 23d, the cavities 754, 756 extend partway through the first conductive elements 732, 734 respectively. The cavities 754, 756 advantageously reduce the mass of the mounting body 730, and provide a fluid pathway for electrolyte to flow through.

Returning to FIG. 23c, the first and second arrays 742, 744 of electrolyte channels extend between the cavity 754, 756 and the exterior surface of the first conductive elements 732, 734. When the mounting body 730 is coupled to a component to be machined, and the electrode(s) extends through the cavities to be machined, electrolyte is pumped through the electrolyte aperture 740, through one of the first and second connecting channels 750, 752 into a respective conductive element cavity 754, 756 and is then discharged by the respective array of electrolyte channels 742, 744. The electrolyte is discharged through the arrays 742, 744 of electrolyte channels into a gap between an internal wall of the cavity to be machined and an outer electrode surface of the electrodes (e.g. including the first conductive elements 732, 734).

Turning to FIG. 23d, the layout of the electrolyte channels will now be described in more detail. FIG. 23d illustrates that the first array 742 of electrolyte channels includes electrolyte channels generally arranged at two opposing sides of a perimeter of the first conductive element 732. Described another way, as shown in FIG. 23d electrolyte channels are only provided through generally upper and lower sides of the first conductive element 732. Where the first conductive element 732 has a generally rectangular cross section, the electrolyte channels may be described as only being provided along one pair of parallel sides.

Beginning with the first array 742 of electrolyte channels, the first array 742 comprises first and second series 758, 760 of electrolyte channels. The first and second series 758, 760 of electrolyte channels are provided at opposing sides of the first conductive element 732 whilst the other pair of opposing sides are free of electrolyte channels. Described another way, two of the sides are generally solid with no channels, whilst two of the sides do comprise channels. Two electrolyte channels are labelled 762, 764 respectively and form part of the first and second series 758, 760 of electrolyte channels respectively. Each of the electrolyte channels extends generally normally through a thickness of the first conductive element 732 (i.e. at a right angle through the internal and external surfaces of the conductive element 732).

Advantageously, the inventors have found that providing a distribution of electrolyte channels around the electrode provides for an improved distribution of electrolyte flow around the electrode during electrochemical machining. This, in turn, results in improved electrochemical machining efficiency by virtue of a more even removal of material from the internal cavity which is being machined.

Although not described in detail here, the other first conductive element 734 also comprises the array 744 of electrolyte channels which comprises first and second series provided generally at opposing sides of the first conductive element 734. The above description, in connection with the array 742, applies equally to the array 744.

Wherever electrolyte is flowing through: 1) a channel, or conduit, of a mounting body which is electrically connected to at least part of an electrode (e.g. where a first conductive element is integral with the mounting body); and 2) the channel, or conduit, is upstream of the electrode (e.g. a first conductive element thereof), the electrolyte is effectively precharged before the electrolyte meets the electrode. Described another way, ions within the electrolyte become charged. This is advantageous, for reasons described in detail later in this document, for the reason that the machining action by the electrolyte occurs more effectively at an upstream end of the cavity to be machined.

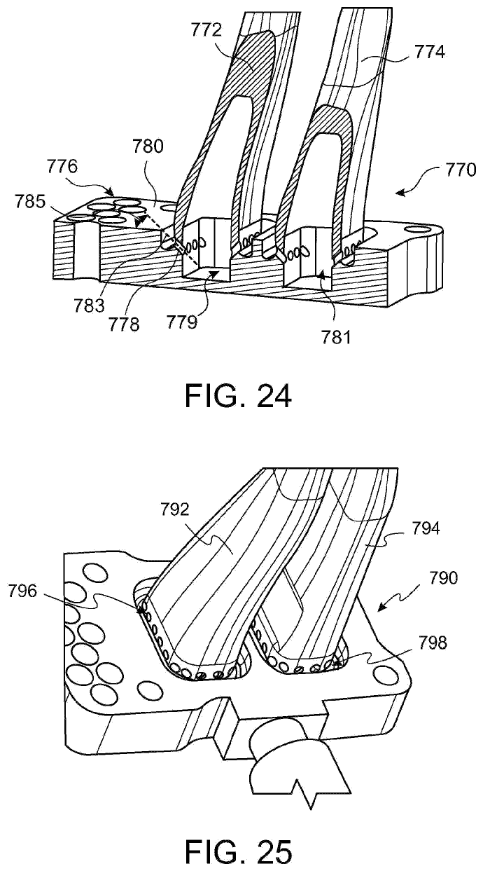

Turning to FIG. 24, a cross-section view of a further embodiment of mounting body 770 is illustrated. The mounting body 770 shares a number of features in common with the mounting body 700 of FIG. 22 and the mounting body 730 of FIG. 23a to d. Only differences will be described in detail.

The mounting body 770 comprises integral first and second conductive elements 772, 774. Furthermore, the mounting body 770 comprises an integral busbar 776.

Unlike the previous embodiments, electrolyte channels are not disposed normal to a thickness of the first conductive elements 772, 774 but are angled (e.g. inclined). The electrolyte channels thus more smoothly guide electrolyte in a direction that the cavity to be machined extends in. Described another way, the electrolyte channels guide electrolyte flow around, and along, the first conductive elements 772, 774. In the illustrated embodiment, and taking a first electrolyte channel 778 as an example, the electrolyte channels are angled in a downstream direction. That is to say, the electrolyte channels are angled with a direction of flow through the cavities 779, 781 and into the internal cavity to be machined. The electrolyte channels 778 may be said to define an axis 783, the axis 783 defining an angle 785 with an engagement face 780 of the mounting body 770. The angle 785 is preferably acute. In the illustrated embodiment the angle 785 is around 45 degrees. The flow of electrolyte through the various channels and cavities also provides an advantageous cooling effect upon the electrode.

Electrolyte channels of the mounting body 770 are only disposed along two opposing sides of each of the first conductive elements 732, 734. The two other sides remain solid and do not comprise any electrolyte channels. The electrolyte channels are bores in the illustrated embodiment (i.e. circular in cross-section and are straight in extent) but in other embodiments other geometry and/or shapes may be employed.

Turning to FIG. 25, a perspective view of part of a mounting body 790 according to another embodiment is provided. The mounting body 790 shares a number of features in common with the mounting body 770 shown in FIG. 24, and only the differences will be described in detail.

First conductive elements 792, 794 are integral with the mounting body 790, as is a busbar. First and second arrays 796, 798 of electrolyte channels extend around the perimeters of each of the first conductive elements 792, 794 respectively. Unlike the mounting body 770 shown in FIG. 24, for the mounting body 790 each of the arrays 796, 798 of electrolyte channels extend continuously around the perimeters of the first conductive elements 792, 794. Described another way, electrolyte channels are provided through each side of the conductive elements 792, 794 (i.e. there are no sides of the conductive elements 792, 794 which have no electrolyte channels). The distribution of electrolyte channels may be described as equal distribution around the (entire) perimeters of the conductive elements 792, 794 in that the electrolyte channels define a generally repeating pattern with equidistant spacing between adjacent electrolyte channels. This is generally the case save for any minor deviations to allow for the urging means (i.e. a flexible element, such as a cord) to extend through the conductive elements 792, 794. Described another way, the repeating pattern, or even distribution, may not be perfectly even, or equal, for each of the electrolyte channels, there may be minor deviations.

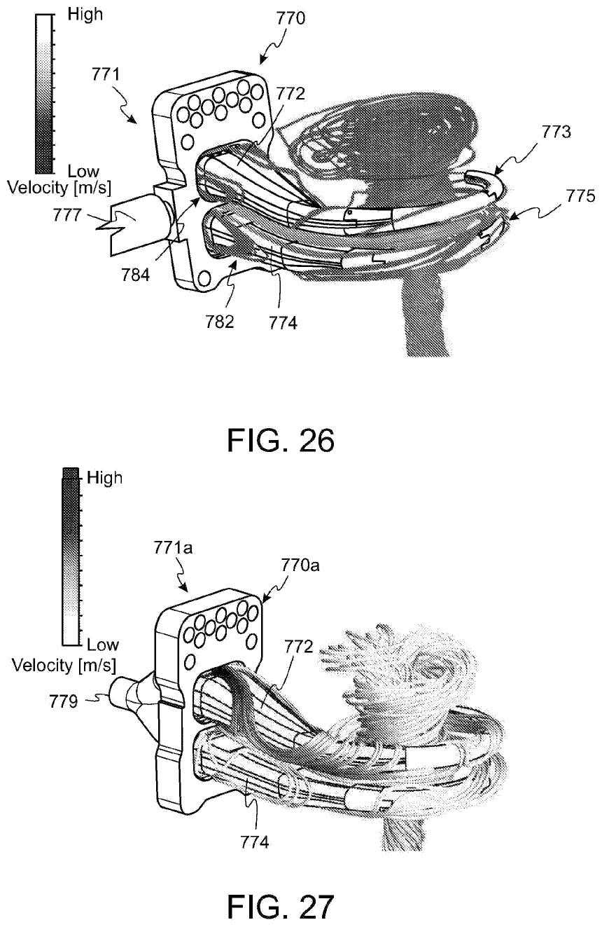

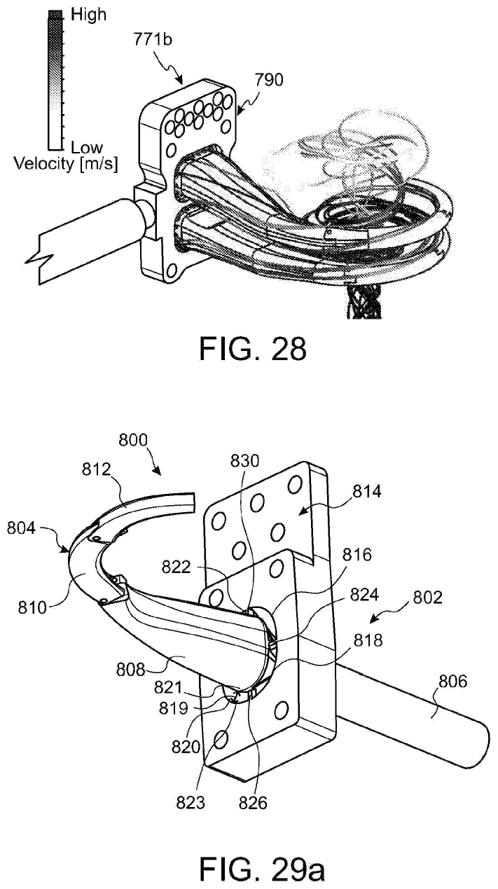

Turning to FIG. 26, the results of a Computational Fluid Dynamics (CFD) simulation conducted on an electrode assembly 771 comprising the mounting body 770 of FIG. 24 are provided. FIG. 26 is a velocity plot showing the contours, and velocity, of electrolyte having passed through the mounting body 770 and along first and second electrodes 773, 775 of which first conductive elements 772, 774 form part. Hidden from view in FIG. 26 is a turbine housing into which the first and second electrodes 773, 775 are inserted. Similarly, the pair of turbine housing volutes, which are the cavities being machined by way of electrochemical machining, are also hidden from view. A representative housing is indicated in FIG. 28 for completeness.

Returning to FIG. 26, the electrode assembly 771, specifically the mounting body 770 thereof, comprises an electrolyte conduit 777. In use, electrolyte is supplied to the mounting body 770 via the electrolyte conduit 777. From FIG. 26 it will be appreciated that the electrolyte conduit 777 is generally provided at a right angle (e.g. an elbow joint) to a thickness of the mounting body 770.

The CFD results shown in FIG. 26 indicate regions 782, 784 of comparatively high recirculation of electrolyte proximate a downstream end of the electrolyte channels (i.e. near where the electrolyte first exits the mounting body 770 by the first conductive elements 772, 774). In particular, the regions of high recirculation 782, 784 occur on the sides of the conductive elements 772, 774 which do not incorporate any electrolyte channels. Although not visible in FIG. 26, similar results are observed on the opposing sides of the first conductive elements 772, 774. Similarly, from the velocity plot it will be appreciated that the electrolyte flow velocity is comparatively lower around the first electrode 773 in comparison to the second electrode 775. Described another way, the electrolyte velocity is generally higher moving around the lower of the electrodes in comparison to the upper electrode.

Regions of recirculating electrolyte have been found to be undesirable for at least the reason that a continuous flow of fresh electrolyte along the electrodes 773, 775 results in the most efficient, and uniform, electrochemical machining. Whilst electrochemical machining occurs, insulating hydroxides are formed as byproducts of the process (e.g. in the form of a viscous slurry). As suggested, the insulating nature of the hydroxides negatively impact electrochemical machining by reducing the efficiency of machining, or entirely preventing it, in the regions of the internal wall of the cavity which are effectively shielded by these insulting hydroxides. During normal operation, such hydroxides are flushed by the continuous pumping of electrolyte through the cavity being machined. Regions of electrolyte flow recirculation 782, 784 can result in regions of the internal cavity being machined at significantly lower rates than others (i.e. as much of a difference as three times the magnitude of machining). This is at least partly due to hydroxides being suspended, rather than ‘flushed’, by electrolyte. More generally, turbulence within the electrolyte flow is undesirable.

Turning to FIG. 27, the results of a CFD simulation conducted on a modified electrode assembly 771a are provided. The modified electrode assembly 771a shares many features in common with the electrode assembly 771 of FIG. 26 other than an electrolyte conduit 779 is a generally straight feed conduit. Described another way, the electrolyte conduit 779 does not extend generally normal to a thickness of the mounting body 770a but instead generally extends normal to major faces (i.e. the engagement face and opposing face) of the mounting body 770a.

As a result of this difference in orientation of the electrolyte conduit 779, the electrolyte fed through the electrolyte conduit 779 has fewer, and less extreme, changes of direction in comparison to the generally right-angled electrolyte conduit 777 of FIG. 26. When the CFD results of FIGS. 26 and 27 are compared, it will be appreciated that, in FIG. 27, the flow is more evenly distributed around the conductive elements 772, 774, and that the recirculation zones 782, 784 of FIG. 26 have been reduced. However, some recirculation remains in similar zones at sides of the conductive elements 772, 774 at which there are no electrolyte channels. In short, the incorporation of a generally straight feed electrolyte conduit 779 has improved the flow characteristics and would therefore improve the efficiency of electrochemical machining, but it is still desirable to obtain a more uniform flow distribution around the conductive elements 772, 774 of the respective electrodes.

FIG. 28 shows the results of a CFD simulation carried out on an electrode assembly 771b comprising the mounting body 790 of FIG. 25 (e.g. where downstream ends of the electrolyte channels are generally evenly, and continuously, distributed around the electrodes).

When FIGS. 26 and 28 are compared, it will be appreciated that distributing downstream ends of the electrolyte channels around an entire perimeter of the electrode(s) (e.g. a generally even distribution) reduces the recirculation of electrolyte within the cavity being machined.

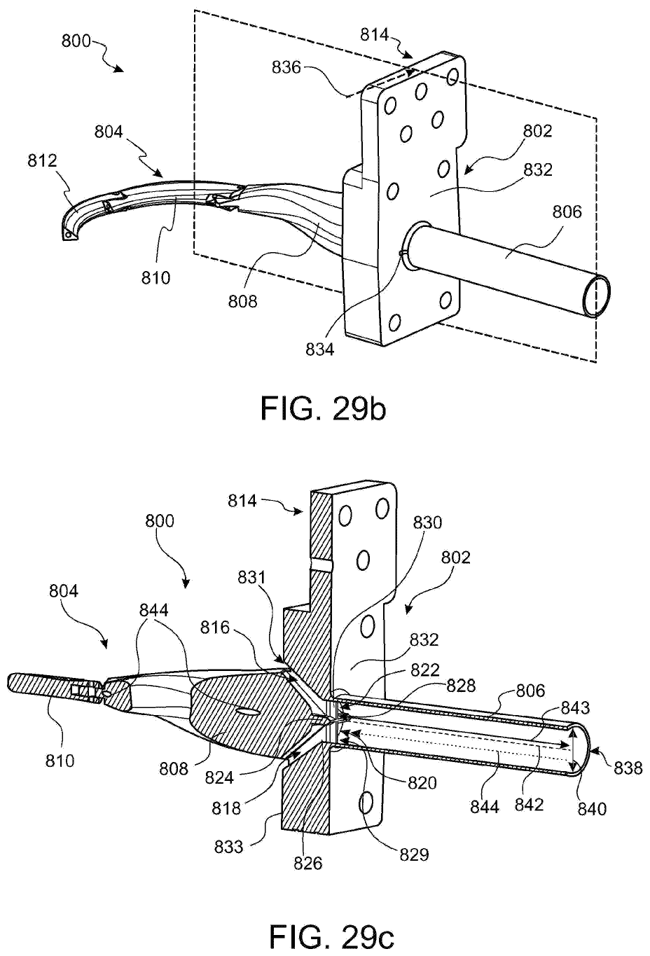

FIG. 29a is a perspective view of an electrode assembly 800 according to another embodiment.

The electrode assembly 800 comprises a mounting body 802, a first electrode 804 and an electrolyte conduit 806.

As previously described elsewhere in this document, the first electrode 804 comprises first, second and third conductive elements 808, 810, 812. The conductive elements 808, 810, 812 are hingeably connected to one another in the same way as those described in connection with FIGS. 20 and 21. For the avoidance of doubt, the electrode 804 is shown in the moveable configuration, in which the conductive elements 808, 810, 812 are moveable relative to one another, but the electrode 804 can be transitioned to a conforming configuration in which the conductive elements 808, 810, 812 align with one another to define a substantially continuous outer electrode surface. The first conductive element 808 is coupled to, and is integral with, the mounting body 802. The mounting body 802 also comprises an integral busbar 814.

Provided through the mounting body 802 are a plurality of electrolyte channels, which may be referred to as discharge channels, through which electrolyte can flow. First to fourth electrolyte channels 816, 818, 820, 822 are distributed around the first conductive element 808 of the electrode 804. The plurality of electrolyte channels 816, 818, 820, 822 may be referred to as an array of electrolyte channels. The electrolyte channels are defined by ribs 824, 826, 830 (one of the ribs not being shown in FIG. 29a) which may be described as extending between the electrolyte channels 816, 818, 820, 822. More detail regarding the electrolyte channels will be provided in connection with FIG. 29c which shows a cross-section view through the electrode assembly 800.

The mounting body 802 is preferably manufactured using an additive manufacture method.

FIG. 29b is a perspective view of the electrode assembly 800 from a generally rear side of the assembly. FIG. 29b shows the electrolyte conduit 806 extending from a rear face 832 of the mounting body 802. In the illustrated embodiment the electrolyte conduit 806 extends substantially perpendicular to the rear face 832 of the mounting body 802. Described another way, the electrolyte conduit 806 is substantially normal to the rear face 832 of the mounting body 802. The electrolyte conduit 806 is an external conduit owing to the fact that it projects from the rear face 832 of the mounting body 802 (as opposed to, for example, extending internally within the mounting body 802). The electrolyte conduit 806 has a circular cross-section in the illustrated embodiment, although it will be appreciated that other cross-section geometries may otherwise be used. The electrolyte conduit 806 is manufactured from the same material as the rest of the mounting body 802 in the illustrated embodiment (e.g. 316L stainless steel, although other materials may otherwise be used). The electrolyte conduit 806 is also integral with the mounting body 802. Described another way, the electrolyte conduit 806 may be manufactured in a unitary manner with the rest of the mounting body 802 (i.e. such that they form a single component with no join lines). Otherwise, and still considered integral, the electrolyte conduit 806 may be connected to the mounting body 802 in a subsequent manufacturing step, e.g. welding. In the illustrated embodiment the electrolyte conduit 806 is TIG welded to the mounting body 802 (specifically a rear face 832 thereof).

The electrolyte conduit 806 preferably extends by at least one, more preferably three and more preferably at least around six diameters in extent (e.g. 843 in FIG. 29c). Extent here is intended to mean a length of the electrolyte conduit 806. Where the electrolyte conduit 806 has a non-circular cross section, the extent of the conduit may be defined in terms of a major dimension through a cross-section of the conduit (e.g. a diameter, in the case of a circular pipe).

The incorporation of the electrolyte conduit 806 provides a number of advantages. Firstly, the electrolyte conduit 806 provides a heat sink functionality by increasing the surface area of conductive material in thermal communication with the bulk of the rest of the mounting body 802. As such, during electrochemical machining where, for example, 1000 A may be passed through the mounting body 802 via the busbar 814, the electrolyte conduit 806 assists in providing a heat sink functionality to cool the overall electrode assembly 800 and the electrolyte flowing therethrough. A further advantage is that the electrolyte conduit 806 provides a more uniform flow of electrolyte through the mounting body 802 and around the first conductive element 808. As already described, a uniform, and reduced turbulence, flow of electrolyte is desirable for reasons of improved efficiency of electrochemical machining. This is particularly advantageous where the electrolyte conduit 806 is axial in nature (i.e. straight) and is substantially normal to the rear surface 832 of the mounting body 802. A further advantage provided by the electrolyte conduit 806 is that as electrolyte flows through the conduit 806, by virtue of the electrolyte conduit 806 being electrically connected (e.g. by virtue of being integral with the mounting body 802) the electrolyte is effectively charged as it moves through the conduit. The electrolyte conduit 806 can therefore be considered to form part of an overall cathode of which the mounting body 802 forms part (including the integral busbar 814 and the first conductive element 802). Charge is therefore transferred to the electrolyte, and the electrolyte is precharged before it actually meets the first conductive element 808 (e.g. before the electrolyte flow enters the electrolyte channels 816, 818, 820, 822). This has advantageously been found to improve the quality of machining as the electrolyte is expelled from the electrolyte channels (visible in FIG. 29a) around the first conductive element 808. The precharging is achieved by increasing the contact time for which the electrolyte passes through electrically charged surrounding surfaces. Precharging refers to the effective charging of the electrolyte before the electrolyte meets the electrode, and provides improved electrochemical machining results at an upstream end of the cavity.

For at least the reasons set out above, incorporation of the electrolyte conduit 806 provides a number of different benefits for the mounting body 802 and the electrode assembly 800 more generally.

Also shown extending partway through the mounting body 802 is a bore 834. The bore 834 is configured to receive an urging means in the form of a flexible element (e.g. a cord) therethrough to be able to transition the electrode 804 from a moveable configuration (e.g. as shown in FIG. 29b) to a conforming configuration (e.g. as shown in FIG. 21).

A clearance, or gap, 819 exists between a perimeter 821 of the first conductive element 808 and an outer edge 823 of the electrolyte channels. This clearance is preferably between around 4 mm and around 6 mm. The outer edge 823 of the electrolyte channels preferably matches the opening which defines the internal cavity to be machined.

Turning to FIG. 29c, a perspective cross-section view of part of the electrode assembly 800 shown in FIGS. 29a and b is provided. The FIG. 29c view is taken about the cross-section labelled 836 in FIG. 29b.

Beginning first with the electrolyte conduit 806, as mentioned above in the illustrated embodiment the electrolyte conduit 806 is a circular pipe having a circular cross-section. A major dimension of the cross-section of the electrolyte conduit 806 is therefore defined by a diameter 840 in the illustrated embodiment. Specifically, the major dimension is defined by an internal diameter 840. The electrolyte conduit 806 has an extent, or length, 843 (which is parallel to the axis 842 in the illustrated embodiment). The extent 843 of the conduit 806 spans from the upstream end 838 to the upstream end 829 of the electrolyte channels 16, 818, 820, 822 in the illustrated embodiment. As mentioned above, the extent 843 of the electrolyte conduit 806 is entirely axial in the illustrated embodiment (i.e. straight) but in other embodiments an arcuate section may be incorporated. Similarly, the axis 842 is normal to the rear face 832, and the engagement face 833, of the mounting body 802. The axis 842 is also normal to an opening that defines the internal cavity that is machined by the electrochemical machining process.

In use, electrolyte is fed through the electrolyte conduit 806 from an upstream end 838. The electrolyte then flows through the electrolyte conduit 806 as indicated by directional arrow 844. Importantly, owing to the axial nature of the electronic conduit 806, and the orientation of the conduit 806 relative to the rear face 832 of the mounting body 802, electrolyte flow 804 through the conduit 806 is relatively uniform and lamina.

At a downstream end of the electrolyte conduit 806, the flow of electrolyte 844 is then divided between the plurality of electrolyte channels 816, 818, 820, 822. The first and second electrolyte channels 816, 818 are shown in cross-section, with the third and fourth channels 820, 822 partially obscured from view (although an upstream end is partially visible). As shown in FIG. 29c, each of the electrolyte channels 816, 818, 820, 822 is defined by one or more of the plurality of ribs 824, 826, 828, 830. For example, the first electrolyte channel 816 (in the upper left hand quadrant of FIG. 29c) is defined by a combination of the first and fourth ribs 824, 830. Each of the first to fourth ribs 824, 826, 828, 830 has a reduced cross-sectional area at an upstream end. Described another way, each of the ribs 824, 826, 828, 830 may be said to be tapered (e.g. chamfered). Advantageously this improves the guiding of electrolyte flow over the ribs 824, 826, 828, 830 and through the electrolyte channels 816, 818, 820, 822.

Electrolyte is delivered to the upstream end 838 of the electrolyte conduit 806 via another electrolyte supply (not shown). Said electrolyte supply may take the form of a conduit, preferably a non-conductive (e.g. insulating) conduit.

When FIG. 29c is considered in combination with FIG. 29a, it will be appreciated that the electrolyte channels 816, 818, 820, 822 take the form of generally arcuate cavities, particularly downstream ends thereof (e.g. 831). The arcuate cavities may otherwise be described as arcuate apertures at the downstream ends 831 of the electrolyte channels 816, 818, 820, 822. Furthermore, the electrolyte channels 816, 818, 820, 822, again specifically downstream ends 831 thereof, are distributed around the first conductive element 808 and generally conform to a perimeter thereof. The electrolyte channels 816, 818, 820, 822 are also evenly distributed around an entire perimeter of the first conductive element 808. The electrolyte channels 816, 818, 820, 822 also generally increase in cross-sectional area from an upstream end 829 to a downstream end 831, such that the electrolyte flow therethrough can be described as diffusing.

Returning to FIG. 29c, it will also be appreciated that the first conductive element 808 is coupled to each of the plurality of ribs 824, 826, 828, 830. Described another way, the first conductive element 808 is effectively connected to the mounting body 802 via the ribs 824, 826, 828, 830. Furthermore, as previously described, the first conductive element 808 is integral with the mounting body 802.

Although there are four electrolyte channels 816, 818, 820, 822 in the illustrated embodiment, it will be appreciated that there may be more, or fewer, electrolyte channels. For example, two or three electrolyte channels could otherwise be incorporated. Similarly, five or more electrolyte channels could otherwise be used. Furthermore, and returning to FIG. 29a, the electrolyte channels 816, 818, 820, 822 are evenly distributed around an entire perimeter of the first conductive element 808. In other embodiments the electrolyte channels 816, 818, 820, 822 may only be distributed around part of a perimeter of the electrode, and/or may extend through part of the electrode (e.g. as shown in FIGS. 22 to 25).

In the illustrated embodiment each of the electrolyte channels 816, 818, 820, 822 extends entirely through a main block of the mounting body 802 (e.g. between the engagement face 833 and the rear face 832). In other embodiments, the electrolyte channels may not extend through such an extent of the mounting body 802. However, it is preferred that the downstream ends 831 of the plurality of electrolyte channels 816, 818, 820, 822 open out through the engagement face 833 of the mounting body 802.

Finally, FIG. 29c also shows part of a passage 844 through which the urging means, in the form of a flexible element (e.g. a cord) extends through the electrode 804. Although not shown in FIG. 29c, in preferred embodiments that passage also extends through a rib (e.g. the first rib 824) and through the bore 834 (as shown in FIG. 29b).

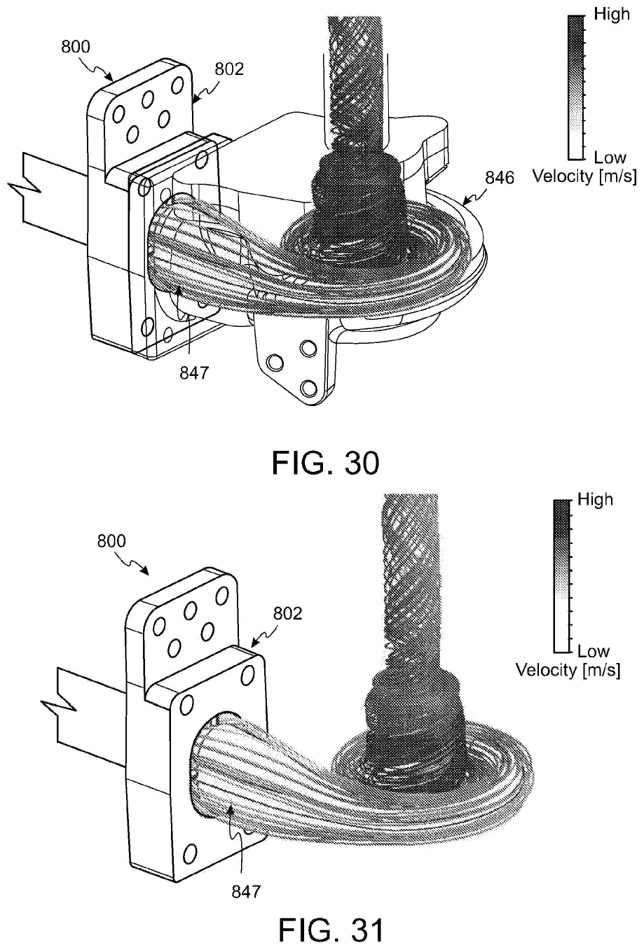

Turning to FIGS. 30 and 31, the results of CFD simulations conducted on the electrode assembly 800 of FIGS. 29a-c are shown. The results show velocity contour plots of the route taken by electrolyte upon expulsion from the mounting body 802 into a component to be machined (a turbine housing 846 in this instance, as shown in FIG. 30). When FIGS. 30 and 31 are compared with FIGS. 26 and 27, it will be appreciated that the electrolyte is expelled from the mounting body in a much more uniform manner than that shown in FIGS. 26 and 27. In particular, in a region 847 proximate an upstream end of the cavity to be machined, the contour lines are entirely separate from one another, absent any recirculation, and follow the outer electrode surface of the first conductive element. This is desirable electrolyte behaviour, as previously described, for the reason that a uniform and less turbulent flow of electrolyte, with little or no recirculation, provide uniform and efficient electrochemical machining. Efficient electrochemical machining may refer to a desirable surface finish being achieved in a low process time (e.g. cycle time). The inventors have also found that the uniformity of the velocity distribution is an important factor for electrochemical machining. The increase in cross-section of the electrolyte channels through the mounting body 802 also provides a more uniform flow of electrolyte (e.g. avoids localised areas of high velocity jets where electrolyte may otherwise have been expelled through comparatively small bores).

It is desirable to improve the efficiency of electrochemical machining generally for the reason that the power requirement can then be reduced (e.g. resulting in lower operating costs). Cooling requirements are also reduced. By reducing the cooling requirement, electrolyte can be pumped at a lower flowrate which, in turn, reduces the risk of turbulent flow disrupting the electrochemical machining process. The electrolyte flowrate is balanced to provide a desirable level of ‘flushing’ of machined material whilst avoiding the formation of turbulent eddy currents in the flow. An electrolyte flowrate of around 22 litres per minute has been found to be particularly effective.

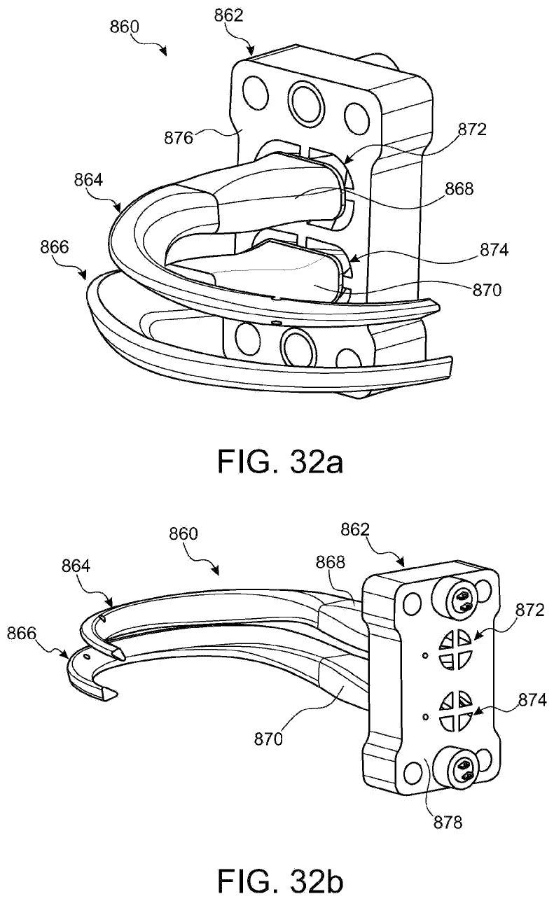

FIG. 32a is a perspective view of an electrode assembly 860 according to another embodiment. FIG. 32a is taken generally from an engagement face 876 side of the assembly, with FIG. 32b taken generally from a rear side 878. The electrode assembly 860 shares many features in common with the electrode assembly 800 described in detail in connection with FIG. 29a to c, and only the differences will be described in detail.

The electrode assembly 860 comprises a mounting body 862 and first and second electrodes 864, 866. First conductive elements 868, 870 of the first and second electrodes 864, 866 respectively are coupled to, and integral with, the mounting body 862. In FIG. 32a and 32b regions of the electrodes 864, 866 beyond the first conductive elements 868, 870 are modelled as single pieces for ease of illustration, although in practice the electrodes 864, 866 each comprise a plurality of conductive elements as described elsewhere in this document.

Distributed around each of the first conductive elements 868, 870 are respective first and second pluralities of electrolyte channels 872, 874. Save for the fact that there is a second electrode 866 and a second plurality of electrolyte channels 874, many of the other features, particularly in connection with the electrolyte channels, are the same as those described in connection with the electrode assembly 800 of FIG. 29a to c.

Turning to FIG. 32b, as mentioned above a view generally of a rear face 878 of the electrode assembly 860 is provided. FIG. 32b illustrates how the first and second pluralities of electrolyte channels 872, 874 extend through an entire thickness of the mounting body 802 (e.g. between the engagement face 876 [as labelled in FIG. 32a] and the rear face 878). Based on FIG. 32a and 32b it will be appreciated that each of the first and second arrays of electrolyte channels 872, 874 are distributed evenly around an entire perimeter of each of the first and second electrodes 864, 866 respectively. That is to say, the first plurality of electrolyte channels 872, specifically downstream ends thereof, are distributed around the first conductive element 868. Similarly, the second plurality of electrolyte channels 874, specifically downstream ends thereof, are distributed around the second conductive element 870. Although two electrodes 864, 866 are incorporated in the illustrated embodiment, it will be appreciated that fewer, or more, electrodes may otherwise be incorporated in other embodiments. A plurality of electrolyte channels are preferably distributed around each electrode where the assembly comprises more than one electrode.

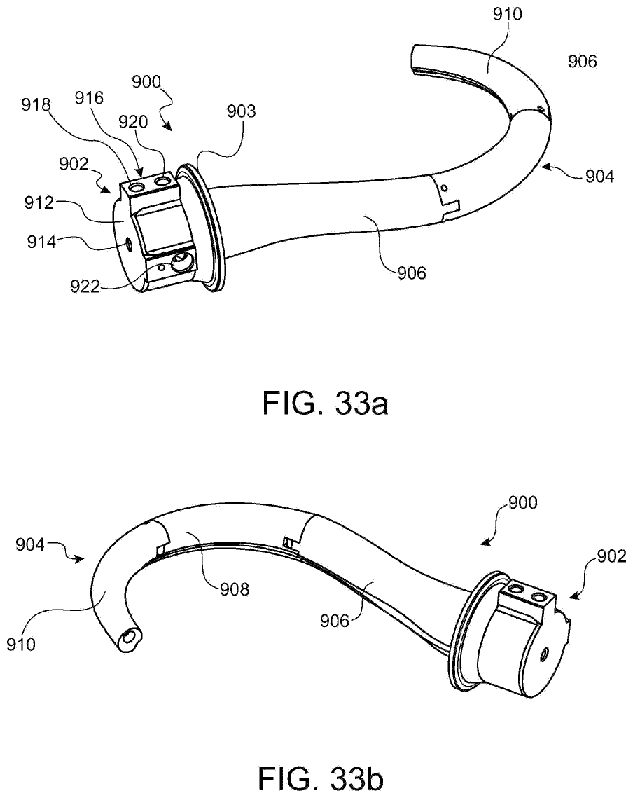

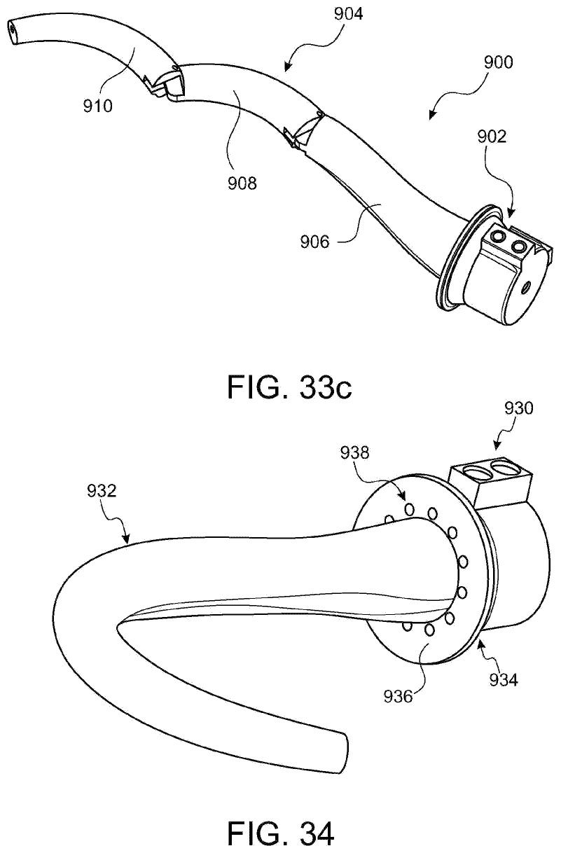

Turning to FIGS. 33a and b, an electrode assembly 900 according to another embodiment is provided. Whereas many of the prior electrode assemblies have been for machining turbine housings, the electrode assembly 900 is for machining a compressor housing instead.

Many of the core features of the electrode assembly 900 are common to the prior embodiments. For example, the electrode assembly 900 comprises a mounting body 902 having an engagement face 903 engageable with the compressor housing to align the mounting body 902 with the housing. The electrode assembly 900 further comprises an electrode 904 comprising first, second and third conductive elements 906, 908, 910. The electrode 904 is shown in a conforming configuration in FIGS. 33a and b but in a moveable configuration in FIG. 33c.

A rear face 912 of the mounting body 902 comprises a bore 914 through which urging means, e.g. in the form of a flexible element such as a cord, is receivable to transition the electrode 904 from the moveable configuration to the conforming configuration. The mounting body 902 further comprises an integral busbar 916 which comprises first and second sockets 918, 920 for electrically connecting the mounting body 902, and electrode 904, to a power supply. The mounting body 902 further comprises an electrolyte conduit 922 integral with the mounting body 902 and configured to receive electrolyte therethrough. Downstream electrolyte channels are shown and described in connection with FIG. 34 (which, for completeness, relates to a slightly different embodiment of electrode assembly).

FIG. 33b is a different perspective view of the electrode assembly 900. FIG. 33c is shows the electrode assembly 900 with the electrode 904 in a movable configuration.

FIG. 34 is a perspective view of an electrode assembly 930 according to another embodiment. The electrode assembly 930 shares many features in common with the electrode assembly 900 of FIG. 33a to c and only the differences will be described in detail.

Firstly, an electrode 932 of the electrode assembly 930 is shown as a single, solid piece for ease of illustration. This is only for reasons of modelling and in practice the electrode 932 would comprises a plurality of conductive elements, hingeably connected to one another, as shown in FIG. 33a to c.

The electrode assembly 930 comprises a mounting body 934. Distributed around an engagement face 936 of the mounting body 932 are a plurality of electrolyte channels 938. The plurality of electrolyte channels 938, specifically downstream ends thereof, are bores which are evenly distributed around the electrode 932 proximate the mounting body 934. The plurality of electrolyte channels 938 are therefore circumferentially distributed around the electrode 932.

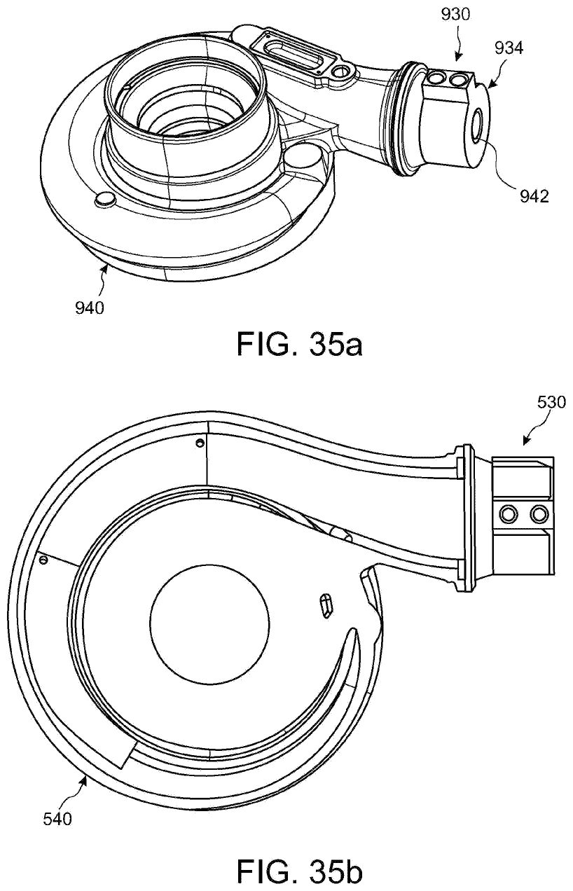

Turning to FIGS. 35a and b, a perspective view of the electrode assembly 930 of FIG. 34 installed in situ and coupled to a compressor housing 940 is shown. FIG. 35a also shows an electrolyte conduit 942, an axial conduit integral with, and extending partway through, the mounting body 934. Advantageously, the incorporation of the axial electrolyte conduit 942 reduces electrolyte flow disruption and provides a reduced turbulence flow of electrolyte into a volute of the compressor housing 940 during electrochemical machining, as well as precharging the electrolyte. The electrolyte conduit 942 in FIG. 35a may be described as an internal conduit in that it can be considered to extend within the mounting body 934.

FIG. 35b is a partially cut-away plan view showing the electrode assembly 930 extending through the volute of the compressor housing 940.

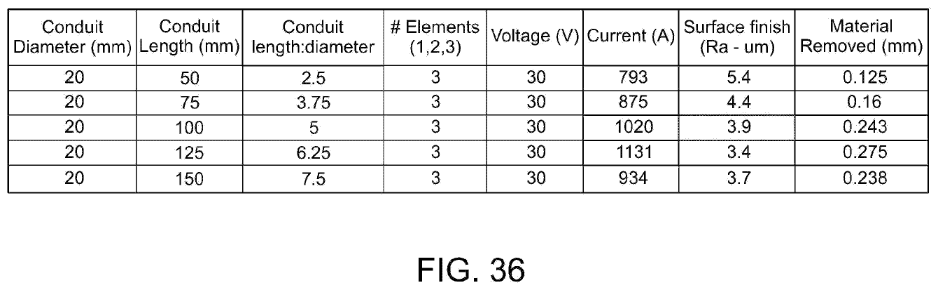

FIG. 36 is a table of experimental data obtained using the electrode assembly 800 of FIGS. 29a to c when a turbine housing is machined.

As indicated in FIG. 36, the supply voltage was held constant at 30 V across all tests. The tests were therefore voltage-driven tests. The length, or extent, of the conduit 806 (FIG. 29a) was varied and the resulting effect upon the electrochemical machining process was recorded. The effect was ascertained by measuring the surface finish of a turbine housing machined using the process (using a manual measurement—a stylus at an inlet of the turbine housing), as well as the amount of material removed (again a manual measurement—callipers across the inlet).

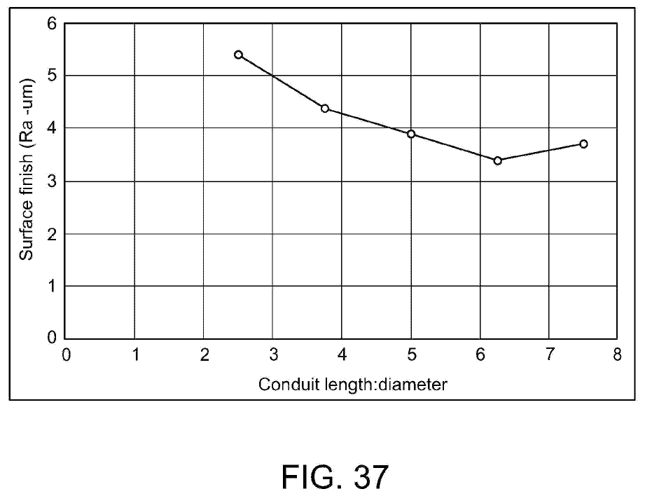

As indicated by the table of FIG. 36, a conduit length:diameter ratio of ˜6 provided the best surface finish with the machining process having removed the most material from the turbine housing. As shown in FIG. 37, which is a plot of the FIG. 36 data (with surface finish plotted on the Y axis), the best surface finish is obtained in embodiments where the extent of the conduit is at least around 6 diameters. This is considered to be a combination of the conduit extent providing uniform flow, as well as a precharging effect upon the electrolyte.

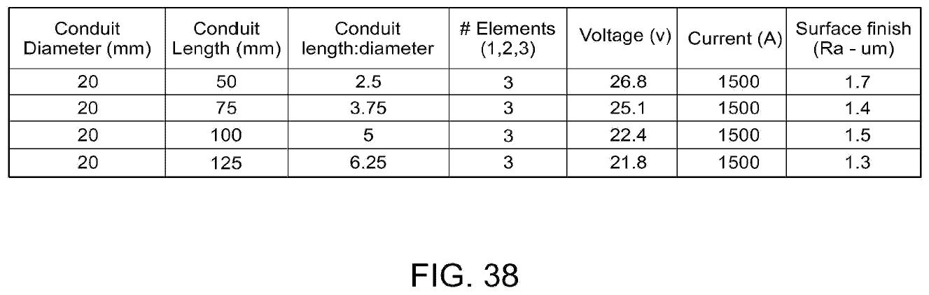

FIG. 38 is a table of experimental data obtained using the electrode assembly 800 of FIGS. 29a to c when a compressor housing is machined.

As indicated in FIG. 38, the current supply was held constant at 1500 A across all tests. The tests were therefore current-driven tests. Again, the length, or extent, of the conduit 806 (FIG. 29a) was varied and the resulting effect upon the electrochemical machining process was recorded.

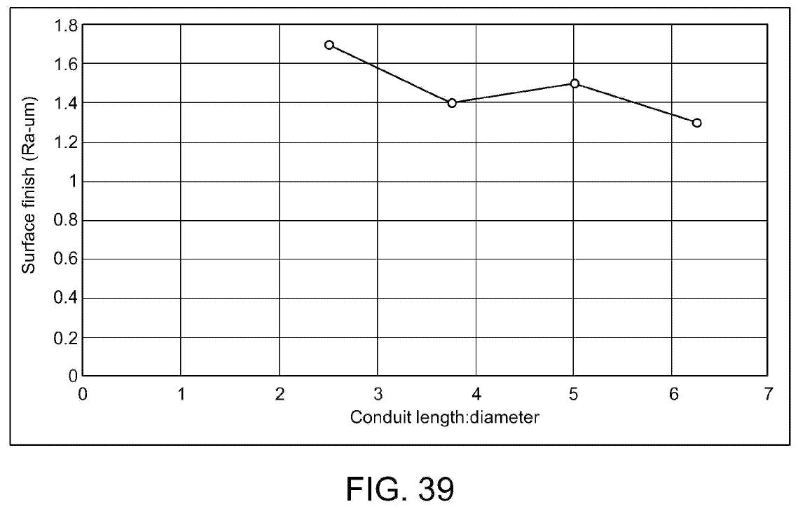

As indicated by the table of FIG. 38, a conduit length:diameter ratio of ˜6 again provided the best surface finish with the machining process having removed the most material from the compressor housing. As shown in FIG. 39, which is a plot of the FIG. 38 data (with surface finish plotted on the Y axis), the best surface finish is obtained in embodiments where the extent of the conduit is around 6 diameters. This is considered to be a combination of the conduit extent providing uniform flow, as well as a precharging effect upon the electrolyte.

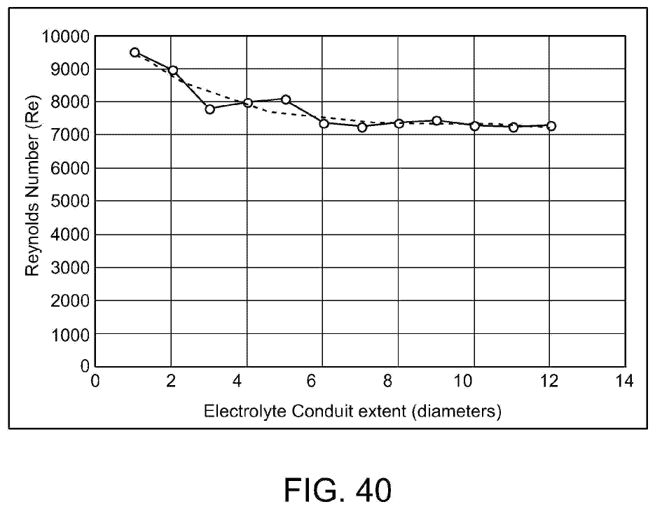

FIG. 40 is a plot showing the effect of the conduit extent, in diameters, (X axis) upon the Reynolds number (Y axis) of electrolyte flow for the electrode assembly 800 of FIGS. 29a to c. The Reynolds number is manually calculated based upon the results of CFD simulation data (in which the velocity of electrolyte at a given point within the turbine housing is obtained from the simulation data). FIG. 40 indicates that the Reynolds number of electrolyte flow generally reduces from around 1 to around 6 conduit extends, at which point the variation generally reduces. This is also indicated by the dashed trend line. FIG. 40 therefore indicates that a conduit extent of around six diameters is a desirable embodiment for reasons of reduced turbulence.

For each of the electrode assemblies described herein, and the associated methods, one or more indicators may be applied to the component during the electrochemical machining process. The indicator(s) may be a machined feature (for example). An example of the machined feature is a hemisphere having, for example, a 5 mm diameter, although it will be appreciated that a wide range of other geometries, and features, could otherwise be machined into the component. This can advantageously provide a visual indicator (e.g. a poka-yoke) that the cavity has been polished, and polished to its full depth. The feature can also be used as a non-functional counterfeit detection feature.

The feature may be applied to an exterior of the component (e.g. an outer face of a flange) or an interior of the component (e.g. to the internal wall). The indicators may be applied by the electrode(s) (e.g. to the internal wall of the cavity) and/or may be applied by the mounting body (e.g. to an exterior of the component).

Electrochemical machining may otherwise be referred to as reverse electroplating in that material is removed, rather than being added (as is the case for electroplating). The polarity of the electrode and workpiece may also be reversed in comparison to electroplating.

Reducing a gap between the conductive body and the internal wall may provide a more significant, or stronger, magnitude of machining.

The compressor housing may be referred to as a compressor cover.

Where the component is a turbine housing, the manufacture process may be:
1. Sand moulding for initial casting geometry;
Shot blasting of cast geometry;
Gates/runners ground off;
Electrochemical machining process, as described in this document;
Cosmetic blast.

Examples according to the disclosure may be formed using an additive manufacturing process. A common example of additive manufacturing is 3D printing; however, other methods of additive manufacturing are available. Rapid prototyping or rapid manufacturing are also terms which may be used to describe additive manufacturing processes.

As used herein, “additive manufacturing” refers generally to manufacturing processes wherein successive layers of material(s) are provided on each other to “build-up” layer-by-layer or “additively fabricate”, a three-dimensional component. This is compared to some subtractive manufacturing methods (such as milling or drilling), wherein material is successively removed to fabricate the part. The successive layers generally fuse together to form a monolithic component which may have a variety of integral sub-components. In particular, the manufacturing process may allow an example of the disclosure to be integrally formed and include a variety of features not possible when using prior manufacturing methods.

Additive manufacturing methods described herein enable manufacture to any suitable size and shape with various features which may not have been possible using prior manufacturing methods. Additive manufacturing can create complex geometries without the use of any sort of tools, molds or fixtures, and with little or no waste material. Instead of machining components from solid billets of plastic or metal, much of which is cut away and discarded, the only material used in additive manufacturing is what is required to shape the part.

Suitable additive manufacturing techniques in accordance with the present disclosure include, for example, Fused Deposition Modeling (FDM), Selective Laser Sintering (SLS), Stereolithography (SLA), Direct Selective Laser Sintering (DSLS), Electron Beam Sintering (EBS), Electron Beam Melting (EBM), Laser Engineered Net Shaping (LENS), Electron Beam Additive Manufacturing (EBAM), Laser Net Shape Manufacturing (LNSM), Direct Metal Deposition (DMD), Digital Light Processing (DLP), Continuous Digital Light Processing (CDLP), Direct Selective Laser Melting (DSLM), Selective Laser Melting (SLM), Direct Metal Laser Melting (DMLM), Direct Metal Laser Sintering (DMLS), Material Jetting (MJ), NanoParticle Jetting (NPJ), Drop On Demand (DOD), Binder Jetting (BJ), Multi Jet Fusion (MJF), Laminated Object Manufacturing (LOM) and other known processes. Binder Jetting is a preferred process for manufacturing the conductive elements, and electrodes, described in this application.

The additive manufacturing processes described herein may be used for forming components using any suitable material. For example, the material may be metal, composite or any other suitable material that may be in solid, liquid, powder, sheet material, wire, or any other suitable form or combinations thereof. More specifically, according to exemplary embodiments of the present subject matter, the additively manufactured components described herein may be formed in part, in whole, or in some combination of materials including but not limited to pure metals, nickel alloys, chrome alloys, titanium, titanium alloys, magnesium, magnesium alloys, aluminum, aluminum alloys, iron, iron alloys, stainless steel, and nickel or cobalt based superalloys (e.g., those available under the name Inconel® available from Special Metals Corporation). These materials are examples of materials suitable for use in additive manufacturing processes which may be suitable for the fabrication of examples described herein. Stainless steel 316 A/L is a preferred material for manufacturing the conductive elements, and electrodes, described herein.

As noted above, the additive manufacturing process disclosed herein allows a single component to be formed from multiple materials. Thus, the examples described herein may be formed from any suitable mixtures of the above materials. For example, a component may include multiple layers, segments, or parts that are formed using different materials, processes, and/or on different additive manufacturing machines. In this manner, components may be constructed which have different materials and material properties for meeting the demands of any particular application. In addition, although the components described herein are constructed entirely by additive manufacturing processes, it should be appreciated that in alternate embodiments, all or a portion of these components may be formed via casting, machining, and/or any other suitable manufacturing process. Indeed, any suitable combination of materials and manufacturing methods may be used to form these components.

Additive manufacturing processes typically fabricate components based on three-dimensional (3D) information, for example a three-dimensional computer model (or design file), of the component.

Accordingly, examples described herein not only include products or components as described herein, but also methods of manufacturing such products or components via additive manufacturing and computer software, firmware or hardware for controlling the manufacture of such products via additive manufacturing. The structure of one or more parts of the product may be represented digitally in the form of a design file. A design file, or computer aided design (CAD) file, is a configuration file that encodes one or more of the surface or volumetric configuration of the shape of the product. That is, a design file represents the geometrical arrangement or shape of the product.

Design files can take any now known or later developed file format. For example, design files may be in the Stereolithography or “Standard Tessellation Language” (.stl) format which was created for stereolithography CAD programs of 3D Systems, or the Additive Manufacturing File (.amf) format, which is an American Society of Mechanical Engineers (ASME) standard that is an extensible markup-language (XML) based format designed to allow any CAD software to describe the shape and composition of any three-dimensional object to be fabricated on any additive manufacturing printer.

Further examples of design file formats include AutoCAD (.dwg) files, Blender (.blend) files, Parasolid (.x_t) files, 3D Manufacturing Format (0.3mf) files, Autodesk (3ds) files, Collada (.dae) files and Wavefront (.obj) files, although many other file formats exist.

Design files can be produced using modelling (e.g. CAD modelling) software and/or through scanning the surface of a product to measure the surface configuration of the product.

Once obtained, a design file may be converted into a set of computer executable instructions that, once executed by a processer, cause the processor to control an additive manufacturing apparatus to produce a product according to the geometrical arrangement specified in the design file. The conversion may convert the design file into slices or layers that are to be formed sequentially by the additive manufacturing apparatus. The instructions (otherwise known as geometric code or “G-code”) may be calibrated to the specific additive manufacturing apparatus and may specify the precise location and amount of material that is to be formed at each stage in the manufacturing process. As discussed above, the formation may be through deposition, through sintering, or through any other form of additive manufacturing method.

The code or instructions may be translated between different formats, converted into a set of data signals and transmitted, received as a set of data signals and converted to code, stored, etc., as necessary. The instructions may be an input to the additive manufacturing system and may come from a part designer, an intellectual property (IP) provider, a design company, the operator or owner of the additive manufacturing system, or from other sources. An additive manufacturing system may execute the instructions to fabricate the product using any of the technologies or methods disclosed herein.

Design files or computer executable instructions may be stored in a (transitory or non-transitory) computer readable storage medium (e.g., memory, storage system, etc.) storing code, or computer readable instructions, representative of the product to be produced. As noted, the code or computer readable instructions defining the product that can be used to physically generate the object, upon execution of the code or instructions by an additive manufacturing system. For example, the instructions may include a precisely defined 3D model of the product and can be generated from any of a large variety of well-known computer aided design (CAD) software systems such as AutoCAD®, TurboCAD®, DesignCAD 3D Max, etc. Alternatively, a model or prototype of the component may be scanned to determine the three-dimensional information of the component.

Accordingly, by controlling an additive manufacturing apparatus according to the computer executable instructions, the additive manufacturing apparatus can be instructed to print out one or more parts of the product. These can be printed either in assembled or unassembled form. For instance, different sections of the product may be printed separately (as a kit of unassembled parts) and then subsequently assembled. Alternatively, the different parts may be printed in assembled form.

In light of the above, embodiments include methods of manufacture via additive manufacturing. This includes the steps of obtaining a design file representing the product and instructing an additive manufacturing apparatus to manufacture the product in assembled or unassembled form according to the design file. The additive manufacturing apparatus may include a processor that is configured to automatically convert the design file into computer executable instructions for controlling the manufacture of the product. In these embodiments, the design file itself can automatically cause the production of the product once input into the additive manufacturing device. Accordingly, in this embodiment, the design file itself may be considered computer executable instructions that cause the additive manufacturing apparatus to manufacture the product. Alternatively, the design file may be converted into instructions by an external computing system, with the resulting computer executable instructions being provided to the additive manufacturing device.

Given the above, the design and manufacture of implementations of the subject matter and the operations described in this specification can be realized using digital electronic circuitry, or in computer software, firmware, or hardware, including the structures disclosed in this specification and their structural equivalents, or in combinations of one or more of them. For instance, hardware may include processors, microprocessors, electronic circuitry, electronic components, integrated circuits, etc. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

Although additive manufacturing technology is described herein as enabling fabrication of complex objects by building objects point-by-point, layer-by-layer, typically in a vertical direction, other methods of fabrication are possible and within the scope of the present subject matter. For example, although the discussion herein refers to the addition of material to form successive layers, one skilled in the art will appreciate that the methods and structures disclosed herein may be practiced with any additive manufacturing technique or other manufacturing technology.

The described and illustrated embodiments are to be considered as illustrative and not restrictive in character, it being understood that only preferred embodiments have been shown and described and that all changes and modifications that come within the scope of the disclosure as defined in the claims are desired to be protected. In relation to the claims, it is intended that when words such as “a,” “an,” “at least one,” or “at least one portion” are used to preface a feature there is no intention to limit the claim to only one such feature unless specifically stated to the contrary in the claim. When the language “at least a portion” and/or “a portion” is used the item can include a portion and/or the entire item unless specifically stated to the contrary.

Optional and/or preferred features as set out herein may be used either individually or in combination with each other where appropriate and particularly in the combinations as set out in the accompanying claims. The optional and/or preferred features for each aspect of the disclosure set out herein are also applicable to any other aspects of the disclosure, where appropriate.

1. An electrode assembly for electrochemically machining a cavity of a component, the electrode assembly comprising:
an electrode comprising a plurality of conductive elements, including an outermost conductive element;
a mounting body coupled to the electrode and engageable with the component to align the electrode within the cavity; and
an urging means configured to transition the electrode from a movable configuration to a conforming configuration; wherein
in the movable configuration the conductive elements are moveable relative to one another; and
in the conforming configuration adjacent conductive elements align to define a substantially continuous outer electrode surface.

2. The electrode assembly according to claim 1, wherein the urging means comprises a flexible element.

3. (canceled)

4. (canceled)

5. (canceled)

6. (canceled)

7. The electrode assembly according to claim 1, wherein each of the conductive elements comprises:
a first end proximate the mounting body; and
a second, opposing end, distal the mounting body;
wherein, for at least in board conductive elements, one or more of the first and second ends comprises an alignment feature configured to align the respective conductive element with the adjacent conductive element.

8. (canceled)

9. (canceled)

10. (canceled)

11. The electrode assembly according to claim 1, wherein the conductive elements are hingeably connected to one another.

12. (canceled)

13. (canceled)

14. The electrode assembly according to claim 1, wherein a cross-section shape of the electrode is non-constant along a length of the electrode.

15. (canceled)

16. The electrode assembly according to claim 1, wherein the mounting body is an alignment flange.

17. The electrode assembly according claim 1, wherein the mounting body comprises one or more electrolyte apertures extending therethrough.

18. The electrode assembly according to claim 1, wherein the mounting body comprises an integral busbar.

19. The electrode assembly according to claim 1, wherein the mounting body is integral with a first conductive element of the electrode.

20. The electrode assembly according to claim 1, wherein the mounting body comprises a plurality of electrolyte channels distributed around the electrode.

21. (canceled)

22. (canceled)

23. The electrode assembly according to claim 20, wherein the electrolyte channels are defined by one or more ribs.

24. The electrode assembly according to claim 1, further comprising an electrolyte conduit in electrical communication with the mounting body.

25. (canceled)

26. (canceled)

27. (canceled)

28. The electrode assembly according to claim 24, wherein the electrolyte conduit has an extent of at least around six major dimensions of the cross-section of the conduit.

29. The electrode assembly according to claim 1, wherein the electrode is a first electrode; and
wherein a second electrode, comprising a respective plurality of conductive elements, is coupled to the mounting body.

30. A method of electrochemically machining a cavity of a component using the electrode assembly according to claim 1, the method comprising:
inserting the outermost, and successive, conductive elements of the electrode through an opening of the cavity and along the cavity whilst the electrode is in the movable configuration;
coupling the mounting body to the component to align the electrode within the cavity, and actuating the urging means to transition the electrode from the movable configuration to the conforming configuration, the conductive elements thus defining the substantially continuous outer electrode surface which conforms to at least part of an internal wall of the cavity; and
applying a negative charge to the electrode, and providing a flow of electrolyte through the cavity to remove material from the internal wall of the cavity.

31. The method according to claim 30, further comprising releasing the urging means, decoupling the mounting body from the component and withdrawing the electrode from the cavity, the electrode transitioning to the movable configuration as the electrode is withdrawn from the cavity.

32. The method according to claim 30, wherein a low power test is conducted before an operational power is supplied to the electrode.

33. The method according to claim 30, wherein an indicator is applied to the component during the electrochemical machining.

34. The method according to claim 30, wherein the cavity is a fluid conduit.

35. The method according to claim 34, wherein the component is a turbine housing or a compressor housing for a turbocharger, and wherein the cavity is a turbine housing volute or a compressor housing volute respectively.

36. A computer program comprising computer executable instructions that, when executed by a processor, cause the processor to control an additive manufacturing apparatus to manufacture the electrode, or a conductive element thereof, according to claim 1.

37. A method of manufacturing an electrode, or a conductive element thereof, via additive manufacturing, the method comprising:
obtaining an electronic file representing a geometry of the electrode, or a conductive element thereof, according to claim 1; and
controlling an additive manufacturing apparatus to manufacture, over one or more additive manufacturing steps, the electrode, or a conductive element thereof, according to the geometry specified in the electronic file.

38. A component comprising a cavity electrochemically machined using the electrode assembly according to claim 1.

39. A component comprising a cavity electrochemically machined using the method according to claim 30.
